(19) United States
(12) Patent Application Publication
(10) Pub. No.: US 2026/0215451 A1
(43) Pub. Date: Jul. 30, 2026

(54) ALTERNATIVE MILK FORMULATIONS AND METHODS FOR DECREASING SULFURIC SMELL DURING MILK HEAT TREATMENT

(71) Applicant: Re-Milk Ltd., Ness Ziona (IL)

(72) Inventors: Alon ROMANO, Ness Ziona (IL); Ram URITSKI, Ness Ziona (IL)

(21) Appl. No.: 19/142,019

(22) PCT Filed: Dec. 17, 2023
(86) PCT No.: PCT/IL2023/051279

§ 371 Date: Jun. 20, 2025

Related U.S. Application Data
(60) Provisional application No. 63/434,486, filed on Dec. 22, 2022.

(51) Int. Cl. A23C 11/04; A23J 3/08; A23L 5/20

(52) U.S. Cl. CPC A23C 11/04; A23J 3/08; A23L 5/21

(57) ABSTRACT

The present disclosure is directed to methods for preventing or decreasing volatile sulfur compounds (VSCs) levels in alternative milk products following heat treatment. The disclosure further provides a stable milk alternative product.

### TECHNICAL FIELD

The present disclosure is directed to methods for decreasing volatile sulfur compounds (VSCs) levels in alternative milk products following heat treatment. The disclosure further provides a stable milk alternative product.

### BACKGROUND

Milk, a low-fat, calcium-rich white liquid, produced by the mammalian glands of mammals, serves humankind as an essential dietary component. Although mammals produce milk to feed their offspring, humans continue to include milk, primarily cow's milk (Bos taurus), in their diets, even beyond infanthood. Today, cow's milk is consumed by approximately six billion people worldwide and annual world production of milk reaches 730 million tons. Milk and milk-derived dairy products are nutritionally important, accounting for approximately 12% of the calories in the daily diet in the US, and possessing 18 of the 22 essential nutrients in the human diet. Importantly, calcium in milk contributes to increasing bone mass.

In spite of the beneficial properties of milk and milk-derived dairy products, a number of factors have made it necessary to reconsider their widescale use. Primary consumer concerns with milk include the ethics surrounding animal rearing, environmental impact of milk production, lactose intolerance, and milk allergies. The consumption of dairy products on a large scale requires the production of large quantities of milk, which requires raising a large number of livestock. It is estimated that there are 140 million cows in the world, which generate 14.5% of all greenhouse gases. The quantity of greenhouse gases created through sustaining this many cows places a great burden on the environment. Various factors contribute to the improper maintenance of animal rights. Because of the large number of cows required to meet the global demand for milk, grazing and housing space are limited, resulting in poor living conditions for cows. Consequently, cow hygiene has decreased, which has resulted in a higher incidence of intramammary infections, respiratory diseases and mortality. In response to the environmental and ethical implications of milk production, many consumers have looked for alternative sources for milk, and animal-derived milk has seen a reduced demand.

In response to consumers' changing preferences, a variety of plant-based milk alternatives have been developed, including oatmeal milk, rice milk, soy milk, almond milk and walnut milk. Milk alternatives have been developed to try to mimic the characteristics of animal milk, including in color, texture, taste, and nutritional values. Plant-based milk alternatives, however, are generally unable to reproduce the nutritional properties of cow's milk, such as the high protein content and host of other nutrients present in cow's milk. More notably, the fat and protein content of cow's milk impart a distinctive taste profile which plant-based milk alternatives are unable to replicate. Furthermore, the natural taste of milk alternatives suffers from undesirable off-flavors. These factors have limited the appeal for plant-based milk alternatives.

In order to overcome the limitations of plant-based milk alternatives, companies have been developing milk alternatives comprising non-animal derived fats and recombinant milk proteins designed to mimic the taste, texture and color of animal-derived milk.

WO 2016/029193 is directed to dairy substitutes, which include micellar casein proteins or 4:1 combination of micellar casein and whey proteins, respectively.

Milk alternatives, like cow milk, are prone to bacterial growth at ambient temperatures. To prevent spoilage, milk products typically undergo thermal treatment during production to improve their quality and shelf-life. A mild heat treatment, pasteurization, remains the most popular milk treatment in North America. Requiring a heat treatment of e.g. at least 71.7° C. for 15 seconds, pasteurization extends the shelf-life of milk to six days, under refrigeration. In comparison, Ultra-High Temperature (UHT) treatment of milk provides a significantly longer shelf life of six to nine months. UHT treatment requires heating milk above 137.8° C. for a period of at least 2 seconds.

Despite the greater stability and shelf-life conferred by UHT milk treatment, UHT milk is not widely accepted by consumers owing to the sensory degradation resulting from the process. UHT can cause chemical changes in milk manifested by noticeable changes to the coloring, taste and smell thereof (Zabbia A, Buys E M, De Kock H L. Undesirable sulfur and carbonyl flavor compounds in UHT milk: a review. Crit Rev Food Sci Nutr. 2012; 52 (1): 21-30. doi: 10.1080/10408398.2010.487166. PMID: 21991988).

One of the sensory degradation issues associated with UHT processing of milk is the development of a cooked or egg-like flavor. This is believed to be caused by the release of various volatile sulfur compounds (VSCs) from whey proteins in milk, particularly beta lactoglobulin (BLG). BLG is sensitive to heat, and when exposed to high temperatures, it denatures and exposes its sulfonic amino acids, cysteine and methionine. The conversion of -SH and -SS groups in BLG into VSCs such as hydrogen sulfide, methanethiol, sulfides, and disulfides contributes to the egg-like flavor of milk. The problem of an eggy smell is particularly pronounced in milk alternative products which have a higher BLG content than cow's milk, e.g. milk alternative products which include recombinant BLG as the primary or only protein component.

Providing safe and efficacious additives capable of reducing or removing the eggy flavor of UHT milk, is of paramount importance and poses a great challenge. Various additives have been studied to remove or reduce the cooked and eggy flavors from UHT cow milk treatments including copper, calcium chloride, disodium hydrogen phosphate, thiosulphonates, thiosulphates, sulphydryl oxidase, epicatechin and L-cystine. However, these additives suffer from various deficiencies, and their effects on the sensory properties of milk are problematic.

There is a continuous need for milk alternatives and for the development of efficacious and non-toxic milk additives, able to prevent, reduce or remove the eggy flavor from UHT milk in order to increase its commercial acceptance.

### SUMMARY

The following aspects, and embodiments thereof, are described and illustrated in conjunction with compositions and methods which are meant to be exemplary and illustrative, not limiting in scope. In various embodiments, one or more of the above-described problems have been prevented, reduced or eliminated, while other embodiments are directed to other advantages or improvements.

According to some embodiments, there is provided a stable milk alternative composition, comprising: (i) at least one milk protein; (ii) at least one additive selected from the group consisting of: a mineral chelator, a mineral, a texturizer and an emulsifier; (iii) at least one saccharide; (iv) at least one fat; and (v) water; wherein the stable milk alternative composition is devoid of animal-derived substances, and/or wherein the stable milk alternative composition has a comparable sulfur smell profile to animal milk, and/or wherein the stable milk alternative composition is devoid of micellar casein.

According to some embodiments, the at least one milk protein comprises beta lactoglobulin (BLG). According to some embodiments, the BLG is present at a concentration of at least 1% w/w. According to some embodiments, the stable milk alternative composition comprises the BLG substantially as the sole milk protein. According to some embodiments, the stable milk alternative composition comprises the BLG substantially as the sole protein. According to some embodiments, the BLG is a recombinant BLG. According to some embodiments, the BLG is recombinant beta-lactoglobulin B (rBLG B).

According to some embodiments, the at least one citrate salt comprises 0.1% to 0.3% w/w trisodium citrate.

According to some embodiments, the at least one sweetener comprises 1.5% to 3% w/w maltose.

According to some embodiments, the at least one non-animal fat comprises 1% to 5% w/w vegetable fat.

According to some embodiments, the hydrogen peroxide is at a concentration of 0.03 ppm to 0.3 ppm.

According to some embodiments, the cystine is at a concentration of 0.10 ppm to 1 ppm.

According to some embodiments, the milk alternative composition comprises 87% to 95% w/w water.

According to some embodiments, the milk alternative composition has a pH in the range of 6.6 to 7.2.

According to some embodiments, the milk alternative composition comprises: (i) recombinant beta-lactoglobulin B (rBLG), 2.5% to 6% w/w; (ii) trisodium citrate, 0.1% to 0.3% w/w; (iii) maltose, 1.5% to 3% w/w; (iv) vegetable fat, 2% to 4% w/w; (v) water; 87% to 95% w/w; (vi) hydrogen peroxide, 0.10 ppm to 1 ppm; (vii) cystine, 0.03 ppm to 0.3 ppm; wherein the milk alternative composition has a pH is in the range of 6.6 to 7.2.

According to some embodiments, there is provided a stable milk alternative composition, comprising: (i) at least one milk protein; (ii) at least one additive selected from the group consisting of: a mineral chelator, a mineral, a texturizer and an emulsifier; (iii) at least one saccharide; (iv) at least one fat; and (v) water; wherein the stable milk alternative composition is devoid of animal-derived substances. According to some embodiments, the stable milk alternative composition has a comparable sulfur smell profile to animal milk, and/or the stable milk alternative composition is devoid of micellar casein. According to some embodiments, the stable milk alternative composition has a comparable sulfur smell profile to animal milk. According to some embodiments, the stable milk alternative composition is devoid of micellar casein. According to some embodiments, the stable milk alternative composition is substantially devoid of any casein proteins. According to some embodiments, the stable milk alternative composition is devoid of any casein proteins. According to some embodiments, the stable milk alternative composition has a comparable VSC content profile to animal milk, and/or the stable milk alternative composition is devoid of micellar casein. According to some embodiments, the stable milk alternative composition has a comparable VSC content profile to animal milk.

According to some embodiments, the stable milk alternative composition further comprises at least one pH adjusting agent. According to some embodiments, the stable milk alternative composition comprises a buffer composition, which maintains a pH range of 6.6 to 7.4 and comprises an aqueous solution of the at least one pH adjusting agent. According to some embodiments, the pH adjusting agent is an alkali phosphate. According to some embodiments, the pH adjusting agent comprises a potassium phosphate. According to some embodiments, the pH adjusting agent is selected from the group consisting of: monosodium phosphate (MSP), disodium phosphate (DSP), dipotassium phosphate (DPP), monopotassium phosphate (MPP) and a combination thereof. According to some embodiments, the pH comprises at least one of MPP and DPP. According to some embodiments, the pH comprises at least MPP and DPP. According to some embodiments, the pH adjusting agent comprises 0.05% to 0.12% w/w MSP, 0.1% to 0.3% w/w DSP, and 0.5% to 0.8% w/w DPP. According to some embodiments, the pH adjusting agent comprises 0.1-0.25% w/w MPP, and 0.5% to 1.1% w/w DPP.

According to some embodiments, the stable milk alternative composition further comprises hydrogen peroxide, cystine or both. According to some embodiments, the stable milk alternative composition further comprises hydrogen peroxide. According to some embodiments, the hydrogen peroxide is present at a concentration of 0.03 ppm to 0.3 ppm.

According to some embodiments, the stable milk alternative composition further comprises cystine. According to some embodiments, the cystine is present at a concentration of 0.1 ppm to 1 ppm.

According to some embodiments, the additive comprises a mineral chelator. According to some embodiments, the mineral chelator comprises a citrate salt. According to some embodiments, the citrate salt comprises trisodium citrate. According to some embodiments, the citrate salt is present at a concentration of 0.05% to 0.3% w/w.

According to some embodiments, the additive comprises a texturizer. According to some embodiments, the texturizer comprises gellan gum. According to some embodiments, the texturizer comprises inulin fiber. According to some embodiments, the inulin fiber is present at a concentration of 1% to 3% w/w. According to some embodiments, the gellan gum is present at a concentration of 0.002% to 0.05% w/w. According to some embodiments, the additive comprises an emulsifier. According to some embodiments, the emulsifier comprises arabic gum. According to some embodiments, the arabic gum is present at a concentration of 0.05% to 0.3% w/w. According to some embodiments, the additive comprises a mineral. According to some embodiments, the mineral comprises a calcium salt. According to some embodiments, the calcium salt is tricalcium phosphate or calcium carbonate. According to some embodiments, the mineral comprises tricalcium phosphate 0.1% to 1% w/w. According to some embodiments, the calcium salt is tricalcium phosphate. According to some embodiments, the mineral comprises tricalcium phosphate 0.1% to 0.5% w/w. According to some embodiments, the calcium salt is tricalcium phosphate. According to some embodiments, the mineral comprises calcium carbonate 0.25% to 0.75% w/w.

According to some embodiments, the stable milk alternative composition comprises at least two additives selected from the group consisting of: mineral chelators, minerals, texturizers and emulsifiers.

According to some embodiments, the at least one saccharide comprises at least one disaccharide. According to some embodiments, the stable milk alternative composition of comprises at least one disaccharide, which is not lactose. According to some embodiments, the at least one disaccharide comprises maltose. According to some embodiments, the at least one disaccharide is present at a concentration of 1.5% to 5% w/w.

According to some embodiments, the at least one saccharide comprises at least one polysaccharide.

According to some embodiments, the at least one polysaccharide comprises at least one polysaccharide fiber. According to some embodiments, the at least one polysaccharide fiber comprises a fructan dietary fiber. According to some embodiments, the at least one polysaccharide comprises inulin fiber. According to some embodiments, the at least one polysaccharide is present at a concentration of 1% to 4% w/w.

According to some embodiments, the least one polysaccharide comprises gellan gum. According to some embodiments, the gellan gum is present at a concentration of 0.002% to 0.05% w/w.

According to some embodiments, the least one polysaccharide comprises arabic gum. According to some embodiments, the arabic gum is present at a concentration of 0.05% to 0.3% w/w.

According to some embodiments, the at least one fat comprises at least one non-animal fat. According to some embodiments, the at least one fat comprises at least one vegetable fat. According to some embodiments, the stable milk alternative composition comprises 1% to 5% w/w vegetable fat.

According to some embodiments, the stable milk alternative composition comprises: (i) recombinant beta-lactoglobulin B (rBLG), 0.5% to 10% w/w; (ii) a mineral chelator, 0.05% to 0.5% w/w; (iii) a saccharide, 0.5% to 10% w/w; (iv) optionally, a fat, 0% to 10% w/w; (v) optionally, a texturizer, 0.001% to 10% w/w; (vi) optionally, an emulsifier, 0.01% to 1% w/w; (vii) optionally, a pH adjustment agent, 0.1% to 3% w/w; (viii) optionally, a mineral, 0.05% to 5% w/w; (ix) optionally, a flavoring agent, 0.05% to 1% w/w; (x) optionally, a coloring agent; and (xi) water, to 100% w/w.

According to some embodiments, the stable milk alternative composition comprises: (i) recombinant beta-lactoglobulin B (rBLG), 1% to 6% w/w; (ii) a mineral chelator, 0.05% to 0.2% w/w; (iii) a saccharide, 1% to 6% w/w; (iv) optionally, a fat, 1% to 5% w/w; (v) optionally, a texturizer, 0.01% to 3% w/w; (vi) optionally, an emulsifier, 0.1% to 0.2% w/w; (vii) optionally, a pH adjustment agent, 0.5% to 1.5% w/w; (viii) optionally, a mineral, 0.1% to 1% w/w; (ix) optionally, a flavoring agent, 0.05% to 0.5% w/w; (x) optionally, a coloring agent; and (xi) water, to 100% w/w.

According to some embodiments, the stable milk alternative composition comprises: (i) recombinant beta-lactoglobulin B (rBLG), 2.5% to 6% w/w; (ii) trisodium citrate, 0.1% to 0.3% w/w; (iii) maltose, 1.5% to 5% w/w; (iv) vegetable fat, 2% to 4% w/w; (v) water, 87% to 95% w/w; (vi) optionally, inulin fiber, 1% to 4% w/w; (vii) gellan gum, 0.002% to 0.05% w/w; (viii) arabic gum, 0.05% to 0.3% w/w; (ix) MSP, 0.05% to 0.12% w/w; (x) DSP, 0.1% to 0.3% w/w; (xi) DPP, 0.5% to 0.8% w/w; (xii) optionally, a coloring agent, preferably yellow colorant, 0.005% to 0.05% w/w; (xii) optionally, a flavoring agent, 0.05% to 0.2% w/w; (xiii) optionally, hydrogen peroxide, 0.10 ppm to 1 ppm; (xiv) optionally, cystine, 0.03 ppm to 0.3 ppm; and (xv) optionally, tricalcium phosphate, 0.15% to 0.4% w/w; wherein the stable milk alternative composition is devoid of animal-derived substances and has a pH above the pI of BLG, preferably the pH is in the range of 7.2 to 7.3.

According to some embodiments, the stable milk alternative composition is selected from the group consisting of: Composition A, Composition B, Composition C, Composition D and Composition E,
wherein Composition A comprises:
   (i) recombinant beta-lactoglobulin B (rBLG), 2.5% to 6% w/w;
   (ii) trisodium citrate, 0.1% to 0.3% w/w;
   (iii) maltose, 1.5% to 5% w/w;
   (iv) vegetable fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) monosodium phosphate (MSP), 0.05% to 0.12% w/w;
   (x) disodium phosphate (DSP), 0.1% to 0.3% w/w;
   (xi) dipotassium phosphate (DPP), 0.5% to 0.8% w/w;
   (xii) optionally, a coloring agent, preferably yellow colorant, 0.005% to 0.05% w/w;
   (xiii) optionally, a flavoring agent, 0.05% to 0.2% w/w;
   (xiv) optionally, hydrogen peroxide, 0.10 ppm to 1 ppm;
   (xv) optionally, cystine, 0.03 ppm to 0.3 ppm; and
   (xvi) optionally, tricalcium phosphate, 0.15% to 0.4% w/w;
wherein the stable milk alternative Composition A is devoid of animal-derived substances and has a pH above the pI of BLG, preferably the pH is in the range of 7.2 to 7.3;
wherein Composition B comprises:
   (i) recombinant beta-lactoglobulin B (rBLG), 2.5% to 6% w/w;
   (ii) trisodium citrate, 0.1% to 0.3% w/w;
   (iii) maltose, 2% to 5.5% w/w;
   (iv) palm fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) MSP, 0.05% to 0.12% w/w;
   (x) DSP, 0.1% to 0.3% w/w;
   (xi) DPP, 0.5% to 0.8% w/w;
   (xii) optionally, a coloring agent, preferably yellow colorant, 0.005% to 0.05% w/w;
   (xiii) optionally, a flavoring agent, 0.2% to 0.5% w/w;
   (xiv) optionally, hydrogen peroxide, 0.10 ppm to 1 ppm;
   (xv) optionally, cystine, 0.03 ppm to 0.3 ppm; and
   (xvi) optionally, tricalcium phosphate, 0.15% to 0.4% w/w;
wherein the stable milk alternative Composition B is devoid of animal-derived substances and has a pH above the pI of BLG, preferably the pH is in the range of 7.2 to 7.3;
wherein Composition C comprises:
   (i) recombinant beta-lactoglobulin B (rBLG), 2.5% to 6% w/w;
   (ii) 1 trisodium citrate, 0.1% to 0.3% w/w;
   (iii) sucrose, 1.5% to 5% w/w;
   (iv) coconut fat, 2% to 4% w/w;
   (v) water, 87% to 95% w/w;
   (vi) calcium carbonate, 0.25% to 0.75% w/w;
   (vii) gellan gum, 0.002% to 0.05% w/w;
   (viii) arabic gum, 0.05% to 0.3% w/w;
   (ix) monopotassium phosphate (MPP), 0.05% to 0.3% w/w;
   (x) DPP, 0.5% to 1.2% w/w;
   (xi) optionally, a coloring agent, preferably yellow colorant, 0.005% to 0.05% w/w;
   (xii) optionally, a flavoring agent, preferably table salt, 0.05% to 0.3% w/w;
   (xiii) optionally, hydrogen peroxide, 0.10 ppm to 1 ppm; and
   (xiv) optionally, cystine, 0.03 ppm to 0.3 ppm;
wherein the stable milk alternative Composition C is devoid of animal-derived substances and has a pH above the pI of BLG, preferably the pH is in the range of 7.2 to 7.4;
wherein Composition D comprises:
   (i) recombinant beta-lactoglobulin B (rBLG), 0.5% to 3% w/w;
   (ii) trisodium citrate, 0.03% to 0.2% w/w;
   (iii) sucrose, 1.5% to 3.5% w/w;
   (iv) plant fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) DPP, 0.5% to 1.2% w/w;
   (x) MPP, 0.05% to 0.3% w/w;
   (xi) optionally, a coloring agent, preferably yellow colorant, 0.05% to 0.5% w/w;
   (xii) optionally, a flavoring agent, 0.02% to 0.5% w/w;
   (xiii) optionally, hydrogen peroxide, 0.10 ppm to 1 ppm;
   (xiv) optionally, cystine, 0.03 ppm to 0.3 ppm; and
   (xv) optionally, calcium carbonate, 0.15% to 1% w/w;
wherein the stable milk alternative Composition D is devoid of animal-derived substances and has a pH above the pI of BLG, preferably the pH is in the range of 7.2 to 7.5; and
wherein Composition E comprises:
   (i) recombinant beta-lactoglobulin B (rBLG), 2% to 6% w/w;
   (ii) trisodium citrate, 0.1% to 0.3% w/w;
   (iii) sucrose, 1.5% to 3.5% w/w;
   (iv) plant fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) DPP, 0.5% to 1.2% w/w;
   (x) MPP, 0.05% to 0.3% w/w;
   (xi) optionally, a coloring agent, preferably yellow colorant, 0.05% to 0.5% w/w;
   (xii) optionally, a flavoring agent, 0.02% to 0.5% w/w;
   (xiii) optionally, hydrogen peroxide, 0.10 ppm to 1 ppm;
   (xiv) optionally, cystine, 0.03 ppm to 0.3 ppm; and
   (xv) optionally, calcium carbonate, 0.15% to 1% w/w;
wherein the stable milk alternative Composition E is devoid of animal-derived substances and has a pH above the pI of BLG, preferably the pH is in the range of 7.2 to 7.5. Each possibility represents a separate embodiment of the invention.

According to some embodiments, the stable milk alternative composition is composition A. According to some embodiments, the stable milk alternative composition is composition B. According to some embodiments, the stable milk alternative composition is composition C. According to some embodiments, the stable milk alternative composition is composition D. According to some embodiments, the stable milk alternative composition is composition E.

According to some embodiments, the stable milk alternative composition remains substantially uncurdled at a temperature of 60° C. for at least 30 minutes. According to some embodiments, the stable milk alternative composition remains substantially uncurdled at pH 5 for at least 30 minutes at 25° C. According to some embodiments, the stable milk alternative composition remains substantially uncurdled at pH 5 and 60° C. for at least 30 minutes.

According to some embodiments, the stable milk alternative composition has dry matter rate in the range of 7% to 14%.

According to some embodiments, the stable milk alternative composition is in the form of liquid milk.

According to some embodiments, the stable milk alternative composition has viscosity in the range of 8 to 50 cP.

According to some embodiments, the stable milk alternative composition has color difference in the range of 0 to 6, as measured by delta E compared to cow milk.

According to some embodiments, the stable milk alternative composition has foam density in the range of 200 to 400 gr/ml.

According to some embodiments, the stable milk alternative composition has foam stability in the range of 90% to 99%.

According to some embodiments, the stable milk alternative composition in the form of liquid milk coffee, and has color difference in the range of 0 to 20, as measured by delta E compared to a corresponding liquid milk coffee made using cow milk.

According to some embodiments, the stable milk alternative composition has greater physical stability to sedimentation than cow milk as measured by an analytical centrifugal analyzer.

According to some embodiments, the stable milk alternative composition has a substantially uniform consistency.

According to some embodiments, the stable milk alternative composition has a pH in the range of 6.6 to 7.4. According to some embodiments, the stable milk alternative composition has a basic pH. According to some embodiments, the stable milk alternative composition has a pH in the range of 7.2 to 7.3.

According to some embodiments, the stable milk alternative composition comprises 80% to 95% w/w water. According to some embodiments, the stable milk alternative composition further comprises at least one flavoring agent. According to some embodiments, the stable milk alternative composition further comprises at least one coloring agent. According to some embodiments, the stable milk alternative composition has an energy content of 50 calories to 65 calories per 100 ml.

According to some embodiments, the stable milk alternative composition is prepared by a method comprising: (i) providing at least one pH adjusting agent; (ii) providing a dry mixture comprising at least one milk protein, at least one additive selected from the group consisting of: a mineral chelator, a texturizer and an emulsifier, and at least one saccharide; (iii) providing a non-animal fat and melting it at a temperature of at least 40° C.; (iv) dissolving the at least one pH adjusting agent in water to form an aqueous buffer solution; (v) dissolving the dry mixture of step (ii) in water at a temperature of at least 30° C. to form an aqueous mixture; (vi) combining the aqueous buffer solution of step (iv) with the aqueous mixture formed in step (v) to form a combined aqueous mixture; and (vii) combining the molten fat of step (iii) with the combined aqueous mixture of step (vi) to form a stable milk alternative composition. According to some embodiments, the method further comprises a step of homogenizing the stable milk alternative composition of step (vii). According to some embodiments, the method further comprises heat-treating the stable milk alternative composition by performing the method for obtaining a heat-treated edible aqueous composition of the present invention.

The present invention further relates to processes for the production of heat-treated edible aqueous compositions, herein termed “Alternative Milk”. The methods provided herein produce heat-treated edible aqueous compositions which are heat treated (e.g., pasteurized or UHT treated) sufficiently to kill microorganisms and/or extend the shelf-life thereof, while maintaining a similar smell and flavor profile to those of untreated or pre-treated compositions.

It was surprisingly found that addition of a combination of hydrogen peroxide and/or cystine suppresses the release of VSCs during heat treatment of an edible aqueous composition which comprises at least one milk protein. In particular, while individual anti-VSCs compounds, including hydrogen peroxide and L-cystine alone, were found to be insufficient in VSCs reduction upon the heat treatment of the edible aqueous composition, a combination of hydrogen peroxide and cystine acted synergistically to enhance VSCs suppression, even in low-ppm levels. The resulting heat-treated product, upon incorporation of the hydrogen peroxide/cystine combination was found to be substantially devoid of VSCs contamination, which enables its use as a milk alternative.

Moreover, the sensory properties provided to the edible composition by the methods and formulations disclosed herein advantageously enable to perform various heat treatment procedures to edible compositions, which comprise recombinant ingredients, such as recombinant milk proteins, while preventing an eggy taste and smell, which is typical to heat-treated milk and milk alternative compositions. As a result, for the first time, a heat-treated milk alternative composition can be produced and provided to consumers with a similar taste profile to animal-derived milk.

As yet a further advantage, the method described herein uses hydrogen peroxide and cystine at concentrations, which are approved for use in the food and beverages industry.

Thus, according to some embodiments, there is provided a method for obtaining a heat-treated edible aqueous composition, the method comprising: (a) providing an edible aqueous composition which comprises at least one milk protein; (b) providing hydrogen peroxide; (c) providing cystine; (d) contacting the edible aqueous composition with the hydrogen peroxide and the cystine to form a mixture; and (e) maintaining the mixture at a temperature of at least 60° C. for a time period of at least 1 second; thereby obtaining a heat-treated edible aqueous composition.

According to some embodiments, the mixture of step (d) comprises at least 3 ppm hydrogen peroxide. According to some embodiments, the mixture of step (d) comprises at least 10 ppm cystine. According to some embodiments, the mixture of step (d) comprises 3 ppm to 30 ppm hydrogen peroxide. According to some embodiments, the mixture of step (d) comprises 10 ppm to 100 ppm cystine.

According to some embodiments, the at least one milk protein of step (a) comprises beta lactoglobulin (BLG). According to some embodiments, the edible aqueous composition comprises BLG at a concentration of at least 1% w/w. According to some embodiments, the edible aqueous composition comprises BLG at a concentration of 3% to 3.5% w/w. According to some embodiments, the BLG is a recombinant BLG. According to some embodiments, the BLG is beta-lactoglobulin B (rBLG B).

According to some embodiments, the heat-treated edible aqueous composition formed in step (e) has a reduced eggy and/or cabbage flavor and/or smell compared to a corresponding heat-treated aqueous composition prepared by employing the conditions of step (e) directly on the edible aqueous composition of step (a).

According to some embodiments, the heat-treated edible aqueous composition formed in step (e) is substantially devoid of an eggy and/or cabbage flavor and/or smell.

According to some embodiments, the edible aqueous composition of step (a) is a milk alternative composition, and/or the heat-treated edible aqueous composition formed in step (e) is a heat-treated milk alternative composition.

According to some embodiments, the edible aqueous composition of step (a) is the stable milk alternative composition according to the present invention, and/or the heat-treated edible aqueous composition formed in step (e) is the stable milk alternative composition according to the present invention. Embodiments relating to the stable milk alternative composition are described in detail above.

According to some embodiments, the heat-treated edible aqueous composition is devoid of animal-derived substances.

According to some embodiments, there is provided a heat-treated edible aqueous composition prepared by the method of the present invention.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1 shows the PCA (Principal Component Analysis) plot (10 sensors, Electronic Nose) evaluation of the heat-treated milk alternative composition with 500 ppm L-cystine (grey squares) or 500 ppm H₂O₂ (white squares), compared to heat-treated milk alternative composition without L-cystine or H₂O₂ (black squares).

FIG. 2A shows the organic sulfur sensor analysis of the heat-treated milk alternative compositions treated with 0-500 ppm L-cystine, and 3% fat commercial milk. FIG. 2B shows the hedonic test analysis of the heat-treated milk alternative compositions treated with 0-500 ppm L-cystine.

FIG. 3 shows the PCA Plot (10 sensors, Electronic Nose) evaluation of the heat-treated alternative compositions treated with 0-500 ppm L-Cystine (0 ppm-circle I; 10 ppm-circle II; 50 ppm-circle III; 100 ppm-circle IV; 250 ppm-circle V; and 500 ppm circle VI), and a corresponding alternative compositions which was not heat-treated (circle VII).

FIG. 4A shows the organic sulfur sensor analysis of the heat-treated milk alternative compositions treated with 0-500 ppm hydrogen peroxide, and 3% fat commercial milk. FIG. 4B shows the hedonic test analysis of the heat-treated milk alternative compositions treated with 0-500 ppm hydrogen peroxide.

FIG. 5 shows the PCA Plot (10 sensors, Electronic Nose) evaluation of the heat-treated alternative compositions treated with 0-500 ppm hydrogen peroxide (0 ppm-circle I; 10 ppm-circle II; 50 ppm-circle III; 100 ppm-circle IV; 250 ppm-circle V; and 500 ppm circle VI), and a corresponding alternative compositions which was not heat-treated (circle VII).

FIG. 6A shows the organic sulfur sensor analysis of the heat-treated milk alternative compositions treated with both 0-500 ppm hydrogen peroxide and 0-500 ppm L-cystine, and 3% fat commercial milk. FIG. 6B shows the hedonic test analysis of the heat-treated milk alternative compositions treated with both 0-500 ppm hydrogen peroxide and 0-500 ppm L-cystine.

FIG. 7A shows the normalized comparison in sulfur smell in the heat-treated milk alternative compositions treated with 0-500 ppm L-cystine (diagonal lines), 0-500 ppm hydrogen peroxide (black dots over white background), and both 0-500 ppm L-cystine and 0-500 ppm hydrogen peroxide (white dots over black background), as measured by the organic sulfur sensor analysis, compared to an untreated control (considered the 100%). FIG. 7B shows the normalized comparison in sulfur smell in the heat-treated milk alternative compositions treated with 0-500 ppm L-cystine (diagonal lines), 0-500 ppm hydrogen peroxide (black dots over white background), and both 0-500 ppm L-cystine and 0-500 ppm hydrogen peroxide (white dots over black background), as measured by the organic sulfur sensor analysis, compared to an untreated control (considered to be 0%).

FIG. 8 shows the PCA Plot (10 sensors, Electronic Nose) evaluation of the heat-treated alternative compositions treated with both L-cystine and hydrogen peroxide (0 ppm-circle I; 10 ppm-circle II; 50 ppm-circle III; 100 ppm-circle IV; 250 ppm-circle V; and 500 ppm-circle VI), and a corresponding alternative compositions which was not heat-treated (circle VII).

FIGS. 9A-C are photographs of coffee samples made using three different types of milk samples: coffee made using milk alternative without BLG (FIG. 9A), coffee made using milk alternative with BLG (FIG. 9B) and a coffee made using commercial cow's milk (FIG. 9C).

FIGS. 10A-B are LUMISizer profile graphs of commercial cow's milk (FIG. 10A) and milk alternative with BLG (FIG. 10B).

FIG. 11 is a graph, which shows G′ and G″ values of foams of commercial cow's milk and milk alternative with 1% and 3% BLG: G′ of commercial cow milk-empty squares, G″ of commercial cow milk-full squares; G′ of milk alternative with 1% BLG-empty rhombuses, G″ of milk alternative with 1% BLG-full rhombuses; G′ of milk alternative with 3% BLG-empty circle, G″ of milk alternative with 3% BLG-full circle.

FIG. 12 shows bubble size distribution of foams of commercial cow's milk—solid black, milk alternative with 1% BLG-checkerboard, and milk alternative with 3% BLG-diagonal lines.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

According to some embodiments, the present invention provides a method for obtaining a heat-treated edible aqueous composition from an edible aqueous composition that comprises at least one milk protein.

In certain embodiments, the heat-treated edible aqueous composition is any heat-treated edible aqueous composition comprising any dairy protein. In certain embodiments, the heat-treated edible aqueous composition is any heat-treated edible aqueous composition comprising a BLG protein. In certain embodiments, the heat-treated edible aqueous composition is selected from the group consisting of milk (including flavored milk, condensed milk, and evaporated milk), cream (including whipping cream), half-and-half, coffee creamer, dairy-based beverages (including lassi and ayran), dairy creamer, and dairy desserts (including custards and rice pudding).

It is to be understood that the edible heat-treated edible aqueous composition of the present invention can be employed in the food industry as e.g. a milk alternative composition, e.g. for drinking as-is, or in coffee drinks. In this context “milk alternative composition” relates to any non-animal derived composition, which can be used as a milk substitute, and/or as a dairy product substitute, of the milk traditionally provided from animals (e.g., cheese or ice cream). Thus, milk alternative compositions may be incorporated into dairy alternative products which are the final products provided to consumers.

The terms “edible composition”, “edible product” and “food product” refer to any composition suitable for consumption by animals and/or humans, typically by ingestion and for enjoyment, nourishment, health and/or wellness benefits. These terms include, but are not limited to, beverages (e.g., milk), confectionery compositions and products, food compositions and products, etc. According to some embodiments, the present edible composition is suitable for consumption by humans.

The terms “substance” and “ingredient” as used herein are interchangeable and refer to an edible part of a nutritional product. Certain non-limiting examples of such substances and ingredients are milk proteins, mineral chelators, pH adjusting agents, minerals, saccharides, fats, emulsifiers, texturizers, coloring agents and flavoring agents.

As used herein, the term “and/or” is intended to include any and all combinations of one or more of the associated listed items, as well as the lack of combinations when interpreted in the alternative (“or”).

As used herein, the term “aqueous” refers to a composition that contains more than a trace amount of water (i.e., more than 0.5%, more than 5%, or more than 50% water by weight, based upon the total weight of the composition). Each possibility represents a separate embodiment of the invention.

The term “edible aqueous composition” refers to any edible composition which comprises water. According to some embodiments, each one of the edible aqueous compositions of step (a) and/or the heat-treated edible aqueous composition of step (e) comprises at least 5% w/w, at least 10% w/w, at least 20% w/w, at least 35% w/w, at least 50% w/w, at least 60% w/w, at least 75% w/w or at least 90% w/w water based on the total weight of the composition, as further detailed below. Each possibility represents a separate embodiment of the invention.

According to some embodiments, the heat-treated edible aqueous composition is a milk alternative composition.

The terms “milk alternative”, “milk substitute” and “milk alternative product” as used herein are interchangeable and refer to products similar to milk in perception but are produced without the use of animal ingredients such as milk. Such products may replace animal-based milk and milk-derived dairy products in one's diet by attempting to mimic or equal the rheologic and/or organoleptic properties of traditional animal-milk-based products. Milk and milk-derived dairy alternative products include, but are not limited to: milk substitute, yogurt substitute, cheese substitute (e.g., cream cheese substitute, ricotta substitute, cheddar substitute etc.), ice cream substitute, butter substitute, and the like.

Thus, according to some embodiments, the method of the present invention is for obtaining a milk alternative composition. Also, it is to be understood that any one of the embodiments directed to the heat-treated edible aqueous composition similarly may apply to the present milk alternative composition, which is prepared according to the present method.

The terms “heat-treated” and “heat-treatment” as used herein includes any treatment or step carried out which results in increasing the temperature of a product or a proteinaceous portion thereof above room temperature, regardless of the period of time during which the temperature is increased. Accordingly, “heat treatment” would include, without limitation, pasteurization, and Ultra-High Temperature processing (UHT). Typically, “heat treatment” conducted to edible compositions is intended to reduce its microorganism count for public health, hygiene and/or safety purposes. Furthermore, heat treatment protocols are often required by regulatory authorities in different territories.

The term “microorganism”, as used herein refers to any microorganism including bacteria, virus, fungi or yeast. This term also includes spores of such microorganisms.

The term “heat-treated edible aqueous composition” means any one of: an edible aqueous composition that underwent a heat-treatment process, an edible aqueous composition that is produced from a composition that underwent a heat-treatment process, an edible aqueous composition that includes at least one edible proteinaceous component that underwent a heat-treatment process, and the like. According to some embodiments, the heat-treated edible aqueous composition is an edible aqueous composition that underwent a heat-treatment process.

The heat treatment of the present invention is described in detail below. However, it should be understood that its general goal is to comply with regulatory authorities which mandate UHT for liquid milk.

The term “substantially” refers to a property that is within 10%, within 5%, within 1%, or is equivalent to a reference property.

As used herein, the term “consists essentially of” (and grammatical variants thereof), as applied to the compositions and methods of the present disclosure, means that the compositions/methods may contain additional components so long as the additional components do not materially alter the composition/method.

As used herein, the terms “comprise”, “comprises”, “comprising”, “include”, “includes” and “including” specify the presence of stated features, steps, operations, elements and/or components, but do not preclude the presence or addition of one or more other features, steps, operations, elements, components and/or groups thereof.

As used herein, the term “about”, when used in reference to a measurable value such as an amount of mass, dose, time, temperature and the like, is meant to encompass variations of 0.1%, 0.25%, 0.5%, 0.75%, 1%, 1.5%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19% or 20% of the specified amount. Unless otherwise indicated, all numerical values in the specification are to be understood as being modified by the term “about”. The term “approximately” is synonymous with the term “about”.

According to some embodiments, the edible aqueous composition provided in step (a) has an initial water proportion (w/w), and the heat-treated edible aqueous composition obtained by the present method has a final water proportion (w/w). According to some embodiments, the final water proportion is in the range of 80% to 120% of the initial water proportion. According to some embodiments, the final water proportion is in the range of 90% to 110% of the initial water proportion. According to some embodiments, the final water proportion is in the range of 95% to 105% of the initial water proportion. According to some embodiments, the final water proportion is in the range of 97% to 103% of the initial water proportion. According to some embodiments, the final water proportion is in the range of 98% to 102% of the initial water proportion. According to some embodiments, the final water proportion is in the range of 99% to 101% of the initial water proportion.

According to some embodiments, the edible aqueous composition provided in step (a) has an initial protein proportion (w/w), and the heat-treated edible aqueous composition obtained by the present method has a final protein proportion (w/w). According to some embodiments, the final protein proportion is in the range of 80% to 120% of the initial protein proportion. According to some embodiments, the final protein proportion is in the range of 90% to 110% of the initial protein proportion. According to some embodiments, the final protein proportion is in the range of 95% to 105% of the initial protein proportion. According to some embodiments, the final protein proportion is in the range of 97% to 103% of the initial protein proportion. According to some embodiments, the final protein proportion is in the range of 98% to 102% of the initial protein proportion. According to some embodiments, the final protein proportion is in the range of 99% to 101% of the initial protein proportion.

According to some embodiments, the edible aqueous composition provided in step (a) has an initial milk protein proportion (w/w), and the heat-treated edible aqueous composition obtained by the present method has a final milk protein proportion (w/w). According to some embodiments, the final milk protein proportion is in the range of 80% to 120% of the initial milk protein proportion. According to some embodiments, the final milk protein proportion is in the range of 90% to 110% of the initial milk protein proportion. According to some embodiments, the final milk protein proportion is in the range of 95% to 105% of the initial milk protein proportion. According to some embodiments, the final milk protein proportion is in the range of 97% to 103% of the initial milk protein proportion. According to some embodiments, the final milk protein proportion is in the range of 98% to 102% of the initial milk protein proportion. According to some embodiments, the final milk protein proportion is in the range of 99% to 101% of the initial milk protein proportion.

According to some embodiments, the edible aqueous composition provided in step (a) has an initial sugar proportion (w/w), and the heat-treated edible aqueous composition obtained by the present method has a final sugar proportion (w/w). According to some embodiments, the final sugar proportion is in the range of 80% to 120% of the initial sugar proportion. According to some embodiments, the final sugar proportion is in the range of 90% to 110% of the initial sugar proportion. According to some embodiments, the final sugar proportion is in the range of 95% to 105% of the initial sugar proportion. According to some embodiments, the final sugar proportion is in the range of 97% to 103% of the initial sugar proportion. According to some embodiments, the final sugar proportion is in the range of 98% to 102% of the initial sugar proportion. According to some embodiments, the final sugar proportion is in the range of 99% to 101% of the initial sugar proportion.

The term “sugar”, as used herein, is intended to refer to any carbohydrate sweetener. Examples of sugars include sucrose, lactose, glucose, galactose and fructose.

According to some embodiments, the edible aqueous composition provided in step (a) has an initial fat proportion (w/w), and the heat-treated edible aqueous composition obtained by the present method has a final fat proportion (w/w). According to some embodiments, the final fat proportion is in the range of 80% to 120% of the initial fat proportion. According to some embodiments, the final fat proportion is in the range of 90% to 110% of the initial fat proportion. According to some embodiments, the final fat proportion is in the range of 95% to 105% of the initial fat proportion. According to some embodiments, the final fat proportion is in the range of 97% to 103% of the initial fat proportion. According to some embodiments, the final fat proportion is in the range of 98% to 102% of the initial fat proportion. According to some embodiments, the final fat proportion is in the range of 99% to 101% of the initial fat proportion.

According to some embodiments, the edible aqueous composition provided in step (a) has an initial mineral proportion (w/w), and the heat-treated edible aqueous composition obtained by the present method has a final mineral proportion (w/w). According to some embodiments, the final mineral proportion is in the range of 80% to 120% of the initial mineral proportion. According to some embodiments, the final mineral proportion is in the range of 90% to 110% of the initial mineral proportion. According to some embodiments, the final mineral proportion is in the range of 95% to 105% of the initial mineral proportion. According to some embodiments, the final mineral proportion is in the range of 97% to 103% of the initial mineral proportion. According to some embodiments, the final mineral proportion is in the range of 98% to 102% of the initial mineral proportion. According to some embodiments, the final mineral proportion is in the range of 99% to 101% of the initial mineral proportion.

According to some embodiments, the edible aqueous composition provided in step (a) has an initial vitamin proportion (w/w), and the heat-treated edible aqueous composition obtained by the present method has a final vitamin proportion (w/w). According to some embodiments, the final vitamin proportion is in the range of 80% to 120% of the initial vitamin proportion. According to some embodiments, the final vitamin proportion is in the range of 90% to 110% of the initial vitamin proportion. According to some embodiments, the final vitamin proportion is in the range of 95% to 105% of the initial vitamin proportion. According to some embodiments, the final vitamin proportion is in the range of 97% to 103% of the initial vitamin proportion. According to some embodiments, the final vitamin proportion is in the range of 98% to 102% of the initial vitamin proportion. According to some embodiments, the final vitamin proportion is in the range of 99% to 101% of the initial vitamin proportion.

According to some embodiments, the method of the present invention comprises: (a) providing an edible aqueous composition which comprises at least one milk protein; (b) providing hydrogen peroxide; (c) providing cystine; (d) contacting the edible aqueous composition with the hydrogen peroxide and the cystine to form a mixture; and (e) maintaining the mixture at a temperature of at least 60° C. for a time period of at least 1 second; thereby obtaining a heat-treated edible aqueous composition.

Specific reference is now made to step (a) of the present method, which introduces the edible aqueous composition. According to some embodiments, step (a) comprises providing an edible aqueous composition which comprises at least one milk protein.

The term “edible aqueous composition” is described above. According to some embodiments, the edible aqueous composition of step (a) comprises at least 5% water w/w based on the total weight of the composition. According to some embodiments, the edible aqueous composition of step (a) comprises at least 10% water w/w based on the total weight of the composition. According to some embodiments, the edible aqueous composition of step (a) comprises at least 20% water w/w based on the total weight of the composition. According to some embodiments, the edible aqueous composition of step (a) comprises at least 35% water w/w based on the total weight of the composition. According to some embodiments, the edible aqueous composition of step (a) comprises at least 50% water w/w based on the total weight of the composition. According to some embodiments, the edible aqueous composition of step (a) comprises at least 60% water w/w based on the total weight of the composition. According to some embodiments, the edible aqueous composition of step (a) comprises at least 75% water w/w based on the total weight of the composition. According to some embodiments, the edible aqueous composition of step (a) comprises at least 85% water w/w based on the total weight of the composition. According to some embodiments, the edible aqueous composition of step (a) comprises at least 90% water w/w based on the total weight of the composition.

According to some embodiments, the edible aqueous composition of step (a) comprises no more than 99% water w/w based on the total weight of the composition. According to some embodiments, the edible aqueous composition of step (a) comprises no more than 97% water w/w based on the total weight of the composition. According to some embodiments, the edible aqueous composition of step (a) comprises no more than 95% water w/w based on the total weight of the composition.

Specifically, as specific embodiment of the present invention provides milk alternative compositions, and as commercial milk typically includes 80% to 95% water w/w, the edible aqueous composition of step (a) may be formulated to include similar water content. According to some embodiments, the edible aqueous composition of step (a) comprises 80% to 95% water w/w based on the total weight of the composition.

According to some embodiments, the edible aqueous composition provided in step (a) comprises at least one protein. According to some embodiments, the protein is a milk protein. According to some embodiments, the protein is a whey protein. According to some embodiments, the milk protein is a whey protein.

As used herein, the term “milk protein” includes all proteins, which are present in animal milk and/or in animal milk-based products, and protein, which are analogs of such proteins, corresponding chimeric proteins, variants thereof etc. Thus, it is to be understood that the term “milk protein” includes natural variants (e.g., natural polymorphism of the amino acid sequence), protein analogs, and/or chimeric milk proteins. As used herein, the terms “protein variant” and “protein analog” refer to a naturally or non-naturally occurring amino acids sequence, respectively, which contains a substitution of at least one amino-acid, e.g., 1-3 amino-acids or 1-5 amino-acids, in comparison to a milk protein sequence. As used herein, the terms “chimeric milk protein” and “a milk protein chimera” are used interchangeably to refer to an amino acid sequence which is produced by the mixture or joining of at least two different, or separate sequences. In certain embodiments, the term “milk protein” relates to BLG, ALA (Alpha-lactalbumin) (whey proteins), αS1 casein, aS2 casein, β casein, and κ casein (casein proteins), or to corresponding chimeric proteins, variants or analogs thereof.

BLG variants are naturally occurring, known polymorphs of the BLG protein. For example, sequence ID Nos 1-10 are naturally occurring bovine BLG variants.

BLG analogs are non-naturally occurring (e.g., man-made) BLG amino acid sequences, each contains several amino acid substitution with respect to any one of the naturally occurring, known BLG variants. For example, sequence ID Nos 11-20 are BLG analogs.

Chimeric BLG may be for a non-limiting example a fusion of a bovine BLG and a human BLG.

In certain embodiments, the BLG analog has at least 95% amino acid sequence identity with a respective sequence selected from any of the BLG variants. In certain embodiments, the BLG analog has at least 91%, 92%, 93%, 94%, 95%, 96%, 97%, 98% or 99% sequence identity with a BLG variant. Each possibility represents a separate embodiment of the invention.

As used herein, the term “whey protein” refers to the proteins which are present in the serum phase of either milk or coagulated milk and further refers to protein, which are analogs of such proteins, corresponding chimeric proteins, variants thereof etc. The proteins of the serum phase of milk are also sometimes referred to as milk serum proteins or ideal whey. This term includes both proteins that are derived from whey or recombinant proteins, which may be produced by microorganisms.

A non-limiting example to a protein, which is considered both as milk protein and as a whey protein is beta lactoglobulin (BLG). Therefore, the corresponding recombinant beta-lactoglobulin B (rBLG) protein is likewise considered both as milk protein and as a whey protein. Similarly, any one of the BLG analogs, chimeric BLG, and BLG variants is considered both as milk protein and as a whey protein.

According to some embodiments, the at least one milk protein of step (a) comprises beta lactoglobulin (BLG). According to some embodiments, the BLG is a recombinant beta-lactoglobulin (rBLG) protein. According to some embodiments, the BLG is beta-lactoglobulin B (rBLG B).

The term “beta-lactoglobulin” (BLG) refers to a beta-lactoglobulin that is typically present in cow's milk or to BLG analogs, chimeric BLG, and BLG variants. According to some embodiments, the term BLG further refers to isoform B of the BLG, i.e., beta-Lactoglobulin B (β-BLG B), which is a small protein of 162 amino acids with a molecular mass of 18.2 kDa and optimum pH of 5.2 (UniProt D6QX31). Nevertheless, in some specific embodiments, the term BLG may refer to BLG-A isoform or to a combination of BLG-A and BLG-B.

The term “recombinant” refers to a polynucleotide, polypeptide or protein that does not naturally occur in a host cell. Thus, the BLG expressed in a microorganism such as Pichia pastoris and specifically BG11 is a recombinant BLG, denoted as rBLG. In some occurrences, rBLG may be, as explained above, BLG-B, BLG-A, or a mixture of BLG-A and BLG-B.

According to some embodiments the at least one milk protein comprises BLG, including variants, analogs and chimeras thereof. According to some embodiments the at least one milk protein comprises a BLG variant or analog. According to some embodiments the at least one milk protein comprises a BLG variant. According to some embodiments the at least one milk protein comprises bovine BLG. According to some embodiments, the BLG and/or rBLG is selected from amino acid sequence SEQ ID Nos: 1-20 as detailed in Table 1. Each possibility represents a separate embodiment of the invention. According to some embodiments, the BLG and/or rBLG is selected from amino acid sequence SEQ ID Nos: 1-10. According to some embodiments, the BLG and/or rBLG have the amino acid sequence SEQ ID NO: 1.

TABLE 1
Amino acid sequences of BLG variants and
analogs

| SEQ | |
|---|---|
| ID NO. | Sequence |
| 1 | LIVTQTMKGLDIQKVAGTWYSLAMAASDISLLDAQSAPLRV |
| | YVEELKPTPEGDLEILLQKWENGECAQKKIIAEKTKIPAVF |
| | KIDALNENKVLVLDTDYKKYLLFCMENSAEPEQSLACQCLV |
| | RTPEVDDEALEKEDKALKALPMHIRLS FNPTQLEEQCHI |
| 2 | LIVTQTMKGLDIQKVAGTWYSLAMAASDISLLDAQSAPLRV |
| | YVEELKPTPEGDLEILLQKWENDECAQKKIIAEKTKIPAVF |
| | KIDALNENKVLVLDTDYKKYLLFCMENSAEPEQSLVCQCLV |
| | RTPEVDDEALEKFDKALKALPMHIRLS FNPTQLEEQCHI |
| 3 | LIVTQTMKGLDIQKVAGTWYSLAMAASDISLLDAQSAPLRV |
| | YVEELKPTPEGDLEILLHKWENDECAQKKIIAEKTKIPAVF |
| | KIDALNENKVLVLDTDYKKYLLFCMENSAEPEQSLVCQCLV |
| | RTPEVDDEALEKFDKALKALPMHIRLS FNPTQLEEQCHI |
| 4 | LIVTQTMKGLDIQKVAGTWYSLAMAASDISLLDAQSAPLRV |
| | YVEQLKPTPEGDLEILLQKWENDECAQKKIIAEKTKIPAVF |
| | VKIDALNENKVLLDTDYKKYLLFCMENSAEPEQSLVCQCLV |
| | RTPEVDDEALEKFDKALKALPMHIRLS FNPTQLEEQCHI |
| 5 | LIVTQTMKGLDIQKVAGTWYSLAMAASNISLLDAQSAPLRV |
| | YVEELKPTPEGDLEILLQKWENDECAQKKIIAEKTKIPAVF |
| | KIDALNENKVLVLDTDYKKYLLFCMENSAEPEQSLVCQCLV |
| | RTPEVDDEALEKFDKALKALPMHIRLS FNPTQLEEQCHI |
| 6 | LIVTQTMKGLDIQKVAGTWYSLAMAASDISLLDAQSAPLRV |
| | YVEELKPTPEGDLEILLQKWENDECAQKKIIAEKTKIPAVF |
| | KIDALNENKVLVLDTDYKKYLLFCMENSAEPEQSLVCQCLV |
| | RTPEVDDEALEKFDKALKALPMHIRLS ENPTQLEGQCHI |
| 7 | LIVTQTMKGLDIQKVAGTWYSLAMAASDISLLDAQSAPLRV |
| | YVEELKPTSEGDLEILLQKWENDECAQKKIIAEKTKIPAVF |
| | KIDALNENKVLVLDTDYKKYLLFCMENSAEPEQSLVCQCLV |
| | RTPEVYYEALEKEDKALKALPMHIRLS FNPTQLEEQCHI |
| 8 | LIVTQTMKGLDIQKVAGTWYSLAMAASDISLLDAQSAPLRV |
| | YVEELKPTPEGDLEILLQKWENDECAQKKIIAEKTKMPAVF |
| | KIDALNENKVLVLDTDYKKYLLFCMENSAEPEQSLVCQCLV |
| | RTPEVDDEALEKFDKALKALPMHIRLS FNPTQLEGQCHI |
| 9 | LIVTQTMKGLDIQKVAGTWYSLAMAASDISLLDAQSAPLRV |
| | YVEELKPTPEGDLELLLQKWENDECAQKKIIAEKTKIPAVF |
| | KIDALNENKVLVLDTDYKKYLLFCMENSAEPEQSLVCQCLV |
| | RTPEVDDEALEKFDKALKALPMHIRLS FNPTQLEEQCHI |
| 10 | LIVTQTMKGLDIQKVAGTWYSLAMAASDISLLDAQSAPLRV |
| | YVEELKPTPEGDLEILLQKWENDECAQKKIIAEKTKIPAVF |
| | KIDALNENKVLVLDTDYKKYLLFCMGNSAEPEQSLVCQCLV |
| | RTPEVDDEALEKFDKALKALPMHIRLS FNPTQLEEQCHI |
| 11 | LIVTQTMKGLDIQKVAGTWYSLAMAASDISLLDAQSAPLRV |
| | YVEELKPTPEGDLEILLHKWENGECAQKKIIAEKTKIPAVF |
| | KIDALNENKVLVLDTDYKKYLLFCMENSAEPEQSLVCQCLV |
| | RTPEVDDEALEKEDKALKALPMHIRLS FNPTQLEEQCHI |
| 12 | LIVTQTMKGLDIQKVAGTWYSLAMAASDISLLDAQSAPLRV |
| | YVEELKPTPEGDLEILLHKWENDECAQKKIIAEKTKIPAVF |
| | KIDALNENKVLVLDTDYKKYLLFCMENSAEPEQSLVCQCLV |
| | RTPEVDDEALEKFDKALKALPMHIRLS FNPTQLEEQCHI |
| 13 | LIVTQTMKGLDIQKVAGTWYSLAMAASDISLLDAQSAPLRV |
| | YVEELKPTPEGDLEILLQKWENDECAQKKIIAEKTKMPAVF |
| | KIDALNENKVLVLDTDYKKYLLFCMENSAEPEQSLVCQCLV |
| | RTPEVDDEALEKEDKALKALPMHIRLS FNPTQLEGQCHI |
| 14 | LIVTQTMKGLDIQKVAGTWYSLAMAASDISLLDAQSAPLRV |
| | YVEELKPTPEGDLELLLQKWENDECAQKKIIAEKTKIPAVF |
| | KIDALNENKVLVLDTDYKKYLLFCMENSAEPEQSLVCQCLV |
| | RTPEVDDEALEKEDKALKALPMHIRLS FNPTQLEEQCHI |
| 15 | LIVTQTMKGLDIQKVAGTWYSLAMAASNISLLDAQSAPLRV |
| | YVEELKPTPEGDLEILLHKWENDECAQKKIIAEKTKIPAVF |
| | KIDALNENKVLVLDTDYKKYLLFCMENSAEPEQSLVCQCLV |
| | RTPEVDDEALEKEDKALKALPMHIRLS FNPTQLEEQCHI |
| 16 | LIVTQTMKGLDIQKVAGTWYSLAMAASDISLLDAQSAPLRV |
| | YVEELKPTPEGDLEILLHKWENDECAQKKIIAEKTKMPAVF |
| | KIDALNENKVLVLDTDYKKYLLFCMENSAEPEQSLVCQCLV |
| | RTPEVDDEALEKEDKALKALPMHIRLS FNPTQLEGQCHI |
| 17 | LIVTQTMKGLDIQKVAGTWYSLAMAASDISLLDAQSAPLRV |
| | YVEELKPTPEGDLELLLHKWENDECAQKKIIAEKTKIPAVF |
| | KIDALNENKVLVLDTDYKKYLLFCMENSAEPEQSLVCQCLV |
| | RTPEVDDEALEKEDKALKALPMHIRLS FNPTQLEEQCHI |
| 18 | LIVTQTMKGLDIQKVAGTWYSLAMAASNISLLDAQSAPLRV |
| | YVEELKPTPEGDLEILLQKWENDECAQKKIIAEKTKMPAVF |
| | KIDALNENKVLVLDTDYKKYLLFCMENSAEPEQSLVCQCLV |
| | RTPEVDDEALEKEDKALKALPMHIRLS FNPTQLEGQCHI |
| 19 | LIVTQTMKGLDIQKVAGTWYSLAMAASNISLLDAQSAPLRV |
| | YVEELKPTPEGDLELLLQKWENDECAQKKIIAEKTKIPAVF |
| | KIDALNENKVLVLDTDYKKYLLFCMENSAEPEQSLVCQCLV |
| | RTPEVDDEALEKEDKALKALPMHIRLS FNPTQLEEQCHI |
| 20 | LIVTQTMKGLDIQKVAGTWYSLAMAASDISLLDAQSAPLRV |
| | YVEELKPTPEGDLELLLQKWENDECAQKKIIAEKTKMPAVF |
| | KIDALNENKVLVLDTDYKKYLLFCMENSAEPEQSLVCQCLV |
| | RTPEVDDEALEKEDKALKALPMHIRLS FNPTQLEGQCHI |

According to some embodiments, the edible aqueous composition of step (a) comprises at least 0.4% of the at least one milk protein w/w based on the total weight of the composition. According to some embodiments, the edible aqueous composition of step (a) comprises at least 0.5% of the at least one milk protein w/w based on the total weight of the composition. According to some embodiments, the edible aqueous composition of step (a) comprises at least 1.0% of the at least one milk protein w/w based on the total weight of the composition. According to some embodiments, the edible aqueous composition of step (a) comprises at least 1.5% of the at least one milk protein w/w based on the total weight of the composition. According to some embodiments, the edible aqueous composition of step (a) comprises at least 2% of the at least one milk protein w/w based on the total weight of the composition. According to some embodiments, the edible aqueous composition of step (a) comprises at least 2.5% of the at least one milk protein w/w based on the total weight of the composition. According to some embodiments, the edible aqueous composition of step (a) comprises at least 3.0% of the at least one milk protein w/w based on the total weight of the composition. According to some embodiments, the edible aqueous composition of step (a) comprises at least 3.5% of the at least one milk protein w/w based on the total weight of the composition. According to some embodiments, the edible aqueous composition of step (a) comprises at least 4.0% of the at least one milk protein w/w based on the total weight of the composition.

According to some embodiments, the edible aqueous composition of step (a) comprises no more than 10% of the at least one milk protein w/w of the at least one milk protein based on the total weight of the composition. According to some embodiments, the edible aqueous composition of step (a) comprises no more than 8% of the at least one milk protein w/w of the at least one milk protein based on the total weight of the composition. According to some embodiments, the edible aqueous composition of step (a) comprises no more than 6% of the at least one milk protein w/w of the at least one milk protein based on the total weight of the composition. According to some embodiments, the edible aqueous composition of step (a) comprises no more than 5% of the at least one milk protein w/w of the at least one milk protein based on the total weight of the composition.

Specifically, as specific embodiment of the present invention provides milk alternative compositions, and as commercial milk typically includes 2.5% to 6% proteins w/w, the edible aqueous composition of step (a) may be formulated to include similar amount of the at least one milk protein content. According to some embodiments, the edible aqueous composition of step (a) comprises 2.5% to 6% of the at least one milk protein w/w based on the total weight of the composition. According to some embodiments, the edible aqueous composition of step (a) comprises 2.5% to 6% of BLG w/w based on the total weight of the composition. According to some embodiments, the edible aqueous composition of step (a) comprises 2.5% to 6% of rBLG w/w based on the total weight of the composition. According to some embodiments, the edible aqueous composition of step (a) comprises 3% to 3.5% of the at least one milk protein w/w based on the total weight of the composition. According to some embodiments, the edible aqueous composition of step (a) comprises 3% to 3.5% of BLG w/w based on the total weight of the composition. According to some embodiments, the edible aqueous composition of step (a) comprises 3% to 3.5% of rBLG w/w based on the total weight of the composition. According to some embodiments, the edible aqueous composition of step (a) comprises 4% to 5% of the at least one milk protein w/w based on the total weight of the composition. According to some embodiments, the edible aqueous composition of step (a) comprises 4% to 5% of BLG w/w based on the total weight of the composition. According to some embodiments, the edible aqueous composition of step (a) comprises 4% to 5% of rBLG w/w based on the total weight of the composition. According to some embodiments, the edible aqueous composition of step (a) comprises 4% to 6% of the at least one milk protein w/w based on the total weight of the composition. According to some embodiments, the edible aqueous composition of step (a) comprises 4% to 6% of BLG w/w based on the total weight of the composition. According to some embodiments, the edible aqueous composition of step (a) comprises 4% to 6% of rBLG w/w based on the total weight of the composition. According to some embodiments, the edible aqueous composition of step (a) comprises 5% to 6% of the at least one milk protein w/w based on the total weight of the composition. According to some embodiments, the edible aqueous composition of step (a) comprises 5% to 6% of BLG w/w based on the total weight of the composition. According to some embodiments, the edible aqueous composition of step (a) comprises 5% to 6% of rBLG w/w based on the total weight of the composition.

According to some embodiments, BLG constitutes at least 51% w/w of the total milk-protein content of the edible aqueous composition of step (a). According to some embodiments, BLG constitutes at least 60% w/w of the total milk-protein content of the edible aqueous composition of step (a). According to some embodiments, BLG constitutes at least 70% w/w of the total milk-protein content of the edible aqueous composition of step (a). According to some embodiments, BLG constitutes at least 80% w/w of the total milk-protein content of the edible aqueous composition of step (a). According to some embodiments, BLG constitutes at least 90% w/w of the total milk-protein content of the edible aqueous composition of step (a). According to some embodiments, BLG constitutes at least 95% w/w of the total milk-protein content of the edible aqueous composition of step (a). According to some embodiments, BLG constitutes at least 99% w/w of the total milk-protein content of the edible aqueous composition of step (a). According to some embodiments, the edible aqueous composition of step (a) comprises BLG substantially as the sole whey protein. According to some embodiments, the edible aqueous composition of step (a) comprises BLG substantially as the sole milk protein. According to some embodiments, the edible aqueous composition of step (a) comprises BLG substantially as the sole protein.

According to some embodiments, the at least one milk protein is a non-animal protein.

The term “animal protein” as used herein means any protein substance derived from an animal. The term encompasses proteins derived from dairy, fish, or meat sources.

The term “non-animal protein” as used herein means any protein that is not obtained from an animal source. The term encompasses proteins derived from plants, microorganisms, as well as synthetic proteins.

According to some embodiments, the at least one milk protein is provided from a non-animal source. Thus, according to some embodiments, step (i) comprises providing an edible aqueous composition, which comprises at least one non-animal milk protein. It is to be understood that in the context of the present invention and under the definitions above, a non-animal milk protein refers to any milk protein, which is provided, produced, extracted or derived from a non-animal source, as defined above. According to some embodiments, the at least one milk protein is a recombinant protein.

According to some embodiments, the edible aqueous composition provided in step (a) comprises at least one fat. According to some embodiments, the fat is a milk fat. According to some embodiments, the fat is a whey fat. According to some embodiments, the milk fat is a whey fat.

As used herein, the term “milk fat” means all fats, which is present in milk and/or in milk-based products. This includes both fats that are derived from milk or its products and fat, which are derived from other sources, as long as they are corresponding to fats, which are present in milk and/or in milk-based products.

The phrase “corresponding fats” in the context of the present invention refers to two or more fats which share the chemical formula.

As used herein, the term “whey fat” refers to the fats which are present in the serum phase of either milk or coagulated milk. This term includes both fats that are derived from whey or its products and fat, which are provided from other sources as long as they are corresponding to fats, which are present in whey and/or in whey-based products.

Milk fat may be defined by its composition, and specifically by the distribution of fatty acids composition the triglyceride mixture thereof. Table 2 is provided below as an example for the fatty acid distribution (gram fatty acid per 100 gram milk fat) in cow milk, sheep milk and goat milk.

TABLE 2
Fatty acid distribution in cow milk, sheep milk and goat milk

| Triglyceride | Cow milk | Sheep Milk | Goat milk |
|---|---|---|---|
| C4 | 2.87 | 2.57 | 2.03 |
| C6 | 2.01 | 1.87 | 2.78 |
| C8 | 1.39 | 1.87 | 2.92 |
| C10 | 3.03 | 6.63 | 9.59 |
| C12 | 3.64 | 3.99 | 4.52 |
| C14 | 10.92 | 10.17 | 9.83 |
| C16 | 28.7 | 25.1 | 24.64 |
| C18:0 | 11.23 | 8.85 | 8.87 |
| C18:1 | 22.36 | 20.18 | 18.65 |
| C18:2 | 3.14 | 3.08 | 2.7 |
| C18:3 | 0.5 | 0.92 | 0.77 |

According to some embodiments, the edible aqueous composition of step (a) comprises at least 0.5% total fat portion based on the total weight of the composition. According to some embodiments, the edible aqueous composition of step (a) comprises at least 1% total fat portion based on the total weight of the composition. According to some embodiments, the edible aqueous composition of step (a) comprises at least 1.5% total fat portion based on the total weight of the composition. According to some embodiments, the edible aqueous composition of step (a) comprises at least 2% total fat portion based on the total weight of the composition. According to some embodiments, the edible aqueous composition of step (a) comprises at least 2.25% total fat portion based on the total weight of the composition. According to some embodiments, the edible aqueous composition of step (a) comprises at least 2.5% total fat portion based on the total weight of the composition. According to some embodiments, the edible aqueous composition of step (a) comprises at least 2.75% total fat portion based on the total weight of the composition. According to some embodiments, the edible aqueous composition of step (a) comprises at least 3% total fat portion based on the total weight of the composition.

According to some embodiments, the edible aqueous composition of step (a) comprises no more than 50% total fat portion based on the total weight of the composition. According to some embodiments, the edible aqueous composition of step (a) comprises no more than 35% total fat portion based on the total weight of the composition. According to some embodiments, the edible aqueous composition of step (a) comprises no more than 25% total fat portion based on the total weight of the composition. According to some embodiments, the edible aqueous composition of step (a) comprises no more than 15% total fat portion based on the total weight of the composition. According to some embodiments, the edible aqueous composition of step (a) comprises no more than 10% total fat portion based on the total weight of the composition. According to some embodiments, the edible aqueous composition of step (a) comprises no more than 8% total fat portion based on the total weight of the composition. According to some embodiments, the edible aqueous composition of step (a) comprises no more than 6% total fat portion based on the total weight of the composition. According to some embodiments, the edible aqueous composition of step (a) comprises no more than 5% total fat portion based on the total weight of the composition. According to some embodiments, the edible aqueous composition of step (a) comprises no more than 4% total fat portion based on the total weight of the composition. According to some embodiments, the edible aqueous composition of step (a) comprises no more than 3.5% total fat portion based on the total weight of the composition.

Specifically, as specific embodiment of the present invention provides milk alternative compositions, and as commercial milk typically includes 1% to 5% or 3% to 3.5% fat content w/w, the edible aqueous composition of step (a) may be formulated to include similar amount of the fat content.

According to some embodiments, the at least one milk fat is a non-animal fat.

The term “animal fat” as used herein means any fat substance derived from at least one animal. The term encompasses fats derived from dairy, fish, or meat sources.

The term “non-animal fat” as used herein means any fat that is not obtained from an animal source. The term encompasses fats derived from plants, microorganisms or fungi, as well as synthetic fats.

According to some embodiments, the edible aqueous composition provided in step (a) comprises at least one vegetable fat. According to some embodiments, the edible aqueous composition provided in step (a) comprises at least one fat which is not present in an animal fat. It is to be understood that milk alternative products may include a mixture of fats, some of which are corresponding (i.e., sharing the same chemical formula) to fats found in animal milk, and some of which are not found in animal milk, where preferable, each of the fats is not provided from animals.

According to some embodiments, the at least one milk fat is provided from a non-animal source. Thus, according to some embodiments, step (a) comprises providing an edible aqueous composition, which comprises at least one non-animal milk fat. It is to be understood that in the context of the present invention and under the definitions above, a non-animal milk fat refers to any milk fat, which is provided, produced, extracted or derived from a non-animal source, as defined above.

According to some embodiments, the edible aqueous composition provided in step (a) comprises at least one sweetener.

As used herein, the term “sweetener(s)” includes all artificial and natural sweeteners, sugar alcohols (or polyols) and sugar sweeteners (or carbohydrates). Artificial and natural sweeteners include but are not limited to abiziasaponin, abrusosides, in particular abrusoside A, abrusoside B, abrusoside C, abrusoside D, acesulfame potassium, advantame, albiziasaponin, alitame, aspartame, superaspartame, bayunosides, in particular bayunoside 1, bayunoside 2, brazzein, bryoside, bryonoside, bryonodulcoside, carnosifloside, carrelame, curculin, cyanin, chlorogenic acid, cyclamates and its salts, cyclocaryoside I, dihydroquercetin-3-acetate, dihydroflavenol, dulcoside, gaudichaudioside, glycyrrhizin, glycyrrhetin acid, gypenoside, hematoxylin, hernandulcin, isomogrosides, in particular iso-mogroside V, lugduname, magap, mabinlins, micraculin, mogrosides (lo han guo), in particular mogroside IV and mogroside V, monatin and its derivatives, monellin, mukurozioside, naringin dihydrochalcone (NarDHC), neohesperidin dihydrochalcone (NDHC), neotame, osladin, pentadin, periandrin I-V, perillartine, D-phenylalanine, phlomisosides, in particular phlomisoside 1, phlomisoside 2, phlomisoside 3, phlomisoside 4, phloridzin, phyllodulcin, polpodiosides, polypodoside A, pterocaryosides, rebaudiosides, in particular rebaudioside A, rebaudioside B, rebaudioside C, rebaudioside D, rebaudioside F, rebaudioside G, rebaudioside H), rubusosides, saccharin and its salts and derivatives, scandenoside, selligueanin A, siamenosides, in particular siamenoside I, stevia, steviolbioside, stevioside and other steviol glycosides, strogines, in particular strogin 1, strogin 2, strogin 4, suavioside A, suavioside B, suavioside G, suavioside H, suavioside I, suavioside J, sucralose, sucronate, sucrooctate, talin, telosmoside A15, thaumatin, in particular thaumatin I and II, trans-anethol, trans-cinnamaldehyde, trilobatin and D-tryptophane, including extracts or enriched fractions of the natural sweeteners. Sugar alcohols (or polyols) include but are not limited to erythritol, galactitol, hydrogenated starch syrups including maltitol and sorbitol syrups, inositols, isomalt, lactitol, maltitol, mannitol, xylitol, and combinations thereof. Sugar sweeteners (or carbohydrates) include monosaccharides, disaccharides, oligosaccharides and polysaccharides such as but not limited to arabinose, dextrin, dextrose, fructose, high fructose corn syrup, fructooligosaccharides, fructooligosaccharide syrups, galactose, galactooligosaccharides, glucose, glucose and (hydrogenated) starch syrups/hydrolysates, isomaltulose, lactose, hydrolysed lactose, maltose, mannose, rhamnose, ribose, sucrose, stachyose, tagatose, trehalose, xylose, and combinations thereof.

According to some embodiments, the sweetener is a sugar. According to some embodiments, the sugar comprises at least one monosaccharide, at least one disaccharide, or a combination thereof.

According to some embodiments, the sugar is selected from the group consisting of glucose, fructose, mannose, xylose, arabinose, sucrose, dextrose, maltose, and galactose. According to some embodiments, the sugar comprises maltose. According to some embodiments, the sweetener is selected from the group consisting of glucose, fructose, mannose, xylose, arabinose, sucrose, dextrose, maltose, and galactose. According to some embodiments, the sweetener comprises maltose.

According to some embodiments, the sugar does not include lactose. According to some embodiments, the disaccharide does not include lactose. According to some embodiments, the edible aqueous composition provided in step (a) is substantially devoid of lactose. According to some embodiments, the edible aqueous composition provided in step (a) is devoid of lactose.

As used herein, “substantially devoid” means a preparation or composition according to the invention that generally contains less than 1%, less than 0.5%, less than 0.3%, less than 0.1% w/w, or is completely devoid of the stated substance. Each possibility represents a separate embodiment of the invention.

According to some embodiments, the edible aqueous composition of step (a) comprises at least 0.5% total sugar portion based on the total weight of the composition. According to some embodiments, the edible aqueous composition of step (a) comprises at least 1% total sugar portion based on the total weight of the composition. According to some embodiments, the edible aqueous composition of step (a) comprises at least 1.5% total sugar portion based on the total weight of the composition. According to some embodiments, the edible aqueous composition of step (a) comprises at least 2% total sugar portion based on the total weight of the composition. According to some embodiments, the edible aqueous composition of step (a) comprises at least 2.25% total sugar portion based on the total weight of the composition. According to some embodiments, the edible aqueous composition of step (a) comprises at least 2.5% total sugar portion based on the total weight of the composition. According to some embodiments, the edible aqueous composition of step (a) comprises at least 2.75% total sugar portion based on the total weight of the composition. According to some embodiments, the edible aqueous composition of step (a) comprises at least 3% total sugar portion based on the total weight of the composition.

According to some embodiments, the edible aqueous composition of step (a) comprises no more than 5% total sugar portion based on the total weight of the composition. According to some embodiments, the edible aqueous composition of step (a) comprises no more than 4% total sugar portion based on the total weight of the composition. According to some embodiments, the edible aqueous composition of step (a) comprises no more than 3.5% total sugar portion based on the total weight of the composition. According to some embodiments, the edible aqueous composition of step (a) comprises no more than 3% total sugar portion based on the total weight of the composition.

Specifically, as specific embodiment of the present invention provides milk alternative compositions, and as commercial milk typically includes 1.5% to 5% sugar content w/w, the edible aqueous composition of step (a) may be formulated to include similar amount of the sugar content.

As detailed above, it is to be understood that both artificial and natural sweeteners are encompassed in the present invention. While the relative content of sugar sweeteners is specified above, a corresponding content of non-sugar sweeteners encompassed by the present invention corresponds to the sweetness imparted by the contents above, by non-sugar sweeteners.

According to some embodiments, the sweetener is provided from a non-animal source. Thus, according to some embodiments, step (i) comprises providing an edible aqueous composition, which comprises at least one sweetener from a non-animal source.

According to some embodiments, the edible aqueous composition provided in step (a) comprises at least one stabilizer. According to some embodiments, the at least one stabilizer functions as a mineral chelator. According to some embodiments, the at least one stabilizer comprises a mineral chelator.

The term “chelation” refers to is a type of bonding of ions and molecules to metal ions. It involves the formation or presence of two or more separate coordinate bonds between a polydentate (multiple bonded) ligand and a single central metal atom. These ligands are called “chelators” or “chelating agents”. Chelators include, but are not limited to, citrate salts, phosphonate salts, ethylenediamine-carboxylic acids (e.g., ethylenediaminetetraacetic acid (EDTA) or ethylenediamine-N,N′-disuccinic acid (EDDS)) and the like. In the context of the present invention, mineral chelators include compound, which form coordination bonding with the minerals present in edible aqueous compositions. For example, minerals present in milk and milk alternative products include calcium, magnesium, potassium, and zinc. Thus, mineral chelators include the compound(s) that form chelation with such minerals within a milk alternative composition, according to some embodiments.

According to some embodiments, the edible aqueous composition provided in step (a) is stabilized by at least one stabilizer. According to some embodiments, the edible aqueous composition provided in step (a) comprises at least one citrate salt. According to some embodiments, the edible aqueous composition provided in step (a) comprises trisodium citrate.

According to some embodiments, the edible aqueous composition provided in step (a) is substantially devoid of any ingredient derived from animal source. According to some embodiments, the edible aqueous composition provided in step (a) comprises at least one ingredient, which is not present in animal milk. It is to be understood that the phrase “comprises at least one ingredient, which is not present in animal milk” refers to a composition, in which at least one ingredient does not have any corresponding ingredient in animal milk”. The specific ingredients of a milk alternative composition according to the present invention is listed hereinbelow in sections relevant thereto.

According to some embodiments, the edible aqueous composition of step (a) imparts an animal milk perception. Thus, according to some embodiments, step (a) comprises providing an edible aqueous composition, which imparts an animal milk perception.

The term “animal milk perception” as used herein refers to the overall sensory sensation experienced by an individual (e.g., human) upon consumption of animal milk. Specifically, a material, composition or compound, which is characterized as imparting animal milk perception is resembling in the oral experience of the individual to the experience with animal milk. The perception includes organoleptic properties such as taste, aroma, flavor, savor, and other related properties.

The term “organoleptic properties” refers to the aspects of food, water or other substances that create an individual experience via the senses, including but not limited to, taste, sight, smell, and touch. Thus, a composition or compound, which imparts milk organoleptic properties is perceived by subjects as if it was an animal milk, irrespective of the origin of the composition or compound (i.e., whether or not it is actually an animal milk).

According to some embodiments, the edible aqueous composition of step (a) has a pH of at least 6. According to some embodiments, the edible aqueous composition of step (a) has a pH of at least 6.25. According to some embodiments, the edible aqueous composition of step (a) has a pH of at least 6.5. According to some embodiments, the edible aqueous composition of step (a) has a pH of at least 6.6. According to some embodiments, the edible aqueous composition of step (a) has a pH of no more than 8. According to some embodiments, the edible aqueous composition of step (a) has a pH of no more than 7.75. According to some embodiments, the edible aqueous composition of step (a) has a pH of no more than 7.5. According to some embodiments, the edible aqueous composition of step (a) has a pH of no more than 7.2.

Specifically, as specific embodiment of the present invention provides milk alternative compositions, and as commercial milk typically has pH of 6.7 to 6.9 or 6.6 to 7.4, the edible aqueous composition of step (a) may be formulated to include similar pH. According to some embodiments, the edible aqueous composition of step (a) has a pH in the range of 6.7 to 6.9. According to some embodiments, the edible aqueous composition of step (a) has a pH in the range of 6.6 to 7.4. According to some embodiments, the edible aqueous composition of step (a) has a physiological pH.

According to the EU Standards for bacteria count in milk, in force 1 Jan. 1993 (World J. Dairy & Food Sci., 2 (2): 49-53, 2007) the bacterial plate count standard for raw milk is below 100,000 Colony Forming Units (CFU) per 1 ml. The corresponding standard for raw milk stored in silo at the dairy for more than 36 hours is below 100,000 CFU per 1 ml. The EU standard for pasteurized milk is below 30,000 CFU per 1 ml and for pasteurized milk after incubation for 5 days at 8° C. it is below 100,000 CFU per 1 ml. Lastly, the EU standard for UHT-treated milk is below 10 CFU per 1 ml.

According to some embodiments, the edible aqueous composition of step (a) has a bacterial count of below 10 CFU per 1 ml. According to some embodiments, the edible aqueous composition of step (a) has a bacterial count of below 1 CFU per 1 ml.

Also, while it is an intention of the present invention to at least partially sterilize the edible aqueous composition of step (a), this edible aqueous composition is provided before undergoing any sterilization or any other heat treatment, according to some embodiments.

Thus, according to some embodiments, the edible aqueous composition of step (a) is devoid of hydrogen peroxide. According to some embodiments, the edible aqueous composition of step (a) is devoid of cystine. According to some embodiments, the edible aqueous composition of step (a) is devoid of cystine and hydrogen peroxide.

According to some embodiments, the edible aqueous composition of step (a) comprises: (i) at least one milk protein; (ii) optionally, at least one citrate salt; (iii) at least one sweetener; (iv) at least one non-animal fat; and (v) water.

According to some embodiments, the edible aqueous composition of step (a) comprises the at least one citrate salt.

According to some embodiments, the at least one milk protein comprises beta lactoglobulin (BLG), the at least one citrate salt comprises trisodium citrate, and the at least one sweetener comprises maltose.

According to some embodiments, the edible aqueous composition of step (a) comprises: (i) BLG; (ii) trisodium citrate; (iii) a sweetener selected from the group consisting of glucose, fructose, mannose, xylose, arabinose, sucrose, dextrose, maltose, and galactose; (iv) non-animal fat; and (v) water.

According to some embodiments, the edible aqueous composition of step (a) comprises: (i) BLG, 2.5% to 6% w/w; (ii) trisodium citrate, 0.1% to 0.3% w/w; (iii) maltose, 1.5% to 3% w/w; (iv) non-animal fat, 2% to 4% w/w; and (v) water, 87% to 95% w/w.

According to some embodiments, the edible aqueous composition of step (a) is prepared by performing steps (a1) to (a3): (a1) combining the at least one milk protein, the at least one citrate salt, and the at least one sweetener with water to form an aqueous mixture; (a2) adding the at least one non-animal fat to the aqueous mixture of step (a1), to form a fatty aqueous mixture; and (a3) adjusting the fatty aqueous mixture of step (a2) to a pH in the range of 6.6 to 7.2.

It is to be understood that embodiments presented in the present disclosure, which relates to the least one milk protein, the at least one non-animal fat, the at least one citrate salt and the least one sweetener may apply to steps (a1) to (a3) of preparing the edible aqueous composition of step (a).

According to some embodiments, step (a1) is performed at a temperature in the range of 30° C. to 60° C.

According to some embodiments, step (a1) comprises dissolving the at least one milk protein in an aqueous solution comprising the at least one citrate salt and at least one sweetener.

According to some embodiments, step (a1) comprises mixing the milk protein, the at least one citrate salt and the at least one sweetener and hydrating the formed mixture until the milk protein is dissolved. According to some embodiments, the hydrating includes mixing. According to some embodiments, the hydrating is performed at about 40° C. According to some embodiments, the hydrating entails mixing the milk protein, the at least one citrate salt and the at least one sweetener in water at about 400 RPM until dissolution of the milk protein.

According to some embodiments, the method further comprising after step (a1), adjusting the pH of the aqueous mixture formed in step (a1) to a pH in the range of 6.6 to 7.4 to form a pH adjusted aqueous mixture. According to some embodiments, the pH range is 6.8 to 7. According to some embodiments, the pH range is 7.2 to 7.4. According to some embodiments, adjusting the pH entails adding a base to the aqueous mixture formed in step (a1). According to some embodiments, adjusting the pH entails adding a basic aqueous solution to the aqueous mixture formed in step (a1). According to some embodiments, the basic aqueous solution comprises a hydroxide base. According to some embodiments, the hydroxide base comprises sodium hydroxide. According to some embodiments, the basic aqueous solution comprises 0.5M NaOH. According to some embodiments, the aqueous mixture to which at least one non-animal fat is added, is the pH adjusted aqueous mixture.

According to some embodiments, step (a2) is performed at a temperature in the range of 40° C. to 80° C.

According to some embodiments, step (a2) entails melting the least one non-animal fat at a temperature in the range of 40° C. to 80° C. and combining the melted non-animal fat with the aqueous mixture. According to some embodiments, step (a2) entails melting the least one non-animal fat at a temperature in the range of about 45° C. and combining the melted non-animal fat with the aqueous mixture.

According to some embodiments, step (a2) further comprises mixing the non-animal fat with the aqueous mixture until a stable composition is formed. According to some embodiments, step (a2) further comprises mixing the non-animal fat with the aqueous mixture at 40° C. to 90° C. According to some embodiments, step (a2) further comprises mixing the non-animal fat with the aqueous mixture at about 60° C. According to some embodiments, step (a2) further comprises mixing the non-animal fat with the aqueous mixture for 5 to 240 minutes. According to some embodiments, step (a2) further comprises mixing the non-animal fat with the aqueous mixture for about 320 minutes.

According to some embodiments, step (a2) further comprises mixing the non-animal fat with the aqueous mixture at 200 RPM to 1500 RPM. According to some embodiments, step (a2) further comprises mixing the non-animal fat with the aqueous mixture at about 60 minutes.

According to some embodiments, step (a2) comprises adding the non-animal fat over 5 minutes to 100 minutes.

According to some embodiments, the method further comprises after step (a2) homogenizing the fatty aqueous mixture formed in step (a2). According to some embodiments, the homogenization is performed at 150 to 400 Bar. According to some embodiments, the homogenization is performed at about 250 Bar.

According to some embodiments, step (a3) comprises adding to the fatty aqueous mixture of step (a2) NaOH until reaching a pH in the range of 6.8 to 7.0.

According to some embodiments, adjusting the fatty aqueous mixture of step (a2) entails adding a base to the fatty aqueous mixture of step (a2). According to some embodiments, adjusting the pH entails adding a basic aqueous solution to the aqueous fatty mixture formed in step (a2). According to some embodiments, the basic aqueous solution comprises a hydroxide base. According to some embodiments, the hydroxide base comprises sodium hydroxide. According to some embodiments, the basic aqueous solution comprises 0.5M NaOH.

According to some embodiments, the edible aqueous composition of step (a) is prepared by performing steps (a1) to (a3): (a1) combining recombinant beta-lactoglobulin B (rBLG), trisodium citrate and maltose, with water at 35° C.-50° C. to form an aqueous mixture; (a2) adding vegetable fat to the aqueous mixture of step (a1) at 50° C.-80° C. for 5 minutes to 100 minutes, and agitating the formed mixture, homogenizing the formed mixture, or both to form a fatty aqueous mixture; and (a3)-adding to the fatty aqueous mixture a basic solution comprising NaOH until reaching a pH in the range of 6.8 to 7.0.

According to some embodiments, the edible aqueous composition of step (a) is a milk alternative composition. According to some embodiments, the edible aqueous composition of step (a) is in the form of an emulsion. According to some embodiments, the edible aqueous composition of step (a) is in the form of a fat-in-water emulsion.

According to some embodiments, the edible aqueous composition of step (a) is the stable milk alternative composition according to the present invention. Embodiments relating to the stable milk alternative composition are described in detail below.

Specific reference is now made to step (b) of the present method, which comprises providing hydrogen peroxide.

Hydrogen peroxide is a chemical compound with the formula H₂O₂. In its pure form, it is a very pale blue liquid that is slightly more viscous than water. It is used as an oxidizer, bleaching agent, and antiseptic, usually as a dilute solution (3%-6% w/w) in water for consumer use, and in higher concentrations of about 30% w/w for industrial use. Preferably for the purpose of the present invention, small amounts of hydrogen peroxide are allowed in food products. Specifically, hydrogen peroxide is an effective milk preservative on its own and in combination with heat. Also, Addition of H₂O₂ to raw milk, is approved by the Codex Alimentarius Commission in 1991 (FAO/WHO 1991). Food and Agriculture Organization of the United Nations permits the addition of H₂O₂ to milk at 0.05%-0.25% (500-2500 mg/L) yet requires its elimination in the final product to 0.5 ppm through enzymatic actions or other. In the USA, H₂O₂ can be added to milk (at 0.05%) to make certain types of cheese.

Provided below are amounts and concentration of the hydrogen peroxide provides and employed in the present method. As hydrogen peroxide is typically provided as an aqueous solution, the person having ordinary skill in the art could appreciate the corresponding amount of hydrogen peroxide solution required to achieve an equal amount of hydrogen peroxide. For example, when using a 30% w/w aqueous H₂O₂, 3 ppm hydrogen peroxide (based on a total specified composition) would correspond to 10 ppm of the 30% solution. Similarly, when using the same 30% w/w aqueous H₂O₂, 30 ppm hydrogen peroxide would correspond to 100 ppm of the 30% solution. In additional examples, when using a 3% w/w aqueous H₂O₂, 3 ppm and 30 ppm hydrogen peroxide (based on a total specified composition) would correspond to 100 ppm and 1000 ppm of the 3% solution respectively.

For low weight percentages, the term “ppm”, corresponding to parts per million on a weight/weight basis is typically used herein, wherein 1% w/w corresponds to 10,000 ppm, and 1 ppm corresponds to 1/1,000,000 which equals 0.000001 or 0.0001% w/w.

According to some embodiments, step (b) comprises providing at least 1 ppm hydrogen peroxide, based on the weight of the edible aqueous composition provided in step (a). According to some embodiments, step (b) comprises providing at least 2 ppm hydrogen peroxide, based on the weight of the edible aqueous composition provided in step (a). According to some embodiments, step (b) comprises providing at least 3 ppm hydrogen peroxide, based on the weight of the edible aqueous composition provided in step (a). According to some embodiments, step (b) comprises providing at least 5 ppm hydrogen peroxide, based on the weight of the edible aqueous composition provided in step (a). According to some embodiments, step (b) comprises providing at least 10 ppm hydrogen peroxide, based on the weight of the edible aqueous composition provided in step (a). According to some embodiments, step (b) comprises providing at least 20 ppm hydrogen peroxide, based on the weight of the edible aqueous composition provided in step (a). According to some embodiments, step (b) comprises providing at least 30 ppm hydrogen peroxide, based on the weight of the edible aqueous composition provided in step (a). According to some embodiments, step (b) comprises providing at least 40 ppm hydrogen peroxide, based on the weight of the edible aqueous composition provided in step (a). According to some embodiments, step (b) comprises providing at least 50 ppm hydrogen peroxide, based on the weight of the edible aqueous composition provided in step (a). According to some embodiments, step (b) comprises providing at least 60 ppm hydrogen peroxide, based on the weight of the edible aqueous composition provided in step (a). According to some embodiments, step (b) comprises providing at least 70 ppm hydrogen peroxide, based on the weight of the edible aqueous composition provided in step (a). According to some embodiments, step (b) comprises providing at least 80 ppm hydrogen peroxide, based on the weight of the edible aqueous composition provided in step (a). According to some embodiments, step (b) comprises providing at least 90 ppm hydrogen peroxide, based on the weight of the edible aqueous composition provided in step (a). According to some embodiments, step (b) comprises providing at least 100 ppm hydrogen peroxide, based on the weight of the edible aqueous composition provided in step (a).

According to some embodiments, step (b) comprises providing no more than 100 ppm hydrogen peroxide, based on the weight of the edible aqueous composition provided in step (a). According to some embodiments, step (b) comprises providing no more than 50 ppm hydrogen peroxide, based on the weight of the edible aqueous composition provided in step (a). According to some embodiments, step (b) comprises providing no more than 40 ppm hydrogen peroxide, based on the weight of the edible aqueous composition provided in step (a). According to some embodiments, step (b) comprises providing no more than 30 ppm hydrogen peroxide, based on the weight of the edible aqueous composition provided in step (a). According to some embodiments, step (b) comprises providing no more than 20 ppm hydrogen peroxide, based on the weight of the edible aqueous composition provided in step (a). According to some embodiments, step (b) comprises providing no more than 10 ppm hydrogen peroxide, based on the weight of the edible aqueous composition provided in step (a).

According to some embodiments, step (b) comprises providing 3 ppm to 30 ppm hydrogen peroxide, based on the weight of the edible aqueous composition provided in step (a).

According to some embodiments, step (b) comprises providing a hydrogen peroxide aqueous solution. According to some embodiments, the aqueous solution comprises about 30% hydrogen peroxide w/w.

According to some embodiments, step (b) comprises providing 10 ppm to 100 ppm of the about 30% w/w hydrogen peroxide aqueous solution, based on the weight of the edible aqueous composition provided in step (a).

As detailed herein, the incorporation of the hydrogen peroxide (as a combination with cystine) is intended to reduce the sensoric (sensory) effect of sulfuric thermal decomposition products of the least one milk protein during the heat treatment in step (e). Therefore, the required amount of hydrogen peroxide depends on the amount of the least one milk protein. Thus, the amount of hydrogen peroxide provided in step (b) may be defined as a proportion of the least one milk protein. A non-limiting numerical example is as follows: a starting composition of edible aqueous composition according to step (a) may include BLG 5% w/w and 25 ppm hydrogen peroxide, which corresponds to 0.0025% w/w (both values are based on the total weight of the composition). Therefore, the weight ratio in this example of hydrogen peroxide to BLG is 1:2000.

According to some embodiments, the weight ratio of hydrogen peroxide to the at least one milk protein is at least 1:50000. According to some embodiments, the weight ratio of hydrogen peroxide to the at least one milk protein is at least 1:25000. According to some embodiments, the weight ratio of hydrogen peroxide to the at least one milk protein is at least 1:20000. According to some embodiments, the weight ratio of hydrogen peroxide to the at least one milk protein is at least 1:10000. According to some embodiments, the weight ratio of hydrogen peroxide to the at least one milk protein is at least 1:5000. According to some embodiments, the weight ratio of hydrogen peroxide to the at least one milk protein is at least 1:2500. According to some embodiments, the weight ratio of hydrogen peroxide to the at least one milk protein is at least 1:1000. According to some embodiments, the weight ratio of hydrogen peroxide to the at least one milk protein is at least 1:500. According to some embodiments, the weight ratio of hydrogen peroxide to the at least one milk protein is at least 1:250. According to some embodiments, the weight ratio of hydrogen peroxide to the at least one milk protein is at least 1:100. According to some embodiments, the weight ratio of hydrogen peroxide to the at least one milk protein is at least 1:50.

According to some embodiments, the weight ratio of hydrogen peroxide to BLG is at least 1:50000. According to some embodiments, the weight ratio of hydrogen peroxide to BLG is at least 1:25000. According to some embodiments, the weight ratio of hydrogen peroxide to BLG is at least 1:10000. According to some embodiments, the weight ratio of hydrogen peroxide to BLG is at least 1:5000. According to some embodiments, the weight ratio of hydrogen peroxide to BLG is at least 1:2500.

According to some embodiments, the weight ratio of hydrogen peroxide to BLG is at least 1:1000. According to some embodiments, the weight ratio of hydrogen peroxide to BLG is at least 1:500. According to some embodiments, the weight ratio of hydrogen peroxide to BLG is at least 1:250. According to some embodiments, the weight ratio of hydrogen peroxide to BLG is at least 1:100. According to some embodiments, the weight ratio of hydrogen peroxide to BLG is at least 1:50.

It is to be understood that in this context, a ratio of at least a specified number allows greater (or equal) values of the numerator, which corresponds to the weight of hydrogen peroxide. For example, the phrase “the weight ratio of BLG to hydrogen peroxide is at least 1:10000” includes, in addition to 1:10000, for example 2/10000 and 10/10000, which are 1/5000 and 1/1000, respectively.

According to some embodiments, the weight ratio of hydrogen peroxide to the at least one milk protein is no more than 1:10. According to some embodiments, the weight ratio of hydrogen peroxide to the at least one milk protein is no more than 1:25. According to some embodiments, the weight ratio of hydrogen peroxide to the at least one milk protein is no more than 1:50. According to some embodiments, the weight ratio of hydrogen peroxide to the at least one milk protein is no more than 1:100. According to some embodiments, the weight ratio of hydrogen peroxide to the at least one milk protein is no more than 1:250. According to some embodiments, the weight ratio of hydrogen peroxide to the at least one milk protein is no more than 1:500. According to some embodiments, the weight ratio of hydrogen peroxide to the at least one milk protein is no more than 1:1000. According to some embodiments, the weight ratio of hydrogen peroxide to the at least one milk protein is no more than 1:2500.

According to some embodiments, the weight ratio of hydrogen peroxide to BLG is no more than 1:10. According to some embodiments, the weight ratio of hydrogen peroxide to BLG is no more than 1:25. According to some embodiments, the weight ratio of hydrogen peroxide to BLG is no more than 1:50. According to some embodiments, the weight ratio of hydrogen peroxide to BLG is no more than 1:100. According to some embodiments, the weight ratio of hydrogen peroxide to BLG is no more than 1:250. According to some embodiments, the weight ratio of hydrogen peroxide to BLG is no more than 1:500. According to some embodiments, the weight ratio of hydrogen peroxide to BLG is no more than 1:1000. According to some embodiments, the weight ratio of hydrogen peroxide to BLG is no more than 1:2500.

It is to be understood that in this context, a ratio of no more than a specified number allows smaller (or equal) values of the numerator, which corresponds to the weight of hydrogen peroxide. For example, the phrase “the weight ratio of BLG to hydrogen peroxide is no more than 1:10” includes, in addition to 1:10, for example 0.1/10 and 0.01/10, which are 1/100 and 1/1000, respectively.

According to some embodiments, the weight ratio of hydrogen peroxide to BLG is in the range of 1:1000 to 1:20000, including each value and sub-range within the specified range. According to some embodiments, the weight ratio of hydrogen peroxide to BLG is in the range of 1:2000 to 1:10000.

Specific reference is now made to step (c) of the present method, which comprises providing cystine.

Cystine is the oxidized dimer of the amino acid cysteine, formed by a disulfide bond of the thiol side chain, and has the formula (SCH₂CH(NH₂)CO₂H)₂ (Scheme I) It is a white solid that is poorly soluble in water. The term “L-cystine” corresponds to the same cystine dimer, wherein each one of the amino acid units is stereo-chemically defined as L-cysteine. Advantageously, cystine is a food grade product.

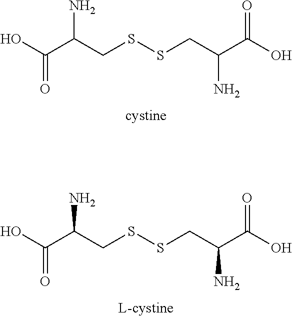 [SMILES: NC(CSSCC(N)C(=O)O)C(=O)O ; N[C@@H](CSSC[C@H](N)C(=O)O)C(=O)O]

### Scheme I: Chemical Structures of Cystine and L-Cystine

According to some embodiments, step (b) comprises providing at least 3 ppm cystine, based on the weight of the edible aqueous composition provided in step (a). According to some embodiments, step (b) comprises providing at least 6 ppm cystine, based on the weight of the edible aqueous composition provided in step (a). According to some embodiments, step (b) comprises providing at least 10 ppm cystine, based on the weight of the edible aqueous composition provided in step (a). According to some embodiments, step (b) comprises providing at least 15 ppm cystine, based on the weight of the edible aqueous composition provided in step (a). According to some embodiments, step (b) comprises providing at least 30 ppm cystine, based on the weight of the edible aqueous composition provided in step (a). According to some embodiments, step (b) comprises providing at least 3 ppm L-cystine, based on the weight of the edible aqueous composition provided in step (a). According to some embodiments, step (b) comprises providing at least 6 ppm L-cystine, based on the weight of the edible aqueous composition provided in step (a). According to some embodiments, step (b) comprises providing at least 10 ppm L-cystine, based on the weight of the edible aqueous composition provided in step (a). According to some embodiments, step (b) comprises providing at least 15 ppm L-cystine, based on the weight of the edible aqueous composition provided in step (a). According to some embodiments, step (b) comprises providing at least 30 ppm L-cystine, based on the weight of the edible aqueous composition provided in step (a).

According to some embodiments, step (b) comprises providing no more than 300 ppm cystine, based on the weight of the edible aqueous composition provided in step (a). According to some embodiments, step (b) comprises providing no more than 150 ppm cystine, based on the weight of the edible aqueous composition provided in step (a). According to some embodiments, step (b) comprises providing no more than 125 ppm cystine, based on the weight of the edible aqueous composition provided in step (a). According to some embodiments, step (b) comprises providing no more than 100 ppm cystine, based on the weight of the edible aqueous composition provided in step (a). According to some embodiments, step (b) comprises providing no more than 300 ppm L-cystine, based on the weight of the edible aqueous composition provided in step (a). According to some embodiments, step (b) comprises providing no more than 150 ppm L-cystine, based on the weight of the edible aqueous composition provided in step (a). According to some embodiments, step (b) comprises providing no more than 125 ppm L-cystine, based on the weight of the edible aqueous composition provided in step (a). According to some embodiments, step (b) comprises providing no more than 100 ppm L-cystine, based on the weight of the edible aqueous composition provided in step (a).

According to some embodiments, step (b) comprises providing 10 ppm to 100 ppm cystine, based on the weight of the edible aqueous composition provided in step (a). According to some embodiments, step (b) comprises providing 10 ppm to 100 ppm L-cystine, based on the weight of the edible aqueous composition provided in step (a).

As detailed herein, the incorporation of the cystine (as a combination with hydrogen peroxide) is intended to reduce the sensoric effect of sulfuric thermal decomposition products of the least one milk protein during the heat treatment in step (e). Therefore, the required amount of cystine depends on the amount of the least one milk protein. Thus, the amount of cystine provided in step (c) may be defined as a proportion of the least one milk protein. A non-limiting numerical example is as follows: a starting composition of edible aqueous composition according to step (a) may include BLG 4.5% w/w and 45 ppm cystine, which corresponds to 0.0045% w/w (both values are based on the total weight of the composition). Therefore, the weight ratio in this example of cystine to BLG is 1:1000.

According to some embodiments, the weight ratio of cystine to the at least one milk protein is at least 1:50000. According to some embodiments, the weight ratio of cystine to the at least one milk protein is at least 1:25000. According to some embodiments, the weight ratio of cystine to the at least one milk protein is at least 1:10000. According to some embodiments, the weight ratio of cystine to the at least one milk protein is at least 1:6000. According to some embodiments, the weight ratio of cystine to the at least one milk protein is at least 1:5000. According to some embodiments, the weight ratio of cystine to the at least one milk protein is at least 1:2500. According to some embodiments, the weight ratio of cystine to the at least one milk protein is at least 1:1000. According to some embodiments, the weight ratio of cystine to the at least one milk protein is at least 1:500. According to some embodiments, the weight ratio of cystine to the at least one milk protein is at least 1:300. According to some embodiments, the weight ratio of cystine to the at least one milk protein is at least 1:250. According to some embodiments, the weight ratio of cystine to the at least one milk protein is at least 1:100. According to some embodiments, the weight ratio of cystine to the at least one milk protein is at least 1:50.

According to some embodiments, the weight ratio of cystine to BLG is at least 1:50000. According to some embodiments, the weight ratio of cystine to BLG is at least 1:25000. According to some embodiments, the weight ratio of cystine to BLG is at least 1:10000. According to some embodiments, the weight ratio of cystine to BLG is at least 1:5000. According to some embodiments, the weight ratio of cystine to BLG is at least 1:2500. According to some embodiments, the weight ratio of cystine to BLG is at least 1:1000. According to some embodiments, the weight ratio of cystine to BLG is at least 1:500. According to some embodiments, the weight ratio of cystine to BLG is at least 1:250. According to some embodiments, the weight ratio of cystine to BLG is at least 1:100. According to some embodiments, the weight ratio of cystine to BLG is at least 1:50.

According to some embodiments, the weight ratio of cystine to the at least one milk protein is no more than 1:10. According to some embodiments, the weight ratio of cystine to the at least one milk protein is no more than 1:25. According to some embodiments, the weight ratio of cystine to the at least one milk protein is no more than 1:50. According to some embodiments, the weight ratio of cystine to the at least one milk protein is no more than 1:100. According to some embodiments, the weight ratio of cystine to the at least one milk protein is no more than 1:250. According to some embodiments, the weight ratio of cystine to the at least one milk protein is no more than 1:500. According to some embodiments, the weight ratio of cystine to the at least one milk protein is no more than 1:1000. According to some embodiments, the weight ratio of cystine to the at least one milk protein is no more than 1:2500.

According to some embodiments, the weight ratio of cystine to BLG is no more than 1:10. According to some embodiments, the weight ratio of cystine to BLG is no more than 1:25. According to some embodiments, the weight ratio of cystine to BLG is no more than 1:50. According to some embodiments, the weight ratio of cystine to BLG is no more than 1:100. According to some embodiments, the weight ratio of cystine to BLG is no more than 1:250. According to some embodiments, the weight ratio of cystine to BLG is no more than 1:500. According to some embodiments, the weight ratio of cystine to BLG is no more than 1:1000. According to some embodiments, the weight ratio of cystine to BLG is no more than 1:2500.

According to some embodiments, the weight ratio of cystine to BLG is in the range of 1:300 to 1:6000, including each value and sub-range within the specified range. According to some embodiments, the weight ratio of cystine to BLG is in the range of 1:600 to 1:3000.

Specific reference is now made to step (d) of the present method, which comprises contacting the edible aqueous composition with the hydrogen peroxide and the cystine to form a mixture.

According to some embodiments, step (d) further comprises mixing the mixture. According to some embodiments, the mixing is performed using a magnetic or a mechanical stirrer. According to some embodiments, the mixing is performed for 10 seconds to 5 minutes, 0.5 to 100 minutes, 0.5 to 1 minutes, 1 to 5 minutes, 2 to 10 minutes, 5 to 60 minutes or 10 to 90 minutes. Each possibility represents a separate embodiment of the invention.

It was surprisingly found that heat-treating the present edible aqueous composition in the present of a combination of hydrogen peroxide and L-cystine result in highly satisfactory results. Specifically, heat treatment processes are regularly employed to foods and beverages for public health, hygiene and/or safety purposes. Furthermore, heat treatment protocols are often required by regulatory authorities in different territories. These requirements specifically apply to milk and dairy products, which have relatively short shelf life due to their naturally high microbial growth potential.

However, an acute problem heat treatment to milk products (e.g., UHT treatment of milk) is the distinct cooked and eggy flavor which has been reported in UHT-processed milk. The origin of the cooked and eggy flavor arising in UHT milk is believed to arise from various volatile sulfur compounds (VSCs) liberated from whey proteins present in milk, particularly from beta lactoglobulin (BLG). BLG is highly sensitive to heat and has high sulfur content, and when exposed to high temperatures, rapidly denatures, which exposes its sulfonic amino acids, cysteine and methionine. The concentration of thiol groups subsequently decreases while the di-sulfide groups increase, due to oxidation. Decreases of both -SH and -SS groups can be explained by their conversion to volatile sulfur compounds (VSCs) such as hydrogen sulfide, methanethiol, sulfides, and disulfide, which contribute to the eggy flavor of milk. This problem is even more pronounce when using milk alternative products, in which BLG is the major (and something the sole) protein component.

The use of scavenging compounds for reducing the amount of VSCs formed in milk products during heat-treatments is known. However, (a) the corresponding challenge in heat-treating milk alternatives is greater, as such products comprise much more BLG than is found in cows' milk (about 10 times more), as detailed above, so it was expected that only high concentration of scavenging compounds will be required; and (b) the art concentrates on heat treatment protocols of milk products, which include either no scavenging compounds or a single compound. A VSC scavenging composition, such as the present hydrogen peroxide/L-cystine combination was not disclosed for reducing the VSCs content during heat treatments. Yet, it was surprisingly found, as exemplified below, that this combination has a pronounced synergistic effect on the VSCs reduction when a milk alternative product was subjected to heat treatment. Specifically, while low concentrations of either hydrogen peroxide or L-cystine had negligent effect on the final VSCs reduction, the present combination significantly reduced the VSCs content even at low (individual and combined) concentrations.

It is to be understood that the embodiments that relate to the concentrations of hydrogen peroxide and cystine in steps (b) and (c) respectively, similarly apply to the concentrations of hydrogen peroxide and cystine within the mixture of step (d).

According to some embodiments, the weight ratio of hydrogen peroxide to cystine is in the range of 1:100 to 10:1, including each value and sub-range within the specified range. According to some embodiments, the weight ratio of hydrogen peroxide to cystine is in the range of 3:100 to 10:3. According to some embodiments, the weight ratio of hydrogen peroxide to BLG is in the range of 1:1000 to 1:20000, including each value and sub-range within the specified range. According to some embodiments, the weight ratio of hydrogen peroxide to BLG is in the range of 1:2000 to 1:10000. According to some embodiments, the weight ratio of cystine to BLG is in the range of 1:300 to 1:6000, including each value and sub-range within the specified range. According to some embodiments, the weight ratio of cystine to BLG is in the range of 1:600 to 1:3000.

Specifically, according to some embodiments, the mixture of step (d) comprises 3 ppm to 30 ppm hydrogen peroxide. According to some embodiments, the mixture of step (d) comprises 10 ppm to 100 ppm of an aqueous hydrogen peroxide solution of about 30% H₂O₂. According to some embodiments, the mixture of step (d) comprises 10 ppm to 100 ppm cystine. According to some embodiments, the mixture of step (d) comprises 10 ppm to 100 ppm L-cystine.

As detailed herein, step (d) comprises contacting the edible aqueous composition with the hydrogen peroxide and the cystine to form a mixture. Thus, step (d) comprises contacting the edible aqueous composition with a combination of the hydrogen peroxide and the cystine to form the mixture. It is to be understood that in this context “a combination of the hydrogen peroxide and the cystine” refers to the sum of the hydrogen peroxide and the cystine, which are provided in steps (b) and (c) respectively. In other words, according to some embodiments, the combination consists of the hydrogen peroxide and the cystine provided in steps (b) and (c).

According to some embodiments, the mixture of step (d) comprises at least 3 ppm of the combination of the hydrogen peroxide and the cystine, based on the weight of the edible aqueous composition provided in step (a). According to some embodiments, the mixture of step (d) comprises at least 6 ppm of the combination of the hydrogen peroxide and the cystine, based on the weight of the edible aqueous composition provided in step (a). According to some embodiments, the mixture of step (d) comprises at least 10 ppm of the combination of the hydrogen peroxide and the cystine, based on the weight of the edible aqueous composition provided in step (a). According to some embodiments, the mixture of step (d) comprises at least 15 ppm of the combination of the hydrogen peroxide and the cystine, based on the weight of the edible aqueous composition provided in step (a). According to some embodiments, the mixture of step (d) comprises at least 30 ppm of the combination of the hydrogen peroxide and the cystine, based on the weight of the edible aqueous composition provided in step (a). According to some embodiments, the mixture of step (d) comprises at least 50 ppm of the combination of the hydrogen peroxide and the cystine, based on the weight of the edible aqueous composition provided in step (a). According to some embodiments, the mixture of step (d) comprises at least 75 ppm of the combination of the hydrogen peroxide and the cystine, based on the weight of the edible aqueous composition provided in step (a). According to some embodiments, the mixture of step (d) comprises at least 100 ppm of the combination of the hydrogen peroxide and the cystine, based on the weight of the edible aqueous composition provided in step (a). According to some embodiments, the mixture of step (d) comprises at least 125 ppm of the combination of the hydrogen peroxide and the cystine, based on the weight of the edible aqueous composition provided in step (a). According to some embodiments, the mixture of step (d) comprises at least 3 ppm of the combination of the hydrogen peroxide and the L-cystine, based on the weight of the edible aqueous composition provided in step (a). According to some embodiments, the mixture of step (d) comprises at least 6 ppm of the combination of the hydrogen peroxide and the L-cystine, based on the weight of the edible aqueous composition provided in step (a). According to some embodiments, the mixture of step (d) comprises at least 10 ppm of the combination of the hydrogen peroxide and the L-cystine, based on the weight of the edible aqueous composition provided in step (a). According to some embodiments, the mixture of step (d) comprises at least 15 ppm of the combination of the hydrogen peroxide and the L-cystine, based on the weight of the edible aqueous composition provided in step (a). According to some embodiments, the mixture of step (d) comprises at least 30 ppm of the combination of the hydrogen peroxide and the L-cystine, based on the weight of the edible aqueous composition provided in step (a). According to some embodiments, the mixture of step (d) comprises at least 50 ppm of the combination of the hydrogen peroxide and the L-cystine, based on the weight of the edible aqueous composition provided in step (a). According to some embodiments, the mixture of step (d) comprises at least 75 ppm of the combination of the hydrogen peroxide and the L-cystine, based on the weight of the edible aqueous composition provided in step (a). According to some embodiments, the mixture of step (d) comprises at least 100 ppm of the combination of the hydrogen peroxide and the L-cystine, based on the weight of the edible aqueous composition provided in step (a). According to some embodiments, the mixture of step (d) comprises at least 125 ppm of the combination of the hydrogen peroxide and the L-cystine, based on the weight of the edible aqueous composition provided in step (a).

According to some embodiments, the mixture of step (d) comprises no more than 450 ppm of the combination of the hydrogen peroxide and the cystine, based on the weight of the edible aqueous composition provided in step (a). According to some embodiments, the mixture of step (d) comprises no more than 300 ppm of the combination of the hydrogen peroxide and the cystine, based on the weight of the edible aqueous composition provided in step (a). According to some embodiments, the mixture of step (d) comprises no more than 200 ppm of the combination of the hydrogen peroxide and the cystine, based on the weight of the edible aqueous composition provided in step (a). According to some embodiments, the mixture of step (d) comprises no more than 150 ppm of the combination of the hydrogen peroxide and the cystine, based on the weight of the edible aqueous composition provided in step (a). According to some embodiments, the mixture of step (d) comprises no more than 125 ppm of the combination of the hydrogen peroxide and the cystine, based on the weight of the edible aqueous composition provided in step (a). According to some embodiments, the mixture of step (d) comprises no more than 100 ppm of the combination of the hydrogen peroxide and the cystine, based on the weight of the edible aqueous composition provided in step (a). According to some embodiments, the mixture of step (d) comprises no more than 450 ppm of the combination of the hydrogen peroxide and the L-cystine, based on the weight of the edible aqueous composition provided in step (a). According to some embodiments, the mixture of step (d) comprises no more than 300 ppm of the combination of the hydrogen peroxide and the L-cystine, based on the weight of the edible aqueous composition provided in step (a). According to some embodiments, the mixture of step (d) comprises no more than 200 ppm of the combination of the hydrogen peroxide and the L-cystine, based on the weight of the edible aqueous composition provided in step (a). According to some embodiments, the mixture of step (d) comprises no more than 150 ppm of the combination of the hydrogen peroxide and the L-cystine, based on the weight of the edible aqueous composition provided in step (a). According to some embodiments, the mixture of step (d) comprises no more than 125 ppm of the combination of the hydrogen peroxide and the L-cystine, based on the weight of the edible aqueous composition provided in step (a). According to some embodiments, the mixture of step (d) comprises no more than 100 ppm of the combination of the hydrogen peroxide and the L-cystine, based on the weight of the edible aqueous composition provided in step (a).

According to some embodiments, the mixture of step (d) comprises 10 ppm to 150 ppm of the combination of the hydrogen peroxide and the cystine. According to some embodiments, the mixture of step (d) comprises 10 ppm to 150 ppm of the combination of the hydrogen peroxide and the L-cystine. According to some embodiments, the mixture of step (d) comprises 13 ppm to 130 ppm of the combination. According to some embodiments, the mixture of step (d) comprises 15 ppm to 150 ppm of the combination.

As detailed herein, the incorporation of the cystine:hydrogen peroxide combination is intended to reduce the sensoric effect of sulfuric thermal decomposition products of the least one milk protein during the heat treatment in step (e). Therefore, the required total amount of cystine and hydrogen peroxide (i.e., the combination) depends on the amount of the least one milk protein. Thus, the amount of the combination in the mixture of step (d) may be defined as a proportion of the least one milk protein. A non-limiting numerical example is as follows: a starting composition of edible aqueous composition according to step (a) may include BLG 4.5% w/w, 45 ppm cystine, which corresponds to 0.0045% w/w and 15 ppm hydrogen peroxide, which corresponds to 0.0015% w/w (each of the values are based on the total weight of the composition). Therefore, (1) the combination will be considered to be present in the mixture of step (d) at a concentration of 60 ppm (45 ppm+15 ppm); and (2) the weight ratio in this example of the cystine:hydrogen peroxide combination to BLG is 0.006:4.5, or simply 1:750.

According to some embodiments, the weight ratio of the combination of the hydrogen peroxide and the cystine to the at least one milk protein is at least 1:50000. According to some embodiments, the weight ratio of the combination of the hydrogen peroxide and the cystine to the at least one milk protein is at least 1:25000. According to some embodiments, the weight ratio of the combination of the hydrogen peroxide and the cystine to the at least one milk protein is at least 1:10000. According to some embodiments, the weight ratio of the combination of the hydrogen peroxide and the cystine to the at least one milk protein is at least 1:6000. According to some embodiments, the weight ratio of the combination of the hydrogen peroxide and the cystine to the at least one milk protein is at least 1:5000. According to some embodiments, the weight ratio of the combination of the hydrogen peroxide and the cystine to the at least one milk protein is at least 1:2500. According to some embodiments, the weight ratio of the combination of the hydrogen peroxide and the cystine to the at least one milk protein is at least 1:1000. According to some embodiments, the weight ratio of the combination of the hydrogen peroxide and the cystine to the at least one milk protein is at least 1:500. According to some embodiments, the weight ratio of the combination of the hydrogen peroxide and the cystine to the at least one milk protein is at least 1:300. According to some embodiments, the weight ratio of the combination of the hydrogen peroxide and the cystine to the at least one milk protein is at least 1:250. According to some embodiments, the weight ratio of the combination of the hydrogen peroxide and the cystine to the at least one milk protein is at least 1:100. According to some embodiments, the weight ratio of the combination of the hydrogen peroxide and the cystine to the at least one milk protein is at least 1:50.

According to some embodiments, the weight ratio of the combination of the hydrogen peroxide and the cystine to BLG is at least 1:50000. According to some embodiments, the weight ratio of the combination of the hydrogen peroxide and the cystine to BLG is at least 1:25000. According to some embodiments, the weight ratio of the combination of the hydrogen peroxide and the cystine to BLG is at least 1:10000. According to some embodiments, the weight ratio of the combination of the hydrogen peroxide and the cystine to BLG is at least 1:5000. According to some embodiments, the weight ratio of the combination of the hydrogen peroxide and the cystine to BLG is at least 1:2500. According to some embodiments, the weight ratio of the combination of the hydrogen peroxide and the cystine to BLG is at least 1:1000. According to some embodiments, the weight ratio of the combination of the hydrogen peroxide and the cystine to BLG is at least 1:500. According to some embodiments, the weight ratio of the combination of the hydrogen peroxide and the cystine to BLG is at least 1:250. According to some embodiments, the weight ratio of the combination of the hydrogen peroxide and the cystine to BLG is at least 1:100. According to some embodiments, the weight ratio of the combination of the hydrogen peroxide and the cystine to BLG is at least 1:50.

According to some embodiments, the weight ratio of the combination of the hydrogen peroxide and the cystine to the at least one milk protein is no more than 1:10. According to some embodiments, the weight ratio of the combination of the hydrogen peroxide and the cystine to the at least one milk protein is no more than 1:25. According to some embodiments, the weight ratio of the combination of the hydrogen peroxide and the cystine to the at least one milk protein is no more than 1:50. According to some embodiments, the weight ratio of the combination of the hydrogen peroxide and the cystine to the at least one milk protein is no more than 1:100. According to some embodiments, the weight ratio of the combination of the hydrogen peroxide and the cystine to the at least one milk protein is no more than 1:250. According to some embodiments, the weight ratio of the combination of the hydrogen peroxide and the cystine to the at least one milk protein is no more than 1:500. According to some embodiments, the weight ratio of the combination of the hydrogen peroxide and the cystine to the at least one milk protein is no more than 1:1000. According to some embodiments, the weight ratio of the combination of the hydrogen peroxide and the cystine to the at least one milk protein is no more than 1:2500.

According to some embodiments, the weight ratio of the combination of the hydrogen peroxide and the cystine to BLG is no more than 1:10. According to some embodiments, the weight ratio of the combination of the hydrogen peroxide and the cystine to BLG is no more than 1:25. According to some embodiments, the weight ratio of the combination of the hydrogen peroxide and the cystine to BLG is no more than 1:50. According to some embodiments, the weight ratio of the combination of the hydrogen peroxide and the cystine to BLG is no more than 1:100. According to some embodiments, the weight ratio of the combination of the hydrogen peroxide and the cystine to BLG is no more than 1:250. According to some embodiments, the weight ratio of the combination of the hydrogen peroxide and the cystine to BLG is no more than 1:500. According to some embodiments, the weight ratio of the combination of the hydrogen peroxide and the cystine to BLG is no more than 1:1000. According to some embodiments, the weight ratio of the combination of the hydrogen peroxide and the cystine to BLG is no more than 1:2500.

According to some embodiments, the weight ratio of the combination of the hydrogen peroxide and the cystine to BLG is in the range of 1:250 to 1:5000, including each value and sub-range within the specified range. According to some embodiments, the weight ratio of the combination of the hydrogen peroxide and the cystine to BLG is in the range of 1:400 to 1:3000.

Specific reference is now made to step (e) of the present method, which is directed to a heat treatment of the mixture of edible aqueous composition, hydrogen peroxide and cystine, to produce the product heat-treated edible aqueous composition.

Thus, according to some embodiments, the method comprises step (e) of maintaining the mixture formed in step (d) at an elevated temperature for a predetermined time period.

Heat treatment procedures of food and beverage products are known in the art. Various heat treatment protocols are employed mainly in order to reduce the microorganism content of the food and beverage products and are typically required by regulatory authorities as part of a marketing permit.

Popular heat treatment protocols include pasteurization and Ultra-high temperature (UHT) processing. According to some embodiments, step (e) comprises pasteurizing and/or UHT processing the mixture of step (d). According to some embodiments, step (e) comprises pasteurizing the mixture of step (d). According to some embodiments, step (e) comprises UHT processing the mixture of step (d).

The term “Ultra-high temperature processing” refers to a food processing technology that sterilizes liquid food by heating it above 135° C.—the temperature required to kill bacterial endospores—for 2 to 5 seconds. UHT processing is most commonly used in milk production, but the process is also used for fruit juices, cream, soy milk, yogurt, wine, soups, honey, and stews.

The term “pasteurization” means a process of food preservation in which packaged and non-packaged foods (such as milk and fruit juices) are treated with mild heat, usually to less than 100° C., to eliminate pathogens and extend shelf life. The process is intended to destroy or deactivate microorganisms and enzymes that contribute to food spoilage or risk of disease, including vegetative bacteria. However, most bacterial spores survive the pasteurization process.

According to some embodiments, the elevated temperature of step (e) is at least 60° C. According to some embodiments, the elevated temperature of step (e) is at least 70° C. According to some embodiments, the elevated temperature of step (e) is at least 80° C. According to some embodiments, the elevated temperature of step (e) is at least 90° C. According to some embodiments, the elevated temperature of step (e) is at least 100° C. According to some embodiments, the elevated temperature of step (e) is at least 120° C. According to some embodiments, the elevated temperature of step (e) is at least 125° C. According to some embodiments, the elevated temperature of step (e) is at least 130° C. According to some embodiments, the elevated temperature of step (e) is at least 135° C. According to some embodiments, the elevated temperature of step (e) is at least 138° C.

According to some embodiments, the elevated temperature of step (e) is in the range of 60° C. to 170° C. According to some embodiments, the elevated temperature of step (e) is in the range of 90° C. to 160° C. According to some embodiments, the elevated temperature of step (e) is in the range of 90° C. to 150° C. According to some embodiments, the elevated temperature of step (e) is in the range of 120° C. to 150° C. According to some embodiments, the elevated temperature of step (e) is in the range of 138° C. to 145° C. According to some embodiments, the elevated temperature of step (e) is about 140° C.

According to some embodiments, step (e) comprises maintaining the mixture of step (d) at the elevated temperature for a time period of at least 0.5 seconds. According to some embodiments, the time period is at least 1 second. According to some embodiments, the time period is at least 1.5 second. According to some embodiments, the time period in the range of 0.5 to 60 seconds. According to some embodiments, the time period in the range of 0.5 to 30 seconds. According to some embodiments, the time period in the range of 0.5 to 15 seconds. According to some embodiments, the time period in the range of 1 to 10 seconds. According to some embodiments, the time period in the range of 1 to 5 seconds. According to some embodiments, the time period in the range of 1 to 3 seconds.

According to some embodiments, step (e) comprises heating the mixture of step (d) to the elevated temperature and maintaining it at the elevated temperature for the time period.

The 1993 E U Standards for bacteria count in milk are detailed hereinabove, when referring to the starting composition of step (a).

In force 1 January (World J. Dairy & Food Sci., 2 (2): 49-53, 2007) the bacterial plate count standard for raw milk is below 100,000 Colony Forming Units (CFU) per 1 ml. The corresponding standard for Raw milk stored in silo at the dairy for more than 36 hours is below 100,000 CFU per 1 ml. The EU standard for pasteurized milk is below 30,000 CFU per 1 ml and for pasteurized milk after incubation for 5 days at 8° C. it is below 100,000 CFU per 1 ml. Lastly, the EU standard for UHT-treated milk is below 10 CFU per 1 ml.

According to some embodiments, the heat-treated edible aqueous composition formed in step (e) has a lower microbial count compared to the edible aqueous composition in step (a). According to some embodiments, the microbial count of the heat-treated edible aqueous composition is at least 50% lower than the microbial count of the edible aqueous composition. According to some embodiments, the microbial count of the heat-treated edible aqueous composition is at least 75% lower than the microbial count of the edible aqueous composition. According to some embodiments, the microbial count of the heat-treated edible aqueous composition is at least 90% lower than the microbial count of the edible aqueous composition. According to some embodiments, the microbial count of the heat-treated edible aqueous composition is at least 95% lower than the microbial count of the edible aqueous composition. According to some embodiments, the microbial count of the heat-treated edible aqueous composition is at least 99% lower than the microbial count of the edible aqueous composition. According to some embodiments, the microbial count of the heat-treated edible aqueous composition is at least 99.5% lower than the microbial count of the edible aqueous composition.

According to some embodiments, the heat-treated edible aqueous composition formed in step (e) has a bacterial count of no more than 30,000 CFU per 1 ml. According to some embodiments, the bacterial count is of no more than 20,000 CFU per 1 ml. According to some embodiments, the bacterial count is of no more than 10,000 CFU per 1 ml. According to some embodiments, the bacterial count is of no more than 5,000 CFU per 1 ml. According to some embodiments, the bacterial count is of no more than 3,000 CFU per 1 ml. According to some embodiments, the bacterial count is of no more than 2,000 CFU per 1 ml. According to some embodiments, the bacterial count is of no more than 1,000 CFU per 1 ml. According to some embodiments, the bacterial count is of no more than 500 CFU per 1 ml. According to some embodiments, the bacterial count is of no more than 300 CFU per 1 ml. According to some embodiments, the bacterial count is of no more than 200 CFU per 1 ml. According to some embodiments, the bacterial count is of no more than 100 CFU per 1 ml. According to some embodiments, the bacterial count is of no more than 50 CFU per 1 ml. According to some embodiments, the bacterial count is of no more than 30 CFU per 1 ml. According to some embodiments, the bacterial count is of no more than 20 CFU per 1 ml. According to some embodiments, the bacterial count is of no more than 10 CFU per 1 ml.

The methods provided herein produce heat-treated edible aqueous compositions which are heat treated (e.g., pasteurized or UHT treated) sufficiently to kill microorganisms, and extend the shelf-life thereof, while maintaining a similar smell and flavor profile to those of untreated compositions.

According to some embodiments, the heat-treated edible aqueous composition formed in step (e) comprises less than 90% VSCs (Volatile Sulfur Compounds) compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 80% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 70% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 60% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 50% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 40% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 30% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 20% VSCs compared to a VSC content of a corresponding heat-treated aqueous composition prepared by employing the conditions of step (e) directly on the edible aqueous composition of step (a). According to some embodiments, the heat-treated edible aqueous composition formed in step (e) comprises less than 10% VSCs compared to a VSC content of a corresponding heat-treated aqueous composition prepared by employing the conditions of step (e) directly on the edible aqueous composition of step (a).

It is to be understood that the phrase “the heat-treated edible aqueous composition formed in step (e) comprises less than 90% VSCs compared to a VSC content of a corresponding heat-treated aqueous composition prepared by employing the conditions of step (e) directly on the edible aqueous composition of step (a)” is intended to mean that (1) if the heat treatment conditions of step (e) are employed directly on the edible aqueous composition of step (a) (i.e., which does not include the hydrogen peroxide/cystine combination) the VSCs contents in the product will be measured as X; (2) the VSCs contents in the heat-treated edible aqueous composition of step (e) of the present method (i.e., wherein the heat treatment is performed in the presence of the hydrogen peroxide/cystine combination) is Y; and (3) Y is at least 10% lower than X. The person having ordinary skill in the art may apply this definition for the other specified ratios.

The term “Volatile Sulfur Compound (VSC)” refers to any compounds responsible for a typically unpleasant sulfur smell in heat-treated milk. The VSCs includes a sufficiently high vapor pressure at ambient temperature and pressure to produce smell. This term includes, but not limited to thiols (e.g. hydrogen sulfide, methanethiol, ethanethiol, propanetriol, etc.), and sulfides and disulfides (e.g. dimethyl sulfide, dimethyl disulfide, dimethyl trisulfide, diethyl sulfide, etc.).

According to some embodiments, the heat-treated edible aqueous composition formed in step (e) has a reduced eggy and/or cabbage flavor and/or smell compared to a corresponding heat-treated aqueous composition prepared by employing the conditions of step (e) directly on the edible aqueous composition of step (a). According to some embodiments, the heat-treated edible aqueous composition formed in step (e) has a reduced eggy flavor compared to a corresponding heat-treated aqueous composition prepared by employing the conditions of step (e) directly on the edible aqueous composition of step (a). According to some embodiments, the heat-treated edible aqueous composition formed in step (e) has a reduced eggy smell compared to a corresponding heat-treated aqueous composition prepared by employing the conditions of step (e) directly on the edible aqueous composition of step (a). According to some embodiments, the heat-treated edible aqueous composition formed in step (e) has a reduced cabbage flavor compared to a corresponding heat-treated aqueous composition prepared by employing the conditions of step (e) directly on the edible aqueous composition of step (a). According to some embodiments, the heat-treated edible aqueous composition formed in step (e) has a reduced cabbage smell compared to a corresponding heat-treated aqueous composition prepared by employing the conditions of step (e) directly on the edible aqueous composition of step (a).

According to some embodiments, the heat-treated edible aqueous composition formed in step (e) is substantially devoid of an eggy and/or cabbage flavor and/or smell. According to some embodiments, the heat-treated edible aqueous composition formed in step (e) is substantially devoid of an eggy smell. According to some embodiments, the heat-treated edible aqueous composition formed in step (e) is substantially devoid of an eggy flavor. According to some embodiments, the heat-treated edible aqueous composition formed in step (e) is substantially devoid of a cabbage smell. According to some embodiments, the heat-treated edible aqueous composition formed in step (e) is substantially devoid of a cabbage flavor.

It is to be understood that “smell” and “flavor” in the context of the above two paragraphs refers to an average human ability to sense these properties.

As detailed above, according to some embodiments, the heat-treated edible aqueous composition obtained by the present method consists essentially of the same chemical composition of the edible aqueous composition provided in step (a).

According to some embodiments, the heat-treated edible aqueous composition obtained in step (e) has a pH of at least 6. According to some embodiments, the heat-treated edible aqueous composition has a pH of at least 6.25. According to some embodiments, the heat-treated edible aqueous composition has a pH of at least 6.5. According to some embodiments, the heat-treated edible aqueous composition has a pH of at least 6.6. According to some embodiments, the heat-treated edible aqueous composition has a pH of no more than 8. According to some embodiments, the heat-treated edible aqueous composition has a pH of no more than 7.75. According to some embodiments, the heat-treated edible aqueous composition has a pH of no more than 7.5. According to some embodiments, the heat-treated edible aqueous composition has a pH of no more than 7.2.

According to some embodiments, the heat treatment of step (e) entails decreasing the amount of the amount of the hydrogen peroxide and/or the cystine by at least 25%, at least 33%, at least 40%, at least 50%, at least 60%, at least 70%, at least 80%, at least 90% or at least 95% compared to their level in step (d). Each possibility represents a separate embodiment of the invention. According to some embodiments, the heat treatment of step (e) entails decreasing the amount of the amount of the hydrogen peroxide by at least 25%, at least 33%, at least 40%, at least 50%, at least 60%, at least 70%, at least 80%, at least 90% or at least 95% compared to its level in step (d). Each possibility represents a separate embodiment of the invention. According to some embodiments, the heat treatment of step (e) entails decreasing the amount of the amount of the cystine by at least 25%, at least 33%, at least 40%, at least 50%, at least 60%, at least 70%, at least 80%, at least 90% or at least 95% compared to its level in step (d). Each possibility represents a separate embodiment of the invention.

According to some embodiments, the amount of the hydrogen peroxide and/or the cystine in the heat-treated edible aqueous composition is at least 25%, at least 33%, at least 40%, at least 50%, at least 60%, at least 70%, at least 80%, at least 90% or at least 95% compared to their level in step (d). According to some embodiments, the amount of the hydrogen peroxide in the heat-treated edible aqueous composition is at least 25%, at least 33%, at least 40%, at least 50%, at least 60%, at least 70%, at least 80%, at least 90% or at least 95% compared to its level in step (d). According to some embodiments, the amount of the amount of the cystine in the heat-treated edible aqueous composition is at least 25%, at least 33%, at least 40%, at least 50%, at least 60%, at least 70%, at least 80%, at least 90% or at least 95% compared to its level in step (d).

Specifically, as specific embodiment of the present invention provides milk alternative compositions, and as commercial milk typically has pH of 6.7 to 6.9 or 6.6 to 7.4, the heat-treated edible aqueous composition formed in step (e) may be formulated to include similar pH. According to some embodiments, the heat-treated edible aqueous composition has a pH in the range of 6.7 to 6.9. According to some embodiments, the heat-treated edible aqueous composition has a pH in the range of 6.6 to 7.4. According to some embodiments, the heat-treated edible aqueous composition has a physiological pH.

Advantageously, it was found that the addition of small amounts of the hydrogen peroxide and cystine does not alter the pH of the edible composition before or after the heat treatment of step (e).

According to some embodiments, the heat-treated edible aqueous composition formed in step (e) comprises beta lactoglobulin (BLG). According to some embodiments, the heat-treated edible aqueous composition comprises BLG at a concentration of at least 1% w/w. According to some embodiments, the heat-treated edible aqueous composition comprises BLG at a concentration of at least 3% w/w. According to some embodiments, the heat-treated edible aqueous composition comprises BLG at a concentration of at least 5% w/w. According to some embodiments, the heat-treated edible aqueous composition comprises BLG at a concentration of 4% to 5.5% w/w. According to some embodiments, the heat-treated edible aqueous composition comprises BLG substantially as the sole whey protein. According to some embodiments, the heat-treated edible aqueous composition comprises BLG substantially as the sole milk protein. According to some embodiments, the heat-treated edible aqueous composition comprises BLG substantially as the sole protein. According to some embodiments, the BLG is a recombinant BLG. According to some embodiments, the BLG is beta-lactoglobulin B (rBLG B).

According to some embodiments, the heat-treated edible aqueous composition formed in step (e) comprises at least 5% w/w, at least 10% w/w, at least 20% w/w, at least 35% w/w, at least 50% w/w, at least 60% w/w, at least 75% w/w or at least 90% w/w water, based on the total weight of the composition, as further detailed below. Each possibility represents a separate embodiment of the invention.

According to some embodiments, the heat-treated edible aqueous composition formed in step (e) comprises the at least one milk protein, at least one mineral chelator, at least one sweetener, at least one fat and water.

Embodiments directed to the least one milk protein are as detailed above.

According to some embodiments, the at least one mineral chelator, comprises a citrate salt. According to some embodiments, the at least one mineral chelator, comprises trisodium citrate. According to some embodiments, the at least one sweetener comprises maltose. According to some embodiments, the fat is a non-animal fat. According to some embodiments, the heat-treated edible aqueous composition formed in step (e) comprises BLG, trisodium citrate, maltose, non-animal fat, and water. According to some embodiments, the heat-treated edible aqueous composition formed in step (e) comprises: (i) BLG, 2.5% to 6% w/w; (ii) trisodium citrate, 0.1% to 0.3% w/w; (iii) maltose, 1.5% to 3% w/w; (iv) non-animal fat, 2% to 4% w/w; and (v) water, 87% to 95% w/w.

According to some embodiments, the heat-treated edible aqueous composition is devoid of animal-derived substances. According to some embodiments, the heat-treated edible aqueous composition is devoid of animal-derived proteins. According to some embodiments, the heat-treated edible aqueous composition is devoid of animal-derived sugars. According to some embodiments, the heat-treated edible aqueous composition is devoid of animal-derived saccharides. According to some embodiments, the heat-treated edible aqueous composition is devoid of animal-derived fat. According to some embodiments, the edible aqueous composition provided in step (e) is substantially devoid of lactose. According to some embodiments, the edible aqueous composition provided in step (e) is devoid of lactose.

According to some embodiments, the heat-treated edible composition of step (e) is substantially devoid of any ingredient derived from animal source. According to some embodiments, the heat-treated edible composition of step (e) comprises at least one ingredient, which is not present in animal milk.

According to some embodiments, the heat-treated edible composition of step (e) imparts an animal milk perception.

According to some embodiments, the heat-treated edible aqueous composition formed in step (e) is a heat-treated milk alternative composition.

According to some embodiments, the heat-treated edible aqueous composition formed in step (e) is the stable milk alternative composition according to the present invention. Embodiments relating to the stable milk alternative composition are described in detail below.

According to some embodiments, the method further comprises step (f) of aseptically filling the heat-treated edible aqueous composition in a container.

According to some embodiments, there is provided a heat-treated edible aqueous composition prepared by the method of the present invention.

According to some embodiments, the treated edible aqueous composition is in the form of an emulsion.

According to some embodiments, the present invention provides a milk alternative composition, comprising: (i) at least one milk protein; (ii) optionally, at least one citrate salt; (iii) at least one sweetener; (iv) at least one fat; (v) water; and (vi) optionally, trace amounts of hydrogen peroxide and/or cystine; wherein the milk alternative composition is devoid of animal-derived substances.

According to some embodiments, the at least one milk protein comprises 2.5% to 6% w/w recombinant beta-lactoglobulin B (rBLG). According to some embodiments, the at least one citrate salt comprises 0.1% to 0.3% w/w trisodium citrate.

According to some embodiments, the at least one sweetener comprises 1.5% to 3% w/w maltose. According to some embodiments, the at least one fat comprises at least one non-animal fat. According to some embodiments, the at least one non-animal fat comprises 1% to 5% w/w vegetable fat.

According to some embodiments, the hydrogen peroxide is at a concentration of 0.03 ppm to 0.3 ppm. According to some embodiments, the hydrogen peroxide is at a concentration of 0.03 ppm to 250 ppm including each value and sub-range within the specified range.

According to some embodiments, the cystine is at a concentration of 0.10 ppm to 1 ppm. According to some embodiments, the cystine is at a concentration of 0.1 ppm to 250 ppm, including each value and sub-range within the specified range.

According to some embodiments, the milk alternative composition comprises 87% to 95% w/w water.

According to some embodiments, the milk alternative composition has a pH in the range of 6.6 to 7.4. According to some embodiments, the milk alternative composition has a pH in the range of 6.6 to 7.2. According to some embodiments, the milk alternative composition has a pH in the range of 6.6 to 6.9

According to some embodiments, the milk alternative composition comprises: (i) recombinant beta-lactoglobulin B (rBLG), 2.5% to 6% w/w; (ii) trisodium citrate, 0.1% to 0.3% w/w; (iii) maltose, 1.5% to 3% w/w; (iv) vegetable fat, 2% to 4% w/w; (v) water; 87% to 95% w/w; (vi) hydrogen peroxide, 0.10 ppm to 1 ppm; (vii) cystine, 0.03 ppm to 0.3 ppm; wherein the milk alternative composition has a pH is in the range of 6.6 to 7.2.

According to some embodiments, the milk alternative composition is in the form of an emulsion.

Specific reference is now made to a stable milk alternative composition provided herein.

Milk alternative compositions typically try to mimic perception imparted by milk products, which are derived from animals (e.g., cow milk, goat milk, camel milk etc.). Such perception properties include taste, mouthfeel, aroma, smell and the like, which are distinct to each animal milk. One way to mimic the perception properties is to provide a milk alternative composition, which includes a chemical composition similar to that of the corresponding animal milk. For this purpose substitute ingredients (e.g., protein(s), fat(s), sugar(s), mineral(s), vitamin(s) etc.), which are derived from non-animal sources, may be incorporated in the milk alternative product.

However, substitute milk proteins, such as BLG, are occasionally less stable in the milk alternative composition then they are in the animal milk. For example, it is well known that milk-containing beverages such as milk coffee (caffè latte), chocolate milk, milk tea etc. include heated milk. The denaturation temperature of BLG is about 60° C., so its incorporation in milk alternative drinks is prone to cause precipitation or curdling in the temperature conditions of the hot milk products.

In addition, most coffee varieties are acidic, with an average pH value of 4.85 to 5.10. This can pose a problem when using BLG, which has an isoelectric point of 5.2, as coffee drinks having pH below this value are also prone to curdling. Additional challenges of milk alternative product in mimicking the animal milk counterparts relates to foaming properties and taste.

The present invention provides combinations of ingredients included in milk alternative compositions that overcome each and all of the above challenges. Thus, the present invention further provides stable milk alternative compositions, which are both stable in elevated temperatures and acidic environment compared to other milk alternative compositions. In addition, the stable milk alternative compositions provided herein have improved foaming and taste compared to other milk alternative compositions.

It is to be understood that the present stable milk alternative compositions may be subjected to the heat treatment methods disclosed herein (i.e., in the present of hydrogen peroxide and cystine). However, in other embodiments the stable milk alternative compositions may be subjected to other heat treatment methods (i.e., in the present of hydrogen peroxide or cystine alone or without anti-VSC agent), or not subjected to heat treatments.

The term “stable” as used herein refers to a food or beverage related product that does not show substantial signs of decomposition, curdling, deformation, phase separation, discoloration and/or precipitation at the conditions (e.g., pH, temperature) in which it is intended for consumption or storage. The term “food or beverage related product” relates to any food or beverage at any stage of the manufacturing thereof. For example, for a milk alternative composition, which undergoes heat treatment, both the heat treated a milk alternative composition and the pre-treated corresponding milk alternative composition are encompassed under “food or beverage related product”.

According to some embodiments, the stable milk alternative composition remains substantially stable at a predetermined temperature for a predetermined time period. According to some embodiments, the stable milk alternative composition remains substantially stable to curdling at a predetermined temperature for a predetermined time period. According to some embodiments, the stable milk alternative composition remains substantially uncurdled at a predetermined temperature for a predetermined time period.

According to some embodiments, the stable milk alternative composition remains substantially stable at a predetermined pH for a predetermined time period. According to some embodiments, the stable milk alternative composition remains substantially stable to curdling at a predetermined pH for a predetermined time period. According to some embodiments, the stable milk alternative composition remains substantially uncurdled at a predetermined pH for a predetermined time period.

According to some embodiments, the stable milk alternative composition remains substantially stable at a predetermined pH and predetermined temperature for a predetermined time period. According to some embodiments, the stable milk alternative composition remains substantially stable to curdling at a predetermined pH and predetermined temperature for a predetermined time period. According to some embodiments, the stable milk alternative composition remains substantially uncurdled at a predetermined pH and predetermined temperature for a predetermined time period.

According to some embodiments, the predetermined temperature is at least 40° C. According to some embodiments, the predetermined temperature is at least 45° C. According to some embodiments, the predetermined temperature is at least 50° C. According to some embodiments, the predetermined temperature is at least 55° C. According to some embodiments, the predetermined temperature is at least 60° C. According to some embodiments, the predetermined temperature is at least 65° C. According to some embodiments, the predetermined temperature is at least 70° C. According to some embodiments, the predetermined temperature is at least 75° C. According to some embodiments, the predetermined temperature is at least 80° C. According to some embodiments, the predetermined temperature is in the range of 50° C. to 90° C. According to some embodiments, the predetermined temperature is in the range of 55° C. to 85° C. According to some embodiments, the predetermined temperature is in the range of 60° C. to 80° C.

According to some embodiments, the predetermined pH is about 4.5. According to some embodiments, the predetermined pH is about 5. According to some embodiments, the predetermined pH is about 5.2. According to some embodiments, the predetermined pH is about 5.5.

According to some embodiments, the predetermined temperature is at least 5 minutes. According to some embodiments, the predetermined temperature is at least 10 minutes. According to some embodiments, the predetermined temperature is at least 15 minutes. According to some embodiments, the predetermined temperature is at least 20 minutes. According to some embodiments, the predetermined temperature is at least 25 minutes. According to some embodiments, the predetermined temperature is at least 30 minutes. Specifically, it is to be understood that in most cases, hot milk beverages are served hot, and cool-down or otherwise are consumed it a time scale of minutes.

According to some embodiments, the stable milk alternative composition remains substantially uncurdled at a temperature of 60° C. for at least 30 minutes. According to some embodiments, the stable milk alternative composition remains substantially uncurdled at pH 5 for at least 30 minutes at 25° C. According to some embodiments, the stable milk alternative composition remains substantially uncurdled at pH 5 and 60° C. for at least 30 minutes.

According to some embodiments, there is provided a stable milk alternative composition, comprising: (i) at least one milk protein; (ii) at least one additive selected from the group consisting of: a mineral chelator, a texturizer and an emulsifier; (iii) at least one saccharide; (iv) at least one fat; and (v) water; wherein the stable milk alternative composition is devoid of animal-derived substances. According to some embodiments, the stable milk alternative composition has a comparable sulfur smell profile to animal milk, and/or the stable milk alternative composition is devoid of micellar casein. According to some embodiments, the stable milk alternative composition has a comparable VSC content profile to animal milk, and/or the stable milk alternative composition is devoid of micellar casein. According to some embodiments, the stable milk alternative composition has a comparable VSC content profile to animal milk, or the stable milk alternative composition is devoid of micellar casein. According to some embodiments, the stable milk alternative composition has a comparable VSC content profile to animal milk, and the stable milk alternative composition is devoid of micellar casein.

The term “comparable” as used herein generally means “capable of or suitable for comparison” i.e. having a minimal likeness or similarity to a reference. For example, the milk alternatives provided here are comparable to animal milk in all the sensoric characteristics, including sulfur smell profile and VSC content profile.

The present disclosure presents several aspects, e.g., (a) a stable milk alternative composition, and (b) a method for obtaining a heat-treated edible aqueous composition, and a heat-treated edible aqueous composition obtained thereby; it is to be understood by a person having ordinary skill in the art that a milk alternative product may include any of the features of the two aspects. Therefore, it is to be understood that any embodiment provided herein as directed to one aspect may similarly apply to the others, and vice versa.

The present milk alternative aqueous compositions have a shelf-life comparable to that of animal milk, while maintaining a similar smell and flavor profile to standard animal milk.

According to some embodiments, the stable milk alternative composition has a comparable sulfur smell profile to animal milk. According to some embodiments, the animal milk is cow milk. According to some embodiments, the animal milk is UTH cow milk.

The phrase “stable milk alternative composition has a comparable sulfur smell profile to animal milk” is intended to mean that the stable milk alternative composition and the animal milk have a similar sulfur smell upon storage at different conditions. For example, the stable milk alternative composition and the animal milk may have a similar sulfur smell upon storage at 20° C. for one week; a similar sulfur smell upon storage at 10° C. for two weeks; similar sulfur smell upon storage at 5° C. for one month, etc. The time duration may be determined from the production date.

Sulfur smell profile comparability can be analytically estimated using e.g. an electronic nose (E-nose; See e.g. Example 3) and/or Hedonic test analysis (See e.g. Example 4). According to the E-nose sulfur smell statistical analysis, upon comparing two compositions, a variance read in the range of 0.95 to 1 (corresponding to 95% to 100% sulfur smell similarity) means that the two compositions have an identical smell; a read in the range of 0.5 to 0.949 (corresponding to 50% to 94.9% sulfur smell similarity) means that the two compositions have a similar smell; and a read in the range of 0 to 0.49 (corresponding to 0% to 49.9% sulfur smell similarity) means that the two compositions have different smells.

According to some embodiments, stable milk alternative composition has a comparable sulfur smell profile to animal milk as statistically determined by E-nose measurements. According to some embodiments, the E-nose measured comparability between the stable milk alternative composition and the animal milk is in the range of 0.5 to 1. According to some embodiments, the E-nose measured comparability between the stable milk alternative composition and the animal milk is in the range of 0.6 to 1. According to some embodiments, the E-nose measured comparability between the stable milk alternative composition and the animal milk is in the range of 0.7 to 1. According to some embodiments, the E-nose measured comparability between the stable milk alternative composition and the animal milk is in the range of 0.8 to 1. According to some embodiments, the E-nose measured comparability between the stable milk alternative composition and the animal milk is in the range of 0.9 to 1. According to some embodiments, the E-nose measured comparability between the stable milk alternative composition and the animal milk is in the range of 0.95 to 1.

According to some embodiments, the stable milk alternative composition and the animal milk retain an E-nose measured comparability of at least 0.5 or in the range of 0.7 to 1, upon storage at 3° C. to 5° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain an E-nose measured comparability of at least 0.5 or in the range of 0.7 to 1, upon storage at 3° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain an E-nose measured comparability of at least 0.5 or in the range of 0.7 to 1, upon storage at 5° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain an E-nose measured comparability of at least 0.5 or in the range of 0.7 to 1, upon storage at 10° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain an E-nose measured comparability of at least 0.5 or in the range of 0.7 to 1, upon storage at 15° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain an E-nose measured comparability of at least 0.5 or in the range of 0.7 to 1, upon storage at 20° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain an E-nose measured comparability of at least 0.5 or in the range of 0.7 to 1, upon storage at 25° C. for three days, one week, two weeks, three weeks, four weeks, five weeks, six weeks, seven weeks or eight weeks. Including each value and sub-range within the specified range and each possibility represents a separate embodiment of the invention.

According to some embodiments, stable milk alternative composition has a comparable sulfur smell profile to animal milk as determined by a Hedonic test measurement. According to some embodiments, the Hedonic test measured comparability between the stable milk alternative composition and the animal milk is in the range of 50% to 100%. According to some embodiments, the Hedonic test measured comparability between the stable milk alternative composition and the animal milk is in the range of 60% to 100%. According to some embodiments, the Hedonic test measured comparability between the stable milk alternative composition and the animal milk is in the range of 70% to 100%. According to some embodiments, the Hedonic test measured comparability between the stable milk alternative composition and the animal milk is in the range of 80% to 100%. According to some embodiments, the Hedonic test measured comparability between the stable milk alternative composition and the animal milk is in the range of 90% to 100%. According to some embodiments, the Hedonic test measured comparability between the stable milk alternative composition and the animal milk is in the range of 95% to 100%.

According to some embodiments, the stable milk alternative composition and the animal milk retain a Hedonic test measured comparability in the range of 70% to 100%, upon storage at 3° C. to 5° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain a Hedonic test measured comparability in the range of 70% to 100%, upon storage at 3° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain a Hedonic test measured comparability in the range of 70% to 100%, upon storage at 5° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain a Hedonic test measured comparability in the range of 70% to 100%, upon storage at 10° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain a Hedonic test measured comparability in the range of 70% to 100%, upon storage at 15° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain a Hedonic test measured comparability in the range of 70% to 100%, upon storage at 20° C. for three days, one week, two weeks, three weeks, four weeks, five weeks, six weeks, seven weeks or eight weeks. Including each value and sub-range within the specified range and each possibility represents a separate embodiment of the invention.

According to some embodiments, the stable milk alternative composition and the animal milk retain a Hedonic test measured comparability in the range of 70% to 100%, upon storage at 25° C. for three days, one week, two weeks, three weeks, four weeks, five weeks, six weeks, seven weeks or eight weeks. Including each value and sub-range within the specified range and each possibility represents a separate embodiment of the invention.

In addition, according to some embodiments, the present stable milk alternative composition imparts an animal milk sulfur smell profile upon experiencing by human subjects, although they are non-animal products, and are devoid of animal ingredients. It is to be understood that “smell” in this context refers to an average human ability to sense smell.

According to some embodiments, the stable milk alternative composition and the animal milk may have a similar sulfur smell upon storage at 3° C.-5° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar sulfur smell upon storage at 3° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar sulfur smell upon storage at 5° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar sulfur smell upon storage at 10° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar sulfur smell upon storage at 15° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar sulfur smell upon storage at 20° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar sulfur smell upon storage at 25° C. for three days, one week, two weeks, three weeks, four weeks, five weeks, six weeks, seven weeks or eight weeks. Each possibility represents a separate embodiment of the invention.

It is to be understood that the sulfur smell profile is imparted on both the animal milk products and on the present stable milk alternative composition mainly by the presence of volatile sulfur compounds (VSCs).

The term “Volatile Sulfur Compound (VSC)” as well as exemplary individual VSCs are as detailed herein above.

According to some embodiments, the stable milk alternative composition has a comparable VSC content profile to animal milk. According to some embodiments, the animal milk is cow milk. According to some embodiments, the animal milk is UTH cow milk.

The phrase “stable milk alternative composition has a comparable VSC content profile to animal milk” is intended to mean that the stable milk alternative composition and the animal milk have a similar contents of total VSCs upon storage at different conditions. For example, the stable milk alternative composition and the animal milk may have a similar sulfur smell upon storage at 20° C. for one week; a similar sulfur smell upon storage at 10° C. for two weeks; similar sulfur smell upon storage at 5° C. for one month, etc. In the context of the present definition, the term similar means ±30%, ±25%, ±20%, ±15%, ±10% or ±5%. Each possibility represents a separate embodiment of the invention.

According to some embodiments, the stable milk alternative composition and the animal milk may have a similar VOC content upon storage at 3° C.-5° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar VOC content upon storage at 3° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar VOC content upon storage at 5° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar VOC content upon storage at 10° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar VOC content upon storage at 15° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar VOC content upon storage at 20° C. for three days, one week, two weeks, three weeks, four weeks, five weeks, six weeks, seven weeks or eight weeks. Each possibility represents a separate embodiment of the invention.

According to some embodiments, the stable milk alternative composition and the animal milk may have a similar VOC content upon storage at 25° C. for three days, one week, two weeks, three weeks, four weeks, five weeks, six weeks, seven weeks or eight weeks. Each possibility represents a separate embodiment of the invention

According to some embodiments, the stable milk alternative composition formed in step (e) has a bacterial count of no more than 30,000 CFU per 1 ml. According to some embodiments, the bacterial count is of no more than 20,000 CFU per 1 ml. According to some embodiments, the bacterial count is of no more than 10,000 CFU per 1 ml. According to some embodiments, the bacterial count is of no more than 5,000 CFU per 1 ml. According to some embodiments, the bacterial count is of no more than 3,000 CFU per 1 ml. According to some embodiments, the bacterial count is of no more than 2,000 CFU per 1 ml. According to some embodiments, the bacterial count is of no more than 1,000 CFU per 1 ml. According to some embodiments, the bacterial count is of no more than 500 CFU per 1 ml. According to some embodiments, the bacterial count is of no more than 300 CFU per 1 ml. According to some embodiments, the bacterial count is of no more than 200 CFU per 1 ml. According to some embodiments, the bacterial count is of no more than 100 CFU per 1 ml. According to some embodiments, the bacterial count is of no more than 50 CFU per 1 ml. According to some embodiments, the bacterial count is of no more than 30 CFU per 1 ml. According to some embodiments, the bacterial count is of no more than 20 CFU per 1 ml. According to some embodiments, the bacterial count is of no more than 10 CFU per 1 ml.

According to some embodiments, the stable milk alternative composition has dry matter rate in the range of 6.5% to 20%, including each value and sub-range within the specified range. According to some embodiments, the stable milk alternative composition has dry matter rate in the range of 7% to 14%. According to some embodiments, the stable milk alternative composition has dry matter rate in the range of 8% to 12%. According to some embodiments, the stable milk alternative composition has dry matter rate of at least 6.5%. According to some embodiments, the stable milk alternative composition has dry matter rate of at least 7%. According to some embodiments, the stable milk alternative composition has dry matter rate of at least 8%. According to some embodiments, the stable milk alternative composition has dry matter rate of at least 9%. According to some embodiments, the stable milk alternative composition has dry matter rate of no more than 20%. According to some embodiments, the stable milk alternative composition has dry matter rate of no more than 15%.

According to some embodiments, the stable milk alternative composition has dry matter rate higher than that of a corresponding milk alternative composition which does not include the milk protein. According to some embodiments, the stable milk alternative composition has dry matter rate higher than that of a corresponding milk alternative composition which does not include the BLG. According to some embodiments, the stable milk alternative composition has dry matter rate higher than that of a corresponding milk alternative composition which does not include the milk protein by at least 1%, at least 2% or at least 3% w/w based on the total wight of the composition.

According to some embodiments, the stable milk alternative composition is in the form of liquid milk.

According to some embodiments, the stable milk alternative composition has viscosity in the range of 8 to 50 cP, including each value and sub-range within the specified range. According to some embodiments, the stable milk alternative composition has viscosity in the range of 10 to 40 cP. According to some embodiments, the stable milk alternative composition has viscosity in the range of 20 to 40 cP. According to some embodiments, the stable milk alternative composition has viscosity in the range of 25 to 35 cP.

According to some embodiments, the stable milk alternative composition has viscosity higher than that of a corresponding milk alternative composition which does not include the milk protein. According to some embodiments, the stable milk alternative composition has viscosity higher than that of a corresponding milk alternative composition which does not include the BLG. According to some embodiments, the stable milk alternative composition has viscosity higher than that of a corresponding milk alternative composition which does not include the milk protein by at least 50%. According to some embodiments, the stable milk alternative composition has viscosity higher than that of a corresponding milk alternative composition which does not include the milk protein by at least 100%. According to some embodiments, the stable milk alternative composition has viscosity higher than that of a corresponding milk alternative composition which does not include the milk protein by at least 150%. According to some embodiments, the stable milk alternative composition has viscosity higher than that of a corresponding milk alternative composition which does not include the milk protein by at least 200%.

According to some embodiments, the stable milk alternative composition has color difference in the range of 0 to 6, as measured by delta E compared to cow milk, including each value and sub-range within the specified range. According to some embodiments, the stable milk alternative composition has color difference in the range of 0 to 4, as measured by delta E compared to cow milk. According to some embodiments, the stable milk alternative composition has color difference in the range of about 3, as measured by delta E compared to cow milk.

According to some embodiments, the stable milk alternative composition has a smaller color difference compared to cow milk than the color difference of a corresponding milk alternative composition which does not include the milk protein. According to some embodiments, the color difference is measured by delta E and the color difference is at least 25% smaller. According to some embodiments, the color difference is at least 50% smaller.

According to some embodiments, the stable milk alternative composition has foam density in the range of 100 to 500 gr/ml, including each value and sub-range within the specified range. According to some embodiments, the stable milk alternative composition has foam density in the range of 200 to 400 gr/ml. According to some embodiments, the stable milk alternative composition has foam density in the range of 250 to 350 gr/ml. According to some embodiments, the stable milk alternative composition has foam density of at least 150 gr/ml. According to some embodiments, the stable milk alternative composition has foam density of at least 200 gr/ml. According to some embodiments, the stable milk alternative composition has foam density of at least 250 gr/ml. According to some embodiments, the stable milk alternative composition has foam density of no more than 500 gr/ml.

According to some embodiments, the stable milk alternative composition has foam stability in the range of 90% to 99%, including each value and sub-range within the specified range. According to some embodiments, the stable milk alternative composition has foam stability in the range of 94% to 99%.

According to some embodiments, the stable milk alternative composition has foam stability higher than that of a corresponding milk alternative composition which does not include the milk protein. According to some embodiments, the stable milk alternative composition has foam stability higher than that of a corresponding milk alternative composition which does not include the BLG. According to some embodiments, the stable milk alternative composition has foam stability higher than that of a corresponding milk alternative composition which does not include the milk protein by at least 5%.

According to some embodiments, the foams of the stable milk alternative compositions provided herein have similar G′ values to the foam of 3% fat cow milk. According to some embodiments, the foams of the stable milk alternative compositions provided herein have similar G″ values to the foam of 3% fat cow milk. According to some embodiments, the foams of the stable milk alternative compositions provided herein have similar G′ and G″ values to the foam of 3% fat cow milk. According to some embodiments, the foams of the stable milk alternative compositions provided herein have G′ values (i) of 30 to 220 at 0.1% to 10% shear rate, (ii) of 2 to 90 at 10% to 100% shear rate, and/or (iii) of 0 to 10 at 100% to 1000% shear rate. Each possibility represents a separate embodiment of the invention. According to some embodiments, the foams of the stable milk alternative compositions provided herein have G″ values (i) of 5 to 45 at 0.1% to 100% shear rate, and/or (ii) of 0 to 12 at 100% to 1000% shear rate. Each possibility represents a separate embodiment of the invention.

According to some embodiments, the foams of the stable milk alternative compositions provided herein have G′ values (i) of 40 to 80 at 0.1% shear rate, (ii) of 45 to 85 at 1% shear rate, (iii) of 15 to 55 at 10% shear rate, and/or (iv) of 1 to 5 at 100% shear rate. Each possibility represents a separate embodiment of the invention. According to some embodiments, the foams of the stable milk alternative compositions provided herein have G″ values (i) of 13 to 23 at 0.1% shear rate, (ii) of 7 to 17 at 1% shear rate, (iii) of 6 to 16 at 10% shear rate, and/or (iv) of 1 to 11 at 100% shear rate. Each possibility represents a separate embodiment of the invention.

According to some embodiments, the foams of the stable milk alternative compositions provided herein have G′ values (i) of 170 to 270 at 0.1% shear rate, (ii) of 130 to 230 at 1% shear rate, (iii) of 65 to 105 at 10% shear rate, and/or (iv) of 1 to 10 at 100% shear rate. Each possibility represents a separate embodiment of the invention. According to some embodiments, the foams of the stable milk alternative compositions provided herein have G″ values (i) of 25 to 45 at 0.1% shear rate, (ii) of 25 to 45 at 1% shear rate, (iii) of 25 to 45 at 10% shear rate, and/or (iv) of 5 to 15 at 100% shear rate. Each possibility represents a separate embodiment of the invention.

According to some embodiments, the foams of the stable milk alternative compositions provided herein have bubble diameter dispersion similar to the bubble diameter dispersion in foam of 3% fat cow milk. According to some embodiments, the foams of the stable milk alternative compositions provided herein have (i) 30%-50% bubbles of a diameter of 0.1-50 micrometer, (ii) 20%-40% bubbles of a diameter of 51-100 micrometer, (iii) 5%-15% bubbles of a diameter of 101-150 micrometer, (iv) 1%-10% bubbles of a diameter of 151-200 micrometer, (v) 3%-10% bubbles of a diameter of 201-250 micrometer, (vi) 1%-5% bubbles of a diameter of 251-300 micrometer, (vii) 1%-5% bubbles of a diameter of 301-350 micrometer, and/or (viii) 2%-6% bubbles of a diameter of 351-400 micrometer. Each possibility represents a separate embodiment of the invention.

According to some embodiments, the stable milk alternative composition in the form of liquid milk coffee, and has color difference in the range of 0 to 20, as measured by delta E compared to a corresponding liquid milk coffee made using cow milk, including each value and sub-range within the specified range. According to some embodiments, the liquid coffee has a smaller color difference compared to cow milk coffee than the color difference of a coffee made using a corresponding milk alternative composition which does not include the milk protein. According to some embodiments, the color difference is measured by delta E and the color difference is at least 25% smaller. According to some embodiments, the color difference is at least 50% smaller.

According to some embodiments, the stable milk alternative composition has greater physical stability to sedimentation than cow milk as measured by an analytical centrifugal analyzer.

According to some embodiments, the stable milk alternative composition has a substantially uniform consistency.

According to some embodiments, the stable milk alternative composition is in the form of an oil-in-water emulsion.

According to some embodiments, the stable milk alternative composition comprises no more than 99% water w/w based on the total weight of the composition. According to some embodiments, the stable milk alternative composition comprises no more than 97% water w/w based on the total weight of the composition. According to some embodiments, the e stable milk alternative composition comprises no more than 95% water w/w based on the total weight of the composition. According to some embodiments, the stable milk alternative composition comprises at least 75% water w/w based on the total weight of the composition. According to some embodiments, the stable milk alternative composition comprises at least 80% water w/w based on the total weight of the composition. According to some embodiments, the stable milk alternative composition comprises at least 83% water w/w based on the total weight of the composition. According to some embodiments, the stable milk alternative composition comprises at least 85% water w/w based on the total weight of the composition. According to some embodiments, the stable milk alternative composition comprises at least 87% water w/w based on the total weight of the composition.

According to some embodiments, the stable milk alternative composition comprises 80% to 95% w/w water. According to some embodiments, the stable milk alternative composition comprises 85% to 95% w/w water. According to some embodiments, the stable milk alternative composition comprises 87% to 95% w/w water.

Specifically, as specific embodiment of the present invention provides stable milk alternative compositions, and as commercial milk typically includes 80% to 95% water w/w, the stable milk alternative composition may be formulated to include similar water content. According to some embodiments, the stable milk alternative composition comprises 85% to 95% water w/w based on the total weight of the composition.

According to some embodiments, the stable milk alternative composition provided herein comprises at least one protein. According to some embodiments, the protein is a milk protein. According to some embodiments, the protein is a whey protein. According to some embodiments, the milk protein is a whey protein.

According to some embodiments, the at least one milk protein of the present stable milk alternative composition comprises beta lactoglobulin (BLG). According to some embodiments, the BLG is a recombinant beta-lactoglobulin (rBLG) protein. According to some embodiments, the BLG is beta-lactoglobulin B (rBLG B). The terms beta lactoglobulin (BLG) and recombinant beta-lactoglobulin (rBLG) are as detailed herein above.

According to some embodiments the at least one milk protein comprises BLG, including variants, analogs and chimeras thereof. According to some embodiments the at least one milk protein comprises a BLG variant or analog. According to some embodiments the at least one milk protein comprises a BLG variant. According to some embodiments the at least one milk protein comprises bovine BLG.

According to some embodiments, the BLG and/or rBLG is selected from amino acid sequence SEQ ID Nos: 1-20 as detailed in Table 1. Each possibility represents a separate embodiment of the invention. According to some embodiments, the BLG and/or rBLG is selected from amino acid sequence SEQ ID Nos: 1-10. According to some embodiments, the BLG and/or rBLG have the amino acid sequence SEQ ID NO: 1.

According to some embodiments, the stable milk alternative composition is substantially devoid of micellar casein. According to some embodiments, the stable milk alternative composition is devoid of micellar casein. According to some embodiments, the stable milk alternative composition is substantially devoid of any casein protein. According to some embodiments, the stable milk alternative composition is devoid of micellar casein. The term “substantially devoid” is as defined herein with respect to lactose.

According to some embodiments, the stable milk alternative composition provided herein comprises at least 0.4% of the at least one milk protein w/w based on the total weight of the composition. According to some embodiments, the stable milk alternative composition comprises at least 0.5% of the at least one milk protein w/w based on the total weight of the composition. According to some embodiments, the stable milk alternative composition comprises at least 1.0% of the at least one milk protein w/w based on the total weight of the composition. According to some embodiments, the stable milk alternative composition comprises at least 1.5% of the at least one milk protein w/w based on the total weight of the composition. According to some embodiments, the stable milk alternative composition comprises at least 2% of the at least one milk protein w/w based on the total weight of the composition. According to some embodiments, the stable milk alternative composition comprises at least 2.5% of the at least one milk protein w/w based on the total weight of the composition. According to some embodiments, the stable milk alternative composition comprises at least 3% of the at least one milk protein w/w based on the total weight of the composition. According to some embodiments, the stable milk alternative composition comprises at least 3.5% of the at least one milk protein w/w based on the total weight of the composition. According to some embodiments, the stable milk alternative composition comprises at least 4% of the at least one milk protein w/w based on the total weight of the composition.

According to some embodiments, the stable milk alternative composition comprises no more than 10% of the at least one milk protein w/w based on the total weight of the composition. According to some embodiments, the stable milk alternative composition comprises no more than 8% of the at least one milk protein w/w based on the total weight of the composition. According to some embodiments, the stable milk alternative composition comprises no more than 6% of the at least one milk protein w/w based on the total weight of the composition. According to some embodiments, the stable milk alternative composition comprises no more than 5.5% of the at least one milk protein w/w based on the total weight of the composition. According to some embodiments, the stable milk alternative composition comprises no more than 5% of the at least one milk protein w/w based on the total weight of the composition. According to some embodiments, the stable milk alternative composition comprises no more than 4.5% of the at least one milk protein w/w based on the total weight of the composition.

Specifically, as specific embodiment of the present invention provides stable milk alternative compositions, and as commercial milk typically includes 2.5% to 6% proteins w/w, the stable milk alternative composition may be formulated to include similar amount of the at least one milk protein content. According to some embodiments, the stable milk alternative composition comprises 2.5% to 6% of the at least one milk protein w/w based on the total weight of the composition. According to some embodiments, the stable milk alternative composition comprises 2.5% to 6% of BLG w/w based on the total weight of the composition. According to some embodiments, the stable milk alternative composition comprises 2.5% to 6% of rBLG w/w based on the total weight of the composition. According to some embodiments, the stable milk alternative composition comprises 4% to 4.5% of the at least one milk protein w/w based on the total weight of the composition. According to some embodiments, the stable milk alternative composition comprises 4% to 4.5% of BLG w/w based on the total weight of the composition. According to some embodiments, the stable milk alternative composition comprises 4% to 4.5% of rBLG w/w based on the total weight of the composition.

According to some embodiments, BLG constitutes at least 51% w/w of the total milk-protein content of the stable milk alternative composition. According to some embodiments, the stable milk alternative composition comprises BLG substantially as the sole whey protein. According to some embodiments, the stable milk alternative composition comprises BLG substantially as the sole milk protein. According to some embodiments, the stable milk alternative composition comprises BLG substantially as the sole protein.

According to some embodiments, the at least one milk protein is a non-animal protein. According to some embodiments, the at least one milk protein is provided from a non-animal source. According to some embodiments, the at least one milk protein is a recombinant protein.

According to some embodiments, the stable milk alternative composition comprises at least one fat. According to some embodiments, the fat is a milk fat. According to some embodiments, the fat is a whey fat. According to some embodiments, the milk fat is a whey fat.

According to some embodiments, the stable milk alternative composition comprises at least 0.5% total fat portion based on the total weight of the composition. According to some embodiments, the stable milk alternative composition comprises at least 1% total fat portion based on the total weight of the composition. According to some embodiments, the stable milk alternative composition comprises at least 1.5% total fat portion based on the total weight of the composition. According to some embodiments, the stable milk alternative composition comprises at least 2% total fat portion based on the total weight of the composition. According to some embodiments, the stable milk alternative composition comprises at least 2.25% total fat portion based on the total weight of the composition. According to some embodiments, the stable milk alternative composition comprises at least 2.5% total fat portion based on the total weight of the composition. According to some embodiments, the stable milk alternative composition comprises at least 2.75% total fat portion based on the total weight of the composition. According to some embodiments, the stable milk alternative composition comprises at least 3% total fat portion based on the total weight of the composition.

According to some embodiments, the stable milk alternative composition comprises no more than 50% total fat portion based on the total weight of the composition. According to some embodiments, the stable milk alternative composition comprises no more than 35% total fat portion based on the total weight of the composition. According to some embodiments, the stable milk alternative composition comprises no more than 25% total fat portion based on the total weight of the composition. According to some embodiments, the stable milk alternative composition comprises no more than 15% total fat portion based on the total weight of the composition. According to some embodiments, the stable milk alternative composition comprises no more than 10% total fat portion based on the total weight of the composition. According to some embodiments, the stable milk alternative composition comprises no more than 8% total fat portion based on the total weight of the composition. According to some embodiments, the stable milk alternative composition comprises no more than 6% total fat portion based on the total weight of the composition. According to some embodiments, the stable milk alternative composition comprises no more than 5% total fat portion based on the total weight of the composition. According to some embodiments, the stable milk alternative composition comprises no more than 4% total fat portion based on the total weight of the composition. According to some embodiments, the stable milk alternative composition comprises no more than 3.5% total fat portion based on the total weight of the composition.

Specifically, as specific embodiment of the present invention provides milk alternative compositions, and as commercial milk typically includes 1% to 5% or 3% to 3.5% fat content w/w, the stable milk alternative composition may be formulated to include similar amount of the fat content. According to some embodiments, the stable milk alternative composition comprises 1% to 5% total fat based on the total weight of the composition. According to some embodiments, the stable milk alternative composition comprises 3% to 3.5% total fat based on the total weight of the composition.

According to some embodiments, the stable milk alternative composition comprises at least one vegetable fat. According to some embodiments, the stable milk alternative composition comprises at least one fat which is not present in an animal fat. It is to be understood that milk alternative products may include a mixture of fats, some of which are corresponding (i.e., sharing the same chemical formula) to fats found in animal milk, and some of which are not found in animal milk, where preferable, each of the fats is not provided from animals. According to some embodiments, the stable milk alternative composition comprises at least one fat.

According to some embodiments, the at least one milk fat is provided from a non-animal source. It is to be understood that in the context of the present invention and under the definitions presented hereinabove, a non-animal milk fat refers to any milk fat, which is provided, produced, extracted or derived from a non-animal source, as defined above.

According to some embodiments, the plant fat comprises shea fat, rapeseed oil, olive oil, palm oil, vegetable oil, cottonseed oil, almond oil, canola oil, coconut oil, corn oil, grape seed oil, peanut oil, saffron oil, sesame oil, soybean oil, a processing product thereof or any combination thereof. According to some embodiments, the plant triglyceride composition comprises shea fat or a processing product thereof. The term “shea fat” as used herein refers to any fatty composition derived from shea plant, including, but not limited to, shea butter, shea oil and/or any shea lipid extract. Vitellaria paradoxa, commonly known as shea tree or vitellaria, is a tree of the family Sapotaceae. According to some embodiments, the plant fat comprises coconut fat.

According to some embodiments, the method further comprises obtaining the non-animal fat from a plant source. Obtaining triglycerides from plants may include extracting the fatty portion of the plant by any procedure known in the art, according to some embodiments.

According to some embodiments, the non-animal fat is provided from a microorganism, or synthetic source. Each possibility represents a separate embodiment of the invention. Each possibility represents a separate embodiment of the invention.

As detailed herein the present stable milk alternative composition comprises at least one saccharide. The term “saccharide” as used herein includes any mono-di-, tri-, oligo- and poly-saccharide or saccharide derivative. Saccharides are aldehyde or ketone compounds substituted with a plurality of hydroxyl groups, and their polymers and oligomers. The term includes saccharides, which are substituted or deoxygenated at one or more positions. As used herein, saccharides include unmodified saccharides, saccharide derivatives, substituted saccharides and modified saccharides. As used herein, the phrases “saccharide derivative,” “substituted saccharide,” and “modified saccharide” are synonymous. Modified saccharide refers to any saccharide, or a combination thereof, in which at least one atom is added, removed, or substituted. Thus, derivatives of saccharides or substituted saccharides include substituted and unsubstituted monosaccharides, disaccharides, oligosaccharides and polysaccharides. The saccharide derivative or substituted saccharide is optionally deoxy at any corresponding C-position and/or substituted with one or more moieties such as hydrogen, halogen, haloalkyl, carboxy, acyl, acyloxy, amino, amido, carboxy derivative, alkylamino, dialkylamino, arylamino, alkoxy, aryloxy, nitro, cyano, sulfo, mercapto, imino, sulfonyl, sulfinyl, sulfenyl, sulfinyl, sulfamoyl, carboalkoxy, carboxamido, phosphonyl, phosphinio, phosphoryl, phosphino, thioester, thioether, oximino, hydrazino, carbamate, phospho, phosphonate, or any other functional group. Thus, it is to be understood that sugar alcohols are encompassed within the term saccharide. Saccharides may be derived from any natural or synthetic sources. According to some embodiments, the saccharide the present composition is a non-animal saccharide, i.e., it is derived from any source, other than from an animal.

According to some embodiments, the saccharide is a sweetener. According to some embodiments, the saccharide sweetener is a natural saccharide sweetener. According to some embodiments, the saccharide sweetener is an artificial saccharide sweetener.

According to some embodiments, the stable milk alternative composition of the present invention further comprises a sweetener. According to some embodiments, the sweetener is an artificial sweetener. According to some embodiments, the sweetener is a natural sweetener. According to some embodiments, the sweetener is not a saccharide. As detailed above, it is to be understood that both artificial and natural sweeteners are encompassed in the present invention. While the relative content of sugar sweeteners is specified above, a corresponding content of non-sugar sweeteners encompassed by the present invention corresponds to the sweetness imparted by the contents above, by non-sugar sweeteners.

According to some embodiments, the at least one saccharide contained in the present stable milk alternative composition comprises at least one monosaccharide and/or disaccharide. According to some embodiments, the at least one saccharide contained in the present stable milk alternative composition comprises at least one disaccharide. According to some embodiments, the stable milk alternative composition of comprises at least one disaccharide, which is not lactose. According to some embodiments, the at least one disaccharide is not glucose. According to some embodiments, the at least one disaccharide is not lactose or glucose. According to some embodiments, the at least one disaccharide is not lactose, glucose, fructose or glucose. According to some embodiments, the stable milk alternative composition of comprises at least one saccharide, which is not lactose. According to some embodiments, the at least one saccharide is not glucose. According to some embodiments, the at least one saccharide is not lactose or glucose. According to some embodiments, the at least one saccharide is not lactose, glucose, fructose or glucose.

According to some embodiments, the stable milk alternative composition is substantially devoid of lactose. According to some embodiments, the stable milk alternative composition is devoid of lactose.

According to some embodiments, the at least one saccharide is selected from the group consisting of: maltose, sucrose, glucose, fructose, erythritol, xylitol and sorbitol, mannitol and any combination thereof.

According to some embodiments, the at least one saccharide comprises maltose. According to some embodiments, the at least one saccharide is maltose. According to some embodiments, the at least one disaccharide comprises maltose. According to some embodiments, the at least one disaccharide is maltose.

According to some embodiments, the stable milk alternative composition comprises at least 0.5% saccharide w/w. According to some embodiments, the stable milk alternative composition comprises at least 1% saccharide w/w. According to some embodiments, the stable milk alternative composition comprises at least 1.5% saccharide w/w. According to some embodiments, the stable milk alternative composition comprises at least 2% saccharide w/w. According to some embodiments, the stable milk alternative composition comprises at least 2.5% saccharide w/w. According to some embodiments, the stable milk alternative composition comprises at least 3% saccharide w/w. According to some embodiments, the stable milk alternative composition comprises no more than 6% saccharide w/w. According to some embodiments, the stable milk alternative composition comprises no more than 5% saccharide w/w. According to some embodiments, the stable milk alternative composition comprises no more than 4% saccharide w/w. According to some embodiments, the stable milk alternative composition comprises no more than 3.5% saccharide w/w. According to some embodiments, the stable milk alternative composition comprises 1.5% to 5% saccharide w/w. According to some embodiments, the stable milk alternative composition comprises 3% to 3.5% saccharide w/w.

According to some embodiments, the stable milk alternative composition comprises at least 0.5% saccharide sweetener w/w. According to some embodiments, the stable milk alternative composition comprises at least 1% saccharide sweetener w/w. According to some embodiments, the stable milk alternative composition comprises at least 1.5% saccharide sweetener w/w. According to some embodiments, the stable milk alternative composition comprises at least 2% saccharide sweetener w/w. According to some embodiments, the stable milk alternative composition comprises at least 2.5% saccharide sweetener w/w. According to some embodiments, the stable milk alternative composition comprises at least 3% saccharide sweetener w/w. According to some embodiments, the stable milk alternative composition comprises no more than 6% saccharide sweetener w/w. According to some embodiments, the stable milk alternative composition comprises no more than 5% saccharide sweetener w/w. According to some embodiments, the stable milk alternative composition comprises no more than 4% saccharide sweetener w/w. According to some embodiments, the stable milk alternative composition comprises no more than 3.5% saccharide sweetener w/w. According to some embodiments, the stable milk alternative composition comprises 1.5% to 5% saccharide sweetener w/w. According to some embodiments, the stable milk alternative composition comprises 3% to 3.5% saccharide sweetener w/w.

According to some embodiments, the stable milk alternative composition comprises at least 0.5% disaccharide w/w. According to some embodiments, the stable milk alternative composition comprises at least 1% disaccharide w/w. According to some embodiments, the stable milk alternative composition comprises at least 1.5% disaccharide w/w. According to some embodiments, the stable milk alternative composition comprises at least 2% disaccharide w/w. According to some embodiments, the stable milk alternative composition comprises at least 2.5% disaccharide w/w. According to some embodiments, the stable milk alternative composition comprises at least 3% disaccharide w/w. According to some embodiments, the stable milk alternative composition comprises no more than 6% disaccharide w/w. According to some embodiments, the stable milk alternative composition comprises no more than 5% disaccharide w/w. According to some embodiments, the stable milk alternative composition comprises no more than 4% disaccharide w/w. According to some embodiments, the stable milk alternative composition comprises no more than 3.5% disaccharide w/w. According to some embodiments, the stable milk alternative composition comprises 1.5% to 5% disaccharide w/w. According to some embodiments, the stable milk alternative composition comprises 3% to 3.5% disaccharide w/w.

Specifically, as commercial milk typically includes 1.5% to 5% sugar content w/w, the stable milk alternative composition may be formulated to include similar of amount the sugar content or a non-saccharide sweetener, which has approximately the same sweetness capacity.

Additionally or as an alternative of saccharide sweetener(s), the stable milk alternative composition of the present invention may include other types of saccharides. One particular class of polysaccharides, which is employed in the food and beverage industry, is the class of dietary fibers. Thus, according to some embodiments, the at least one saccharide comprises a dietary fiber.

The term “dietary fiber” encompasses non-starch polysaccharides and other plant components such as cellulose, resistant starch, resistant dextrins, inulin, lignins, chitins (in fungi), pectins, beta-glucans, and oligosaccharides.

According to some embodiments, the at least one saccharide comprises at least one polysaccharide.

According to some embodiments, the at least one polysaccharide comprises at least one polysaccharide fiber. According to some embodiments, the at least one polysaccharide fiber comprises a fructan dietary fiber. According to some embodiments, the at least one polysaccharide comprises inulin. According to some embodiments, the at least one polysaccharide comprises inulin fiber.

According to some embodiments, the stable milk alternative composition comprises at least 0.5% dietary fiber w/w. According to some embodiments, the stable milk alternative composition comprises at least 1% dietary fiber w/w. According to some embodiments, the stable milk alternative composition comprises at least 1.5% dietary fiber w/w. According to some embodiments, the stable milk alternative composition comprises no more than 5% dietary fiber w/w. According to some embodiments, the stable milk alternative composition comprises no more than 4% dietary fiber w/w. According to some embodiments, the stable milk alternative composition comprises no more than 3% dietary fiber w/w. According to some embodiments, the dietary fiber is present at a concentration of 0.5% to 6% w/w, 1% to 5% w/w, 1.5% to 4% w/w or 1.5% to 2.5% w/w. Each possibility represents a separate embodiment of the invention. According to some embodiments, the stable milk alternative composition comprises about 2% dietary fiber w/w.

According to some embodiments, the stable milk alternative composition comprises at least 0.5% inulin w/w. According to some embodiments, the stable milk alternative composition comprises at least 1% inulin w/w. According to some embodiments, the stable milk alternative composition comprises at least 1.5% inulin w/w. According to some embodiments, the stable milk alternative composition comprises no more than 5% inulin w/w. According to some embodiments, the stable milk alternative composition comprises no more than 4% inulin w/w. According to some embodiments, the stable milk alternative composition comprises no more than 3% inulin w/w. According to some embodiments, the inulin is present at a concentration of 0.5% to 6% w/w, 1% to 5% w/w, 1.5% to 4% w/w or 1.5% to 2.5% w/w. Each possibility represents a separate embodiment of the invention. According to some embodiments, the stable milk alternative composition comprises about 2% inulin w/w.

According to some embodiments, the stable milk alternative composition comprises no more than 3.5% disaccharide w/w. According to some embodiments, the stable milk alternative composition comprises 1.5% to 5% disaccharide w/w.

According to some embodiments, the least one polysaccharide comprises gellan gum. According to some embodiments, the gellan gum is present at a concentration of 0.002% to 0.05% w/w. According to some embodiments, the gellan gum is present at a concentration of about 0.01% w/w.

The term “gellan gum” as used herein means a deacetylated microbial polysaccharide produced by the microorganism Sphingomon elodea. gellan gum is a linear heteropolysaccharide composed of repeating units of four sugars of glucose, glucuronic acid, glucose and L-rhamnose, and has a glucuronic acid-derived carboxy group. There are two types of gellan gum: deacylated and native. The difference is the presence or absence of an acetyl group and a glyceryl group present in the 1-3-linked glucose. The “deacylated type” is obtained by removing the acetyl group and the glyceryl group. The “native type” is a glucose residue in which one glyceryl group residue and an average 1/2 residue of an acetyl group are bonded. Among them, the gellan gum contained in the protein-containing beverage obtained by the production method of the present embodiment is preferably a native type.

According to some embodiments, the least one polysaccharide comprises arabic gum. According to some embodiments, the arabic gum is present at a concentration of 0.05% to 0.3% w/w. According to some embodiments, the arabic gum is present at a concentration of about 0.15% w/w.

As used herein, the term “arabic gum” refers to a polysaccharide-based material obtained from acacia secretions. More specifically, the arabic gum is dried from the bark of the bark of an Acacia senegal (Scientific name: Acacia sengal) or its related plant. Arabic gum swells like gelatin when absorbed. The arabic gum is senegal, A.M. abysinica, A.M. glaucophylla, A.M. giraffae, A.M. refiiens, A.M. It can be collected from fistula and the like. Arabic gum has a high solubility in water, its aqueous solution exhibits a strong viscosity, and exhibits good emulsification stability. Therefore, arabic gum may be used in beverages and foods as an emulsifier or stabilizer. The main component of arabic gum is a polysaccharide. Arabic gum is a mixture of arabinogalactan (about 75% to about 94%), arabinogalactan-protein (about 5% to about 20%), glycoprotein (about 1% to about 5%) and the like.

According to some embodiments, the stable milk alternative composition comprises at least 0.5% polysaccharide(s) w/w. According to some embodiments, the stable milk alternative composition comprises at least 1% polysaccharide(s) w/w. According to some embodiments, the stable milk alternative composition comprises at least 1.5% polysaccharide(s) w/w. According to some embodiments, the stable milk alternative composition comprises no more than 5% polysaccharide(s) w/w. According to some embodiments, the stable milk alternative composition comprises no more than 4% polysaccharide(s) w/w. According to some embodiments, the stable milk alternative composition comprises no more than 3% polysaccharide(s) w/w. According to some embodiments, the polysaccharide(s) is present at a concentration of 0.5% to 6% w/w, 1% to 5% w/w, 1.5% to 4% w/w or 1.5% to 2.5% w/w. Each possibility represents a separate embodiment of the invention. According to some embodiments, the stable milk alternative composition comprises about 2% polysaccharide(s) w/w.

As detailed herein, the present stable milk alternative composition comprises at least one additive selected from the group consisting of: a mineral chelator, a texturizer and an emulsifier, according to some embodiments. Each possibility represents a separate embodiment of the invention.

According to some embodiments, the additive comprises a mineral chelator. According to some embodiments, the mineral chelator comprises a citrate salt. According to some embodiments, the mineral chelator comprises a sodium citrate salt. According to some embodiments, the mineral chelator is selected from the group consisting of: monosodium citrate, disodium citrate, trisodium citrate and a combination thereof.

According to some embodiments, the citrate salt comprises trisodium citrate. According to some embodiments, the mineral chelator is trisodium citrate.

According to some embodiments, the stable milk alternative composition comprises at least 0.01% mineral chelator(s) w/w. According to some embodiments, the stable milk alternative composition comprises at least 0.05% mineral chelator(s) w/w. According to some embodiments, the stable milk alternative composition comprises at least 0, 1% mineral chelator(s) w/w. According to some embodiments, the stable milk alternative composition comprises at least 0.15% mineral chelator(s) w/w. According to some embodiments, the stable milk alternative composition comprises no more than 1% mineral chelator(s) w/w. According to some embodiments, the stable milk alternative composition comprises no more than 0.5% mineral chelator(s) w/w. According to some embodiments, the stable milk alternative composition comprises no more than 0.25% mineral chelator(s) w/w. According to some embodiments, the stable milk alternative composition comprises no more than 0.2% mineral chelator(s) w/w. According to some embodiments, the stable milk alternative composition comprises 0.05% to 0.3% mineral chelator(s) w/w. According to some embodiments, the stable milk alternative composition comprises about 0.16% mineral chelator(s) w/w.

According to some embodiments, the stable milk alternative composition comprises at least 0.01% trisodium citrate w/w. According to some embodiments, the stable milk alternative composition comprises at least 0.05% trisodium citrate w/w. According to some embodiments, the stable milk alternative composition comprises at least 0, 1% trisodium citrate w/w. According to some embodiments, the stable milk alternative composition comprises at least 0.15% trisodium citrate w/w. According to some embodiments, the stable milk alternative composition comprises no more than 1% trisodium citrate w/w. According to some embodiments, the stable milk alternative composition comprises no more than 0.5% trisodium citrate w/w. According to some embodiments, the stable milk alternative composition comprises no more than 0.25% trisodium citrate w/w. According to some embodiments, the stable milk alternative composition comprises no more than 0.2% trisodium citrate w/w. According to some embodiments, the stable milk alternative composition comprises 0.05% to 0.3% trisodium citrate w/w. According to some embodiments, the stable milk alternative composition comprises about 0.16% trisodium citrate w/w.

According to some embodiments, the additive comprises a texturizer.

The term “texturizer” means any additive designed to give a structure and a specific consistency to the stable milk alternative composition according to the present invention. Advantageously, it was found that gellan gum as texturizer helps to stabilize the proteins within the stable milk alternative composition, specifically at elevated temperatures. The texturizer(s) contained in the stable milk alternative composition of the present invention include any stabilizer(s) which stabilizes proteins in suspension, according to some embodiments. Advantageously, it was found that inulin fiber is both a texturizer and added little sweetness.

According to some embodiments, the texturizer comprises gellan gum.

According to some embodiments, the stable milk alternative composition comprises at least 0.001% gellan gum w/w. According to some embodiments, the stable milk alternative composition comprises at least 0.005% gellan gum w/w. According to some embodiments, the stable milk alternative composition comprises at least 0.0075% gellan gum w/w. According to some embodiments, the stable milk alternative composition comprises no more than 0.05% gellan gum w/w. According to some embodiments, the stable milk alternative composition comprises no more than 0.02% gellan gum w/w. According to some embodiments, the stable milk alternative composition comprises no more than 0.015% gellan gum w/w. According to some embodiments, the gellan gum is present at a concentration of 0.002% to 0.05% w/w. According to some embodiments, the gellan gum is present at a concentration of about 0.01% w/w. According to some embodiments, the texturizer comprises inulin fiber. According to some embodiments, the inulin fiber is present at a concentration of 1% to 3% w/w.

According to some embodiments, the additive comprises an emulsifier.

In the present context the term “emulsifier” means one or more chemical additives that encourage the suspension of one liquid in another, as in the mixture of oil and water in various food products (e.g., margarine).

According to some embodiments, the emulsifier has Hydrophilic-lipophilic balance (HLB) of at least 15.

The term “hydrophilic-lipophilic balance” as used herein relates to the measurement of the degree to which a compound is hydrophilic or lipophilic, determined by calculating values for the different regions of the molecule, as described by Griffin (Griffin, W. C. (1949), Journal of the Society of Cosmetic Chemists 1 (5): 311-26 and Griffin, William C. (1954), Journal of the Society of Cosmetic Chemists 5 (4): 249-56). This method requires the use of Formula (i) below:

$$Hydrophilic - lipophilic balance = 20 \times Mh / M , \qquad ( i )$$

where Mh is the molecular mass of the hydrophilic portion of the molecule, and M is the molecular mass of the whole molecule, giving a result on a scale of 0 to 20. A hydrophilic-lipophilic balance value of 0 corresponds to a completely lipophilic/hydrophobic molecule, and a value of 20 corresponds to a completely hydrophilic/lipophobic molecule. In general, a value of 10 or below corresponds to a lipid soluble (water insoluble) molecule.

According to some embodiments, the emulsifier comprises arabic gum. According to some embodiments, the emulsifier is arabic gum.

Advantageously, it was found that arabic gum improves the foaming properties of the present stable milk alternative composition. Specifically, BLG proteins have a good foaming capacity and lower density than cow proteins. The addition of arabic gum was found to stabilize the air bubbles in the milk alternative emulsion, so that they resemble the foaming of animal milk.

According to some embodiments, the stable milk alternative composition comprises at least 0.015% arabic gum w/w. According to some embodiments, the stable milk alternative composition comprises at least 0.075% arabic gum w/w. According to some embodiments, the stable milk alternative composition comprises at least 0.01% arabic gum w/w. According to some embodiments, the stable milk alternative composition comprises no more than 0.75% arabic gum w/w. According to some embodiments, the stable milk alternative composition comprises no more than 0.3% arabic gum w/w. According to some embodiments, the stable milk alternative composition comprises no more than 0.2% arabic gum w/w. According to some embodiments, the arabic gum is present at a concentration of 0.03% to 0.3% w/w. According to some embodiments, the arabic gum is present at a concentration of about 0.15% w/w.

According to some embodiments, the stable milk alternative composition comprises at least two additives selected from the group consisting of: mineral chelators, texturizers and emulsifiers. According to some embodiments, the stable milk alternative composition comprises at least three additives selected from the group consisting of: mineral chelators, texturizers and emulsifiers.

According to some embodiments, the stable milk alternative composition further comprises at least one pH adjusting agent.

According to some embodiments, the stable milk alternative composition comprises a buffer composition, which maintains a pH range of 6.6 to 7.4 and comprises an aqueous solution of the at least one pH adjusting agent. Typically, pH buffer composition used in the food and beverage industry are solutions, i.e. the pH adjusting agent contained therein is soluble and dissolved. Thus, it is to be understood that although when that the buffer composition is incorporated into the present stable milk alternative composition the product mixture is an emulsion (due to fat/water mixture) the pH buffer composition can still be regarded as a solution.

According to some embodiments, the pH adjusting agent is a basic compound. According to some embodiments, the pH adjusting agent is a basic inorganic compound.

According to some embodiments, the pH adjusting agent comprises an alkali phosphate. According to some embodiments, the pH adjusting agent is selected from the group consisting of: monosodium phosphate (MSP), disodium phosphate (DSP), dipotassium phosphate (DPP) and a combination thereof. According to some embodiments, the pH adjusting agent comprises at least two of MSP, DSP and DPP. According to some embodiments, the pH adjusting agent comprises MSP, DSP and DPP.

According to some embodiments, the pH adjusting agent is selected from the group consisting of: monosodium phosphate (MSP), disodium phosphate (DSP), dipotassium phosphate (DPP), monopotassium Phosphate (MPP) and a combination thereof. According to some embodiments, the pH adjusting agent comprises at least two of MSP, DSP, DPP and MPP. According to some embodiments, the pH adjusting agent comprises DPP and MPP.

According to some embodiments, the stable milk alternative composition comprises 0.05% to 0.12% w/w MSP, including each value and sub-range within the specified range. According to some embodiments, the stable milk alternative composition comprises 0.1% to 0.3% w/w DSP, including each value and sub-range within the specified range. According to some embodiments, the stable milk alternative composition comprises 0.5% to 1.5% w/w DPP, including each value and sub-range within the specified range. According to some embodiments, the stable milk alternative composition comprises 0.05% to 0.25% w/w MPP, including each value and sub-range within the specified range.

According to some embodiments, the stable milk alternative composition comprises 0.05% to 0.12% w/w MSP, 0.1% to 0.3% w/w DSP, and 0.5% to 0.8% w/w DPP. According to some embodiments, the stable milk alternative composition comprises 0.1-0.25% w/w MPP, and 0.5% to 1.1% w/w DPP

According to some embodiments, the stable milk alternative composition has a pH of at least 6. According to some embodiments, the stable milk alternative composition has a pH of at least 6.25. According to some embodiments, the stable milk alternative composition has a pH of at least 6.5. According to some embodiments, the stable milk alternative composition has a pH of at least 6.6. According to some embodiments, the stable milk alternative composition has a pH of at least 6.75. According to some embodiments, the stable milk alternative composition has a pH of at least 7. According to some embodiments, the stable milk alternative composition has a pH of at least 7.1. According to some embodiments, the stable milk alternative composition has a pH of at least 7.2. According to some embodiments, the stable milk alternative composition has a pH of no more than 8. According to some embodiments, the stable milk alternative composition has a pH of no more than 7.75. According to some embodiments, the stable milk alternative composition has a pH of no more than 7.5. According to some embodiments, the stable milk alternative composition has a pH of no more than 7.3.

Specifically, as commercial milk typically has pH of 6.7 to 6.9 or 6.6 to 7.4, the stable milk alternative composition may be formulated to include similar pH. According to some embodiments, the stable milk alternative composition has a pH in the range of 6.7 to 6.9. According to some embodiments, the stable milk alternative composition has a pH in the range of 6.6 to 7.4. According to some embodiments, the stable milk alternative composition has a pH in the range of 7.2 to 7.3.

As detailed herein, the stable milk alternative composition may undergo the heat treatment process disclosed herein or other heat treatment processes using hydrogen peroxide and/or cystine. As a result, it may include trace amounts of hydrogen peroxide and/or cystine.

According to some embodiments, the stable milk alternative composition further comprises hydrogen peroxide. According to some embodiments, the hydrogen peroxide is present at a concentration of 0.03 ppm to 0.3 ppm. According to some embodiments, the hydrogen peroxide is at a concentration of 0.03 ppm to 250 ppm, including each value and sub-range within the specified range.

According to some embodiments, the stable milk alternative composition further comprises cystine. According to some embodiments, the cystine is present at a concentration of 0.1 ppm to 1 ppm. According to some embodiments, the cystine is at a concentration of 0.1 ppm to 250 ppm, including each value and sub-range within the specified range. According to some embodiments, the cystine is at a concentration below 30 ppm, as determined by chromatography. According to some embodiments, the chromatography is HPLC. According to some embodiments, the chromatography is performed with a photo diode array, refractive-index UV light and/or visible light detector. According to some embodiments, the chromatography is performed with a UV and/or visible light detector. According to some embodiments, the chromatography is performed with a UV detector. According to some embodiments, the UV and/or visible light detector is configured to measure the light intensity at wavelengths in the range of 200 nm to 300 nm. According to some embodiments, the detector comprises a 206 nm detector, a 280 nm detector or both. According to some embodiments, the chromatography is performed with a 280 nm detector (for BLG) and/or a 206 nm detector (for cystine).

According to some embodiments, the stable milk alternative composition further comprises at least one flavoring agent. According to some embodiments, the flavoring agent imparts perception and/or mouthfeel characteristic of animal milk. For example the fatty mouthfeel characteristic of cowmilk. According to some embodiments, the stable milk alternative composition comprises 0.05% to 0.2% flavoring agent(s).

According to some embodiments, the stable milk alternative composition further comprises at least one coloring agent. Relevant coloring agents are yellow colorants, which can impart a milky appearance to the stable milk alternative composition.

According to some embodiments, the stable milk alternative composition further comprises at least one of a vitamin and a mineral, which are present in animal milk. According to some embodiments, the vitamin and a mineral are present in the stable milk alternative composition in an amount comparable to that the corresponding ingredient(s) in animal milk.

According to some embodiments, the mineral is selected from the group consisting of: calcium, magnesium, potassium and zinc. Each possibility represents a separate embodiment of the invention. According to some embodiments, the mineral comprises calcium.

According to some embodiments, the mineral comprises a phosphate salt. According to some embodiments, the mineral comprises tricalcium phosphate. According to some embodiments, the mineral comprises a carbonate salt. According to some embodiments, the mineral comprises calcium carbonate.

According to some embodiments, the stable milk alternative composition comprises at least 0.05% w/w total minerals. According to some embodiments, the stable milk alternative composition comprises at least 0.1% w/w total minerals. According to some embodiments, the stable milk alternative composition comprises at least 0.125% w/w total minerals. According to some embodiments, the stable milk alternative composition comprises at least 0.14% w/w total minerals. According to some embodiments, the stable milk alternative composition comprises no more than 1% w/w total minerals. According to some embodiments, the stable milk alternative composition comprises no more than 0.5% w/w total minerals. According to some embodiments, the stable milk alternative composition comprises 0.1% to 0.4% w/w total minerals. According to some embodiments, the stable milk alternative composition comprises 0.05% to 0.4% w/w total minerals.

It is to be understood that in this context, “total minerals” refers to the total weight of metal cations, which are considered minerals, rather than the weight of the molecule (that further includes a counter anion).

According to some embodiments, the stable milk alternative composition comprises at least 0.05% w/w calcium. According to some embodiments, the stable milk alternative composition comprises at least 0.1% w/w calcium. According to some embodiments, the stable milk alternative composition comprises at least 0.125% w/w calcium. According to some embodiments, the stable milk alternative composition comprises at least 0.14% w/w calcium. According to some embodiments, the stable milk alternative composition comprises no more than 1% w/w calcium. According to some embodiments, the stable milk alternative composition comprises no more than 0.5% w/w calcium. According to some embodiments, the stable milk alternative composition comprises 0.1% to 0.4% w/w calcium. According to some embodiments, the stable milk alternative composition comprises 0.05% to 0.4% w/w calcium.

According to some embodiments, the stable milk alternative composition comprises at least 0.05% w/w tricalcium phosphate. According to some embodiments, the stable milk alternative composition comprises at least 0.1% w/w tricalcium phosphate. According to some embodiments, the stable milk alternative composition comprises at least 0.125% w/w tricalcium phosphate. According to some embodiments, the stable milk alternative composition comprises at least 0.15% w/w tricalcium phosphate. According to some embodiments, the stable milk alternative composition comprises at least 0.2% w/w tricalcium phosphate. According to some embodiments, the stable milk alternative composition comprises no more than 1% w/w tricalcium phosphate. According to some embodiments, the stable milk alternative composition comprises no more than 0.5% w/w tricalcium phosphate. According to some embodiments, the stable milk alternative composition comprises 0.1% to 0.5% w/w tricalcium phosphate. According to some embodiments, the stable milk alternative composition comprises 0.15% to 0.4% w/w tricalcium phosphate.

According to some embodiments, the stable milk alternative composition comprises at least 0.15% w/w calcium carbonate. According to some embodiments, the stable milk alternative composition comprises at least 0.2% w/w calcium carbonate. According to some embodiments, the stable milk alternative composition comprises at least 0.25% w/w calcium carbonate. According to some embodiments, the stable milk alternative composition comprises at least 0.3% w/w calcium carbonate. According to some embodiments, the stable milk alternative composition comprises at least 0.4% w/w calcium carbonate. According to some embodiments, the stable milk alternative composition comprises no more than 1% w/w calcium carbonate. According to some embodiments, the stable milk alternative composition comprises no more than 0.75% w/w calcium carbonate. According to some embodiments, the stable milk alternative composition comprises 0.25% to 0.75% w/w calcium carbonate.

According to some embodiments, the stable milk alternative composition comprises: (i) recombinant beta-lactoglobulin B (rBLG), 0.5% to 10% w/w; (ii) a mineral chelator, 0.05% to 0.5% w/w; (iii) a saccharide, 0.5% to 10% w/w; (iv) optionally, a fat, 0% to 10% w/w; (v) optionally, a texturizer, 0.001% to 10% w/w; (vi) optionally, an emulsifier, 0.01% to 1% w/w; (vii) optionally, a pH adjustment agent, 0.1% to 3% w/w; (viii) optionally, a mineral, 0.05% to 5% w/w; (ix) optionally, a flavoring agent, 0.05% to 1% w/w; (x) optionally, a coloring agent; and (xi) water, to 100% w/w.

According to some embodiments, the stable milk alternative composition comprises: (i) recombinant beta-lactoglobulin B (rBLG), 1% to 6% w/w; (ii) a mineral chelator, 0.05% to 0.2% w/w; (iii) a saccharide, 1% to 6% w/w; (iv) optionally, a fat, 1% to 5% w/w; (v) optionally, a texturizer, 0.01% to 3% w/w; (vi) optionally, an emulsifier, 0.1% to 0.2% w/w; (vii) optionally, a pH adjustment agent, 0.5% to 1.5% w/w; (viii) optionally, a mineral, 0.1% to 1% w/w; (ix) optionally, a flavoring agent, 0.05% to 0.5% w/w; (x) optionally, a coloring agent; and (xi) water, to 100% w/w.

According to some embodiments, the stable milk alternative composition is selected from the group consisting of: Composition A, Composition B, Composition C, Composition D and Composition E,
wherein Composition A comprises:
   (i) recombinant beta-lactoglobulin B (rBLG), 2.5% to 6% w/w;
   (ii) trisodium citrate, 0.1% to 0.3% w/w;
   (iii) maltose, 1.5% to 5% w/w;
   (iv) vegetable fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) monosodium phosphate (MSP), 0.05% to 0.12% w/w;
   (x) disodium phosphate (DSP), 0.1% to 0.3% w/w;
   (xi) dipotassium phosphate (DPP), 0.5% to 0.8% w/w;
   (xii) optionally, a coloring agent, preferably yellow colorant, 0.005% to 0.05%
   w/w;
   (xiii) optionally, a flavoring agent, 0.05% to 0.2% w/w;
   (xiv) optionally, hydrogen peroxide, 0.10 ppm to 1 ppm;
   (xv) optionally, cystine, 0.03 ppm to 0.3 ppm; and
   (xvi) optionally, tricalcium phosphate, 0.15% to 0.4% w/w;
wherein the stable milk alternative Composition A is devoid of animal-derived substances and has a pH above the pI of BLG, preferably the pH is in the range of 7.2 to 7.3;
wherein Composition B comprises:
   (i) recombinant beta-lactoglobulin B (rBLG), 2.5% to 6% w/w;
   (ii) trisodium citrate, 0.1% to 0.3% w/w;
   (iii) maltose, 2% to 5.5% w/w;
   (iv) palm fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) MSP, 0.05% to 0.12% w/w;
   (x) DSP, 0.1% to 0.3% w/w;
   (xi) DPP, 0.5% to 0.8% w/w;
   (xii) optionally, a coloring agent, preferably yellow colorant, 0.005% to 0.05% w/w;
   (xiii) optionally, a flavoring agent, 0.2% to 0.5% w/w;
   (xiv) optionally, hydrogen peroxide, 0.10 ppm to 1 ppm;
   (xv) optionally, cystine, 0.03 ppm to 0.3 ppm; and
   (xvi) optionally, tricalcium phosphate, 0.15% to 0.4% w/w;
wherein the stable milk alternative Composition B is devoid of animal-derived substances and has a pH above the pI of BLG, preferably the pH is in the range of 7.2 to 7.3;
wherein Composition C comprises:
   (i) recombinant beta-lactoglobulin B (rBLG), 2.5% to 6% w/w;
   (ii) trisodium citrate, 0.1% to 0.3% w/w;
   (iii) sucrose, 1.5% to 5% w/w;
   (iv) coconut fat, 2% to 4% w/w;
   (v) water, 87% to 95% w/w;
   (vi) calcium carbonate, 0.25% to 0.75% w/w;
   (vii) gellan gum, 0.002% to 0.05% w/w;
   (viii) arabic gum, 0.05% to 0.3% w/w;
   (ix) monopotassium phosphate (MPP), 0.05% to 0.3% w/w;
   (x) DPP, 0.5% to 1.2% w/w;
   (xi) optionally, a coloring agent, preferably yellow colorant, 0.005% to 0.05% w/w;
   (xii) optionally, a flavoring agent, preferably table salt, 0.05% to 0.3% w/w;
   (xiii) optionally, hydrogen peroxide, 0.10 ppm to 1 ppm; and
   (xiv) optionally, cystine, 0.03 ppm to 0.3 ppm;
wherein the stable milk alternative Composition C is devoid of animal-derived substances and has a pH above the pI of BLG, preferably the pH is in the range of 7.2 to 7.4;
wherein Composition D comprises:
   (i) recombinant beta-lactoglobulin B (rBLG), 0.5% to 3% w/w;
   (ii) trisodium citrate, 0.03% to 0.2% w/w;
   (iii) sucrose, 1.5% to 3.5% w/w;
   (iv) plant fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) DPP, 0.5% to 1.2% w/w;
   (x) MPP, 0.05% to 0.3% w/w;
   (xi) optionally, a coloring agent, preferably yellow colorant, 0.05% to 0.5% w/w;
   (xii) optionally, a flavoring agent, 0.02% to 0.5% w/w;
   (xiii) optionally, hydrogen peroxide, 0.10 ppm to 1 ppm;
   (xiv) optionally, cystine, 0.03 ppm to 0.3 ppm; and
   (xv) optionally, calcium carbonate, 0.15% to 1% w/w;
wherein the stable milk alternative Composition D is devoid of animal-derived substances and has a pH above the pI of BLG, preferably the pH is in the range of 7.2 to 7.5; and
wherein Composition E comprises:
   (i) recombinant beta-lactoglobulin B (rBLG), 2% to 6% w/w;
   (ii) trisodium citrate, 0.1% to 0.3% w/w;
   (iii) sucrose, 1.5% to 3.5% w/w;
   (iv) plant fat, 2% to 4% w/w;
   (v) water, 80% to 95% w/w;
   (vi) optionally, inulin fiber, 1% to 4% w/w;
   (vii) gellan gum, 0.002% to 0.05% w/w;
   (viii) arabic gum, 0.05% to 0.3% w/w;
   (ix) DPP, 0.5% to 1.2% w/w;
   (x) MPP, 0.05% to 0.3% w/w;
   (xi) optionally, a coloring agent, preferably yellow colorant, 0.05% to 0.5% w/w;
   (xii) optionally, a flavoring agent, 0.02% to 0.5% w/w;
   (xiii) optionally, hydrogen peroxide, 0.10 ppm to 1 ppm;
   (xiv) optionally, cystine, 0.03 ppm to 0.3 ppm; and
   (xv) optionally, calcium carbonate, 0.15% to 1% w/w;
wherein the stable milk alternative Composition E is devoid of animal-derived substances and has a pH above the pI of BLG, preferably the pH is in the range of 7.2 to 7.5. Each possibility represents a separate embodiment of the invention.

According to some embodiments, the stable milk alternative composition is composition A. According to some embodiments, the stable milk alternative composition is composition B. According to some embodiments, the stable milk alternative composition is composition C. According to some embodiments, the stable milk alternative composition is composition D. According to some embodiments, the stable milk alternative composition is composition E.

According to some embodiments, the stable milk alternative composition is selected from the group consisting of: composition A, composition B, composition C and composition D. According to some embodiments, the stable milk alternative composition is selected from the group consisting of: composition A, composition B, composition C and composition E. According to some embodiments, the stable milk alternative composition is selected from the group consisting of: composition A, composition B, composition D and composition E. According to some embodiments, the stable milk alternative composition is selected from the group consisting of: composition A, composition C, composition D and composition E. According to some embodiments, the stable milk alternative composition is selected from the group consisting of: composition B, composition C, composition D and composition E.

According to some embodiments, the stable milk alternative composition has an energy content of 50 calories to 65 calories per 100 ml.

According to some embodiments, the stable milk alternative composition is prepared by a method comprising: (i) providing at least one pH adjusting agent; (ii) providing a dry mixture comprising at least one milk protein, at least one additive selected from the group consisting of: a mineral chelator, a texturizer and an emulsifier, and at least one saccharide; (iii) providing a non-animal fat and melting it at a temperature of at least 40° C.; (iv) dissolving the at least one pH adjusting agent in water to form an aqueous buffer solution; (v) dissolving the dry mixture of step (ii) in water at a temperature of at least 30° C. to form an aqueous mixture; (vi) combining the aqueous buffer solution of step (iv) with the aqueous mixture formed in step (v) to form a combined aqueous mixture; and (vii) combining the molten fat of step (iii) with the combined aqueous mixture of step (vi) to form a stable milk alternative composition.

According to some embodiments, the method further comprises a step of homogenizing the stable milk alternative composition of step (vii).

According to some embodiments, the method further comprises heat-treating the stable milk alternative composition by performing the method for obtaining a heat-treated edible aqueous composition of the present invention.

According to some embodiments, the method further comprises aseptically filling the stable milk alternative composition in a container.

According to some embodiments, the stable milk alternative composition is substantially devoid of any ingredient derived from animal source. According to some embodiments, the stable milk alternative composition comprises at least one ingredient, which is not present in animal milk.

According to some embodiments, the stable milk alternative composition imparts an animal milk perception.

The terms “animal milk perception” and “organoleptic properties” are as defined hereinabove.

According to some embodiments, the animal milk perception imparted by the present stable milk alternative composition is selected from the group consisting of: bovine milk perception, caprine milk perception, equine milk perception, ovine milk perception, porcine milk perception, and cameline milk perception. Each possibility represents a separate embodiment of the invention.

### EXAMPLES

### Example 1: Process for Forming a Milk Alternative Composition

A milk alternative composition was prepared using the following ingredients: Recombinant BLG protein: 5.46%, Trisodium citrate: 0.16%, Maltose: 2.30%, Vegetable fat: 3.00%, Water: to 100% (89.08%).

To form the edible aqueous composition, the dry ingredients (recombinant BLG protein, trisodium citrate, and maltose) were mixed together according to the ratios above in a mixing vessel and hydrated in water for 20 minutes at 40° C. at 400 RPM, until the protein was fully dissolved. The pH of the resultant aqueous solution was then adjusted to 6.8-7 with 0.5M aq. NaOH.

The vegetable fat was then heated to 45° C. until it melted completely. The melted vegetable fat was integrated into the aqueous solution under agitation, using a mixing device, and mixed at 60° C. for 30 minutes at 600 RPM. An ultra-high-pressure homogenizer was used to process the mixture at maximum speed, and the mixture was homogenized at 250 bar (2 stage homogenization) to ensure a uniform consistency. The pH of the mixture was adjusted again to 6.8-7 with 0.5M aq. NaOH.

### Example 2: UHT Pasteurization of the Milk Alternative Composition with L-Cystine and Hydrogen Peroxide

30% Hydrogen peroxide, L-cystine, or a combination of hydrogen peroxide and L-cystine were added to the milk alternative composition of Example 1 at varying concentrations (as shown in Table 3) to form a mixture. 30% hydrogen peroxide is used such that 100 ppm of 30% hydrogen peroxide is ~30 ppm hydrogen peroxide. The mixture was then pasteurized using a high-temperature short-time pasteurization system by heating the mixture to 140° C. for 2 seconds using a tubular heat exchanger pre-heated to approximately 70° C.

TABLE 3
Samples and anti-VSC treatment ingredients

| | | 30% Hydrogen | L-cystine |
|---|---|---|---|
| Treatment | Sample | Peroxide (ppm) | (ppm) |
| Control | Milk alternative | 0 | 0 |
| | composition | | |
| Treatment 1 | Milk alternative | 10 | 0 |
| | composition | | |
| Treatment 2 | Milk alternative | 50 | 0 |
| | composition | | |
| Treatment 3 | Milk alternative | 100 | 0 |
| | composition | | |
| Treatment 4 | Milk alternative | 250 | 0 |
| | composition | | |
| Treatment 5 | Milk alternative | 500 | 0 |
| | composition | | |
| Treatment 6 | Milk alternative | 0 | 10 |
| | composition | | |
| Treatment 7 | Milk alternative | 0 | 50 |
| | composition | | |
| Treatment 8 | Milk alternative | 0 | 100 |
| | composition | | |
| Treatment 9 | Milk alternative | 0 | 250 |
| | composition | | |
| Treatment 10 | Milk alternative | 0 | 500 |
| | composition | | |
| Treatment 11 | Milk alternative | 10 | 10 |
| | composition | | |
| Treatment 12 | Milk alternative | 50 | 50 |
| | composition | | |
| Treatment 13 | Milk alternative | 100 | 100 |
| | composition | | |
| Treatment 14 | Milk alternative | 250 | 250 |
| | composition | | |
| Treatment 15 | Milk alternative | 500 | 500 |
| | composition | | |

### Example 3 Organic Sulfur Sensor Analysis of the Heat-Treated Milk Alternative Compositions of Example 2

The sulfuric eggy smell of the heat-treated milk alternative compositions of Example 2, was measured using a 10-channel portable electronic nose (PEN-3), a device that uses a metal-oxide gas sensor array to detect and classify gases or gas mixtures. PEN-3 was set to measure the sulfuric eggy smell on a scale from 1 to 9 at a 40 second sample measuring time, 80 second flush time.

Prior to the analysis, 12 mL samples were inserted into a closed glass tube (40 mL total volume) and incubated for 30 minutes at 50° C. to induce the formation of Volatile Sulfur Compounds (VSCs) in the heat-treated milk alternative compositions. The samples were compared to a commercial 3% fat cow's milk as a control. Only one channel of an e-nose device was used to measure the changes in smell.

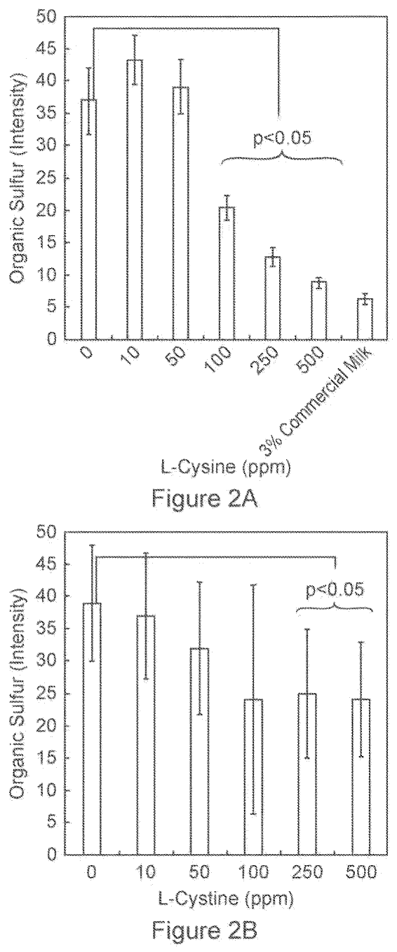

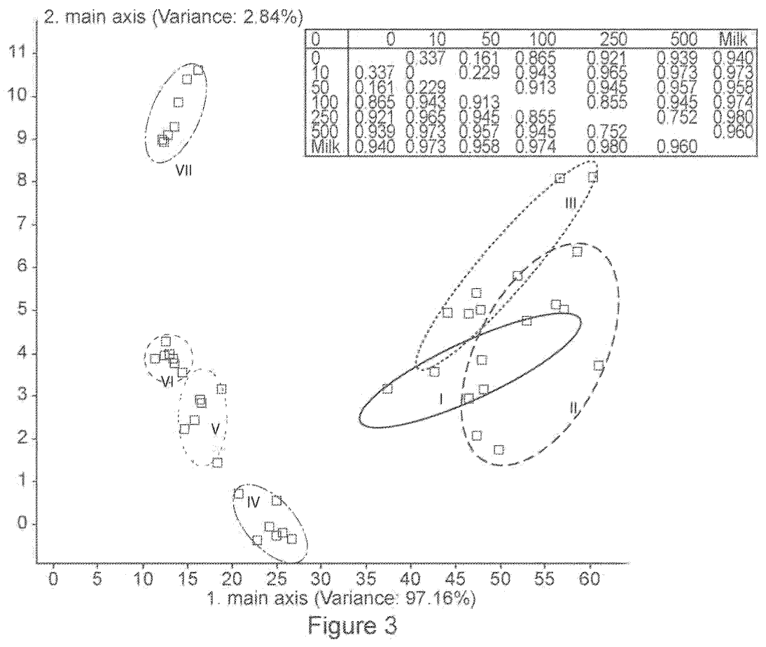

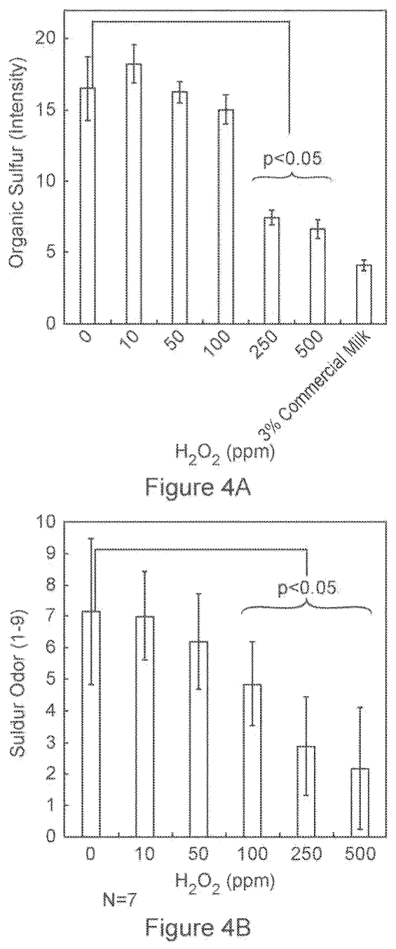

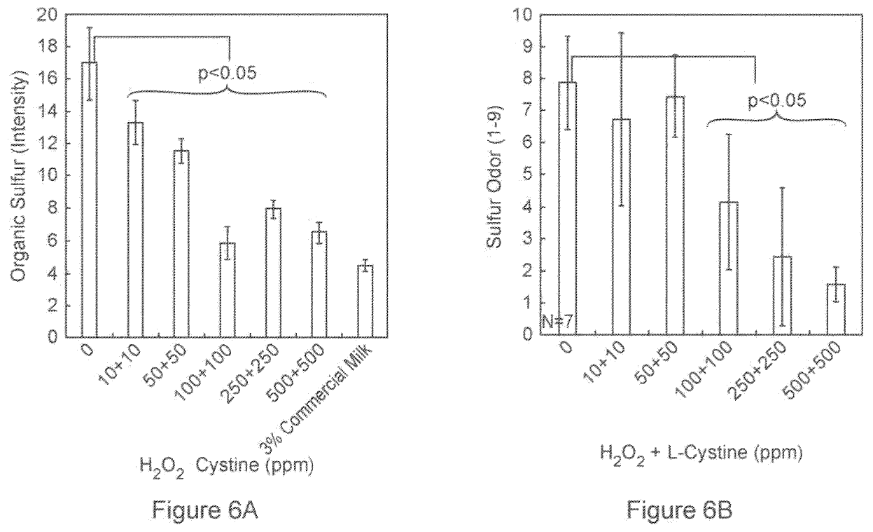

The organic sensor reported that different concentrations of 30% hydrogen peroxide and L-cystine had varying effects on the reduction of sulfur smell compared to the untreated control (FIGS. 2A, 4A and 6A). At L-cystine concentrations of 10-50 ppm (Treatments 6 and 7), the sulfur smell was not effectively reduced. However, concentrations of 100-250 ppm (Treatments 8 and 9) resulted in a modest reduction in sulfur smell. At L-cystine 500 ppm (Treatment 10), the sulfur smell achieved a similar reduction such that it was comparable to the sulfur smell detected in the 3% commercial milk control (with the disadvantage of high concentration of this additive). The PCA plot (10 sensors, Electronic Nose) in FIG. 3, shows that L-cystine was ineffective at reducing the sulfur smell at concentrations of 10-50 ppm, only moderately effective at 100-250 ppm, but able to reduce the sulfur smell to a level similar to that of cow's milk at 500 ppm.

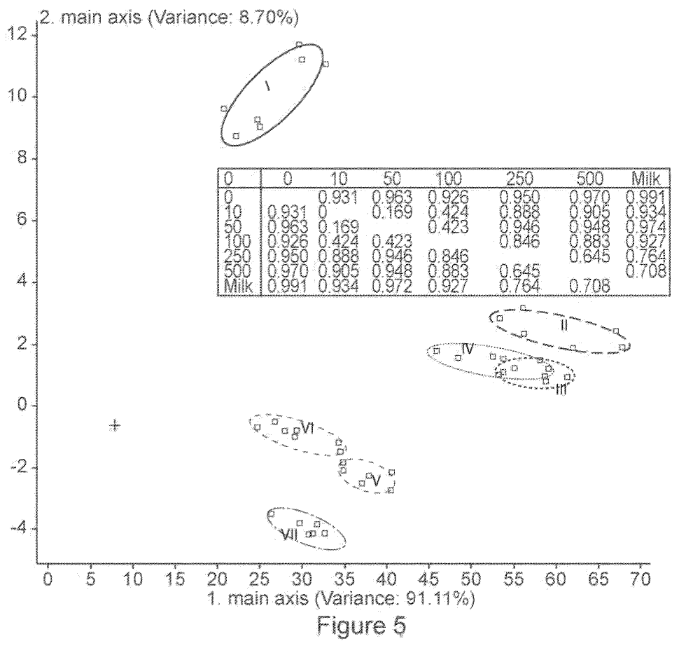

At 30% hydrogen peroxide 10-100 ppm (Treatments 1-3), the eggy sulfur smell was not meaningfully reduced. However, at 250-500 ppm (Treatments 4 and 5), the reduction in sulfur smell was modest. The PCA plot (10 sensors, Electronic Nose) in FIG. 5 shows that concentrations of 10-500 ppm of 30% hydrogen peroxide alone were not effective at effectively reducing the sulfur smell.

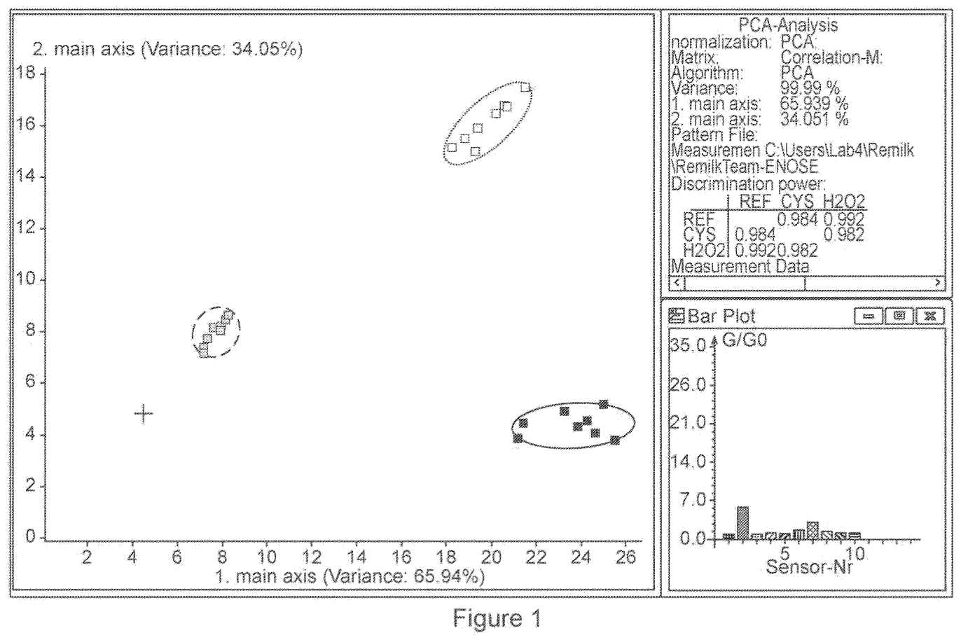

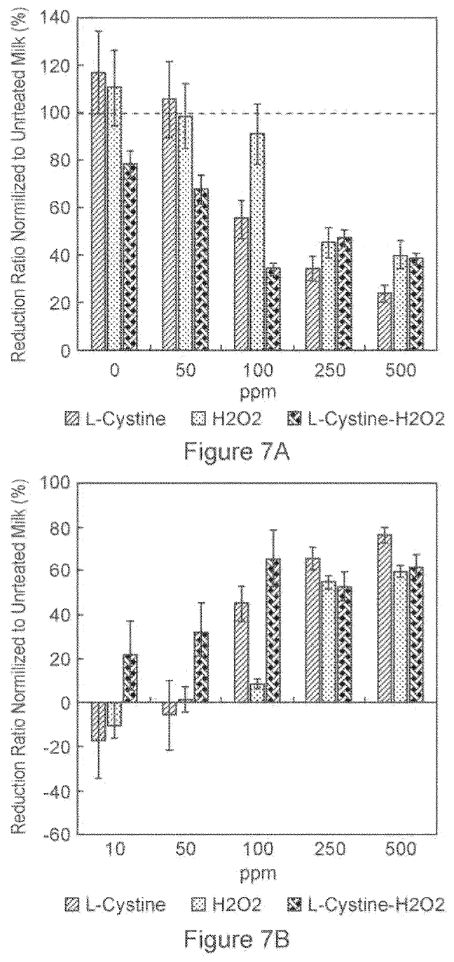

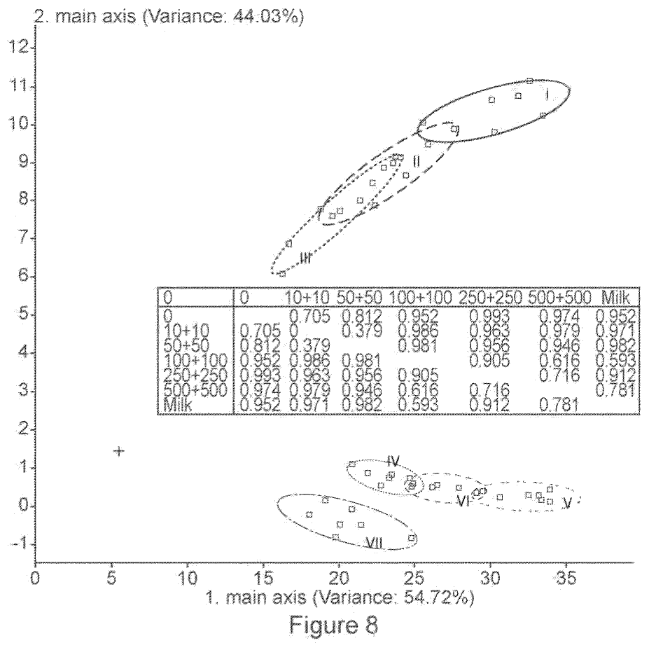

Surprisingly, samples containing a combination of L-cystine and 30% hydrogen peroxide (Treatments 11 to 15) exhibited an enhanced reduction in sulfur smell even at low concentration. At 30% hydrogen peroxide/L-cystine concentrations of 10/10 to 50/50 ppm, a modest reduction was detected. Surprisingly, at a concentration of 30% hydrogen peroxide/L-cystine 100/100 ppm (Treatment 13), a comparable sulfur smell profile to 3% commercial milk was exhibited. When used individually, neither L-cystine nor 30% hydrogen peroxide achieved a similar reduction in sulfur smell, indicating a synergistic relationship between the two additives. This is supported by the PCA plot in FIG. 1, which shows that individually treating heat-treated milk alternative compositions with either 30% hydrogen peroxide (red) or L-cystine (green) produced a different reaction. Unexpectedly, at 30% hydrogen peroxide/L-cystine 250+250 to 500+500 ppm (Treatments 14 and 15), the reduction in sulfur smell was less effective than 100/100 ppm. The PCA plot (10 sensors, Electronic Nose) in FIG. 8 shows that at concentrations of 30% hydrogen peroxide/L-cystine of 50/10-50 ppm, the reduction in sulfur smell was mediocre. However, at concentrations of 100/100 to 500/500 ppm, the combination of 30% hydrogen peroxide and L-cystine was able to reduce the sulfur smell to a similar level to that of cow's milk. FIGS. 7A and 7B, illustrating the reduction ratio in sulfur smell of treated compositions compared to an untreated control, demonstrate that the reduction in sulfur smell increased as the concentration of L-cystine or 30% hydrogen peroxide increased. At 10-50 ppm, the reduction was minimal, while at 100 ppm it was modest. The most significant reduction was seen at significantly higher concentrations of 250-500 ppm. Compositions treated with L-cystine/30% hydrogen peroxide showed greater reductions in sulfur smell at 10-50/10-50 ppm compared to compositions treated with L-cystine or hydrogen peroxide individually. Unexpectedly, when treating with L-cystine/30% hydrogen peroxide, there was a greater sulfur smell reduction at 100/100 ppm compared to at higher concentrations of 250-500/250-500 ppm.

### Example 4: Hedonic Test Analysis of the Heat-Treated Milk Alternative Compositions Treated with L-Cystine, 30% Hydrogen Peroxide, or a Combination of Both

The sulfuric eggy smell of the heat-treated milk alternative compositions treated with L-cystine, 30% hydrogen peroxide, or a combination of both, was then evaluated by the Hedonic test using more than five evaluators. This allowed for the quantitative measurement of the sulfuric eggy smell in the heat-treated edible aqueous compositions using PEN-3, displayed in FIGS. 2B, 4B and 6B.

The hedonic test analysis reported a different effect in the reduction of the sulfur smell reduction in the heat-treated milk alternative compositions at different concentrations of 30% hydrogen peroxide and L-cystine. At 30% hydrogen peroxide 10-50 ppm (Treatment 1 to 2), the sulfur smell was not effectively reduced, while at 30% hydrogen peroxide 100-500 ppm (Treatments 3 to 5), the reduction in sulfur smell was mediocre. At L-cystine 10-100 ppm (Treatments 6 to 8), the eggy smell was not effectively reduced, while at 250-500 ppm (Treatments 9 to 10), the reduction in smell was only modest. Similarly, at L-cystine/30% hydrogen peroxide 10/10 to 100/100 ppm (Treatments 11 to 12), no significant sulfur smell was observed. Unexpectedly, a greater reduction in sulfur smell was observed at 30% hydrogen peroxide/L-cystine 100/100 to 500/500 ppm (Treatments 13 to 15) than for L-cystine or 30% hydrogen peroxide at the same concentrations individually.

### Example 5A: Process for Forming 3% Fat Stable Milk Alternative Composition

A 3% fat milk alternative composition was prepared using the following ingredients: Recombinant BLG protein: 4.32%, Trisodium citrate: 0.16%, Maltose: 3.50%, Vegetable fat: 3.00%, Inulin fibers: 2.00%, Arabic gum: 0.15%, Gellan gum: 0.01%, Dipotassium phosphate: 0.65%, Disodium phosphate: 0.2%, Monosodium phosphate: 0.085%, L-Cystine and/or 30% hydrogen peroxide: 0.05%, Yellow coloring: 0.015%, Flavors: about 0.1%, Water: to 100%.

To form the 3% fat milk alternative composition, a salt solution was prepared by adding a pre-mixed salt mixture containing monosodium phosphate, disodium phosphate, and dipotassium phosphate to a 250 mL water solution. Separately, a protein solution was prepared by adding a dry mix of the recombinant BLG protein, maltose, inulin fibers, gellan gum, arabic gum, trisodium citrate, and yellow color (0.015%) to water heated to 40° C. The protein solution was stirred at 40° C. until the recombinant BLG protein was dissolved, taking approximately 30 minutes.

The salt solution was then added to the protein solution and mixed for 20 minutes at 40° C. The pH was maintained at between 7.2 and 7.3 using NaOH. The preparation was heated to 60° C., and the melted vegetable fat (3%) was added to the solution to form an emulsion.

The emulsion was heated to 60° C. for 30 minutes, pre-homogenized using Ultra Thurax for a maximum of 2 minutes at a maximum speed of 25,000 rpm, and homogenized at a total of 1000 bars with the second stage at 250 bars and the first stage at 750 bars, to form the 3% fat milk alternative.

### Example 5B: Process for Forming 3% Fat Stable Milk Alternative Composition

A 3% fat milk alternative composition was prepared using the following ingredients: Recombinant BLG protein: 4.32%, Trisodium citrate: 0.16%, Maltose: 4.00%, Palm fat: 3.00%, Arabic gum: 0.15%, Gellan gum High Acyl: 0.01%, Dipotassium phosphate: 0.65%, Disodium phosphate: 0.2%, Monosodium phosphate: 0.085%, Tricalcium phosphate: 0.25%, L-Cystine: 0.05%, Yellow color: 0.01%, Flavors: 0.4%, Water: to 100% (~86.71%).

To form the 3% fat milk alternative composition, a salt solution was prepared by mixing a salt mixture containing monosodium phosphate, disodium phosphate, and dipotassium phosphate in water for 30 minutes to form a slat solution having pH 7.6. The salt solution was then heated to 40° C. A dry mix of the recombinant BLG protein, maltose, gellan gum, arabic gum, trisodium citrate, tricalcium phosphate, flavorant and yellow color was added to the solution at 40° C. for dissolution during 30 minutes until the recombinant BLG protein was dissolved. The pH was measured between 7.2 and 7.3. The preparation was heated to 60° C., a pre-melted vegetable fat (palm fat 3% w/w, previously melted at 60° C.) was added to the solution to form an emulsion. The emulsion was maintained at 60° C. for 30 minutes, pre-homogenized using Ultra Thurax for a maximum of 2 minutes at a maximum speed of 25,000 rpm, and homogenized at a total of 1000 bars with the second stage at 250 bars and the first stage at 750 bars, to form the 3% fat milk alternative.

### Example 6A: Pasteurization of 3% Fat Stable Milk Alternative Composition of Example 5A

30% hydrogen peroxide 500 ppm, L-cystine 500 ppm, or a combination of 30% hydrogen peroxide 500 ppm and L-cystine 500 ppm were added to the 3% fat milk alternative composition of Example 5A to form a 30% hydrogen peroxide-treated, L-cystine treated and 30% hydrogen peroxide/L-cystine-treated mixtures. The mixtures were then heat treated at 140° C. for 2 seconds using a tubular heat exchanger pre-heated to approximately 70° C., to form heat-treated 3% fat milk alternative compositions. The nutritional and physical values of the products are specified in tables 3 and 4 below.

TABLE 4
Nutritional Values of the milk alternative
compositions of Examples 5A and 6A:

| Nutritional Values | Milk Alternative 3% |
|---|---|
| Energy | 58 |
| Total Carbohydrates | 3.5 g |
| Fibers | 2 g |
| Fat | 3 g |
| Protein | 3.3 g |

TABLE 5
Physical Values of the milk alternative
compositions of Examples 5A and 6A:

| Nutritional Values | Milk Alternative3% |
|---|---|
| pH | 7.1-7.2 |
| Dry matter | 12.8-13.2% |

### Example 6B: Pasteurization of 3% Fat Stable Milk Alternative Composition of Example 5B

L-cystine was added to the 3% fat milk alternative composition of Example 5B to form an L-cystine treated mixture. The mixture was then heat treated according to two separate heat treatment protocols:

### Heat Treatment Protocol 1:

Heating the L-cystine treated mixture at 140° C. for 2 seconds form a heat-treated 3% fat milk alternative composition.

### Heat Treatment Protocol 2:

Heating the L-cystine treated mixture at 85° C. for 2 minutes form a heat-treated 3% fat milk alternative composition. The nutritional and physical values of the products are specified in tables 5 and 6 below.

TABLE 6
Nutritional Values of the milk alternative
compositions of Examples 5B and 6B:

| Nutritional Values | Milk Alternative3% |
|---|---|
| Energy | 56 |
| Total Carbohydrates | 4 g |
| Calcium | 145 mg |
| Fat | 3 g |
| Protein | 3.3 g |

TABLE 7
Physical Values of the milk alternative
compositions of Examples 5B and 6B:

| Nutritional Values | Milk Alternative3% |
|---|---|
| pH | 7.2-7.3 |
| Dry matter | 12.5-13.5% |

### Example 7: Acid Stability

An acid stability test was performed on the heat-treated milk alternative composition of Example 2 and the heat-treated 3% fat stable milk alternative compositions of Example 6. The heat-treated milk alternative composition of Example 2 was not stable under acidic conditions and displayed curdling and precipitation. Surprisingly, the heat-treated 3% fat stable milk alternative compositions, which contained a mixture monosodium phosphate, disodium phosphate, and dipotassium phosphate, remained stable and did not exhibit curdling or precipitation.

### Example 8: Heat Stability

A heat stability test was conducted on the heat-treated milk alternative composition of Example 2 and the heat-treated 3% fat stable milk alternative compositions of Example 6. The heat-treated milk alternative composition of Example 2 was not stable at temperatures of 55° C. and curdling and precipitation were observed. Unexpectedly, the heat-treated 3% fat stable milk alternative compositions, which contained gellan gum, remained stable and did not display curdling or precipitation at 55° C.

### Example 9: Foaming

A foaming test was performed on the heat-treated milk alternative composition of Example 2 and the heat-treated 3% fat stable milk alternative compositions of Example 6. The heat-treated milk alternative composition of Example 2 displayed poor foaming ability, with limited foam formation and low foam stability. However, greater foaming ability, with stable, long-lasting foaming was observed in the heat-treated 3% fat stable milk alternative compositions.

### Example 10: Taste Improvement

A hedonic taste perception test was performed to compare the mouthfeel and bodyness of the heat-treated milk alternative composition of Example 2 and the heat-treated 3% fat stable milk alternative compositions of Example 6. The heat-treated 3% fat stable milk alternative compositions were reported to have a superior mouthfeel and bodyness, with greater richness and thickness, and a creamier and more luxurious sensation, compared to the heat-treated milk alternative composition.

### Example 11: Process for Forming 3% Fat Stable Milk Alternative Composition

A 3% fat milk alternative composition was prepared using the following ingredients: Recombinant BLG protein: 3.95%, Trisodium citrate: 0.15%, Sucrose: 2.10%, Coconut fat 3.0%, Arabic gum: 0.18%, Gellan gum: Salt: 0.05%, L-Cystine: 0.05%, 0.02%, Calcium Carbonate: 0.50%, Dipotassium phosphate (DPP): 0.80%, Monopotassium phosphate (MPP): 0.155%, Flavors: 0.1%, Water: to 100% (~88.44%).

To form the 3% fat milk alternative composition, a salt solution was prepared by hydrating the buffering agents (DPP and MPP) in water according to the ratios above for 30 minutes at 40° C. at 400 RPM. Next, the other dry ingredients (recombinant BLG protein, TSC, sucrose, salt, L-cystine, arabic gum, gellan gum and calcium carbonate) were added according to the ratios above and the solution was further mixed for 30 min (40° C. at 400 RPM), until the protein was fully dissolved.

The preparation was heated to 60° C., and the melted vegetable fat (3%) was added to the solution to form an emulsion. The emulsion was heated to 60° C. for 30 minutes, pre-homogenized using Ultra Thurax for a maximum of 2 minutes at a maximum speed of 25,000 rpm, and homogenized at a total of 600 bars with the second stage at 150 bars and the first stage at 450 bars, to form the 3% fat milk alternative.

The homogenized mixture was then pasteurized using a high-temperature short-time pasteurization system by heating the mixture to 121° C. for 2 seconds using a tubular heat exchanger pre-heated to approximately 70° C. The milk alternative was bottled and stored at 4° C.

### Example 12: Functional and Physical Comparison of Milk Alternative with and without BLG

A milk alternative was prepared as detailed in Example 11 with and a similar milk alternative without the BLG component (the 3.95% protein fraction was substituted with deionized water). The two milk alternatives, and a local commercial cow milk brand, were characterized for their physical and functional properties, including: viscosity, pH, dry matter percentage, milk and coffee color, foam density and stability. Milk colors of the composition of Example 11 and the composition without BLG were measured as a difference compared to the commercial cow milk, which was used as a reference. The color measurement is conventional in the art. Specifically, the measured delta E indicates a summation of the color difference between the reference and the investigated composition in three dimensions (lighter/darker, redder/greener, and yellower/bluer). A lower delta E indicates a more similar visual appearance to the reference composition. The coffee color examination compared the colors of coffee compositions similarly prepared from the composition of Example 11 and the composition without BLG, with the reference coffee with commercial cow milk.

TABLE 8
Physical properties of cow milk and milk alternative compositions

| | | Milk | Milk |
|---|---|---|---|
| | Commercial | alternative | alternative |
| | cow milk | with BLG | without BLG |
| Viscosity (cP) | 10.6 | 29.9 | 7.29 |
| pH | 6.81 | 7.35 | 8.94 |
| Dry matter (%) | 11.71 | 9.72 | 6.32 |
| Milk color (delta E) | — | 3 | 6.7 |
| Coffee color (delta E) | — | 11.5 | >30 |
| Foam density (100 gr/ml) | 1.57 | 2.94 | 1.71 |
| Foam stability (%) | 76 | 95 | 87 |

Results suggest that BLG has a significant impact on the functionality of the milk alternative and brings it closer to the commercial cow's milk. Advantageously, the superior foaming density and stability of the BLG-containing milk alternative over the commercial cow's milk makes it better suited to be used as “Barista Milk” which create long-lasting foam for cappuccinos, lattes, and other milk-based coffee and tea drinks.

### Example 13: Comparison of Coffee Color with Commercial Milk Vs. Milk Alternative with and without BLG

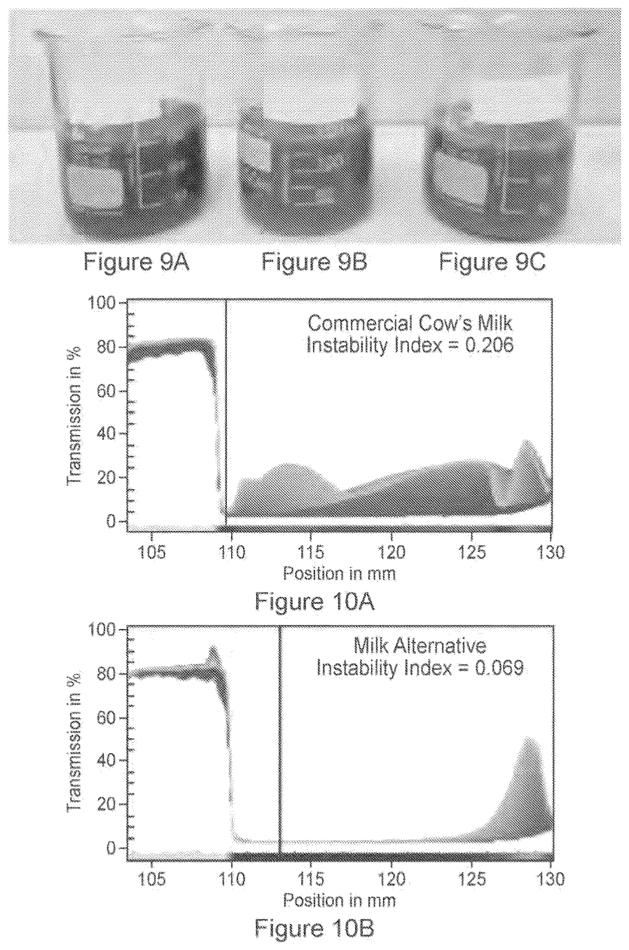

FIGS. 9A-C are photographs of coffee samples made using three different types of milk samples: coffee made using milk alternative without BLG (FIG. 9A), coffee made using milk alternative with BLG (i.e., a milk alternative according to the present invention, as prepared in Example 11; FIG. 9B) and a coffee made using a commercial cow milk (FIG. 9C). The coffee samples were prepared as follows: a commercial instant coffee (2 gr) was mixed with 150 gr deionized boiling water and the different milk samples (15 gr) were immediately added to the coffee. Visual similarity between the coffee made with commercial cow milk and the coffee made with the milk alternative according to the present invention can be immediately appreciated. Also, the coffee made with milk alternative without BLG (FIG. 9A) is darker and visually distinct from the coffee samples of FIG. 9B and FIG. 9C.

### Example 14: Physical Stability of Milk Alternative to Sedimentation and Creaming

The physical stability to sedimentation of the milk alternative prepared in Example 11 was monitored via an analytical centrifugal analyzer (LUMisizer, L.U.M. GmbH, Berlin, Germany). Briefly, non-diluted samples (commercial cow's milk and the milk alternative of Example 11) milk were loaded (400 μL) into 2.0 mm optical path length polycarbonate disposable cells and the time and space-resolved transmission extinction profiles were recorded at 2000 RPM at 4° C. for 15 hours. The instability index was calculated using the included software (SepView 6.0; LUM). The instability index is a simple determination of the phase separation and destabilization phenomena measured by the clarification at a certain separation time, divided by the maximum clarification.

The results are shown in FIG. 10A and FIG. 10B. FIG. 10A-B show LUMISizer profile of commercial cow's milk (FIG. 10A) and milk BLG-based alternative as prepared in Example 11 (FIG. 10B). Also indicated is the instability index as calculated by SepView software. Advantageously, the results show that the overall physical stability of the alternative BLG-based milk is approximately three times higher than the commercial cow's milk, which is very desirable commercially.

### Example 15A: Process for Forming 1% Protein, 3.5% Fat Stable Milk Alternative Composition

A 3.5% fat, 1% protein milk alternative composition was prepared as detailed in Example 11, using the following ingredients (Table 9).

TABLE 9
Ingredients of a 3.5% fat, 1% protein milk
alternative composition

| | | Nutritional |
|---|---|---|
| Ingredients | % w/w | Value (%) |
| Water | 89.4 | |
| BLG | 1.00 | 1 |
| Plant fat (oil) | 3.5 | 3.5 |
| Salt | 0.05 | 0.05 |
| Sucrose | 2.1 | 2 |
| Dipotassium phosphate | 0.8 | 0.8 |
| Monopotassium | 0.155 | 0.155 |
| phosphate | | |
| Calcium carbonate | 0.5 | 0.5 |
| Arabic gum | 0.18 | 0.18 |
| Tri-sodium citrate | 0.09 | 0.08 |
| Natural flavors | 0.18 | 0.18 |
| L-cystine | 0.02 | 0.02 |
| High acyl gellan gum | 0.025 | 0.025 |
| Inulin fibers | 2 | 1.8 |

### Example 15B: Process for Forming 3.5% Fat Stable Milk Alternative Composition

A 3.5% fat milk alternative composition was prepared as detailed in Example 11, using the following ingredients:

TABLE 10
Ingredients of a 3.5% fat, 3% protein milk
alternative composition

| | % | Nutritional |
|---|---|---|
| Ingredients | W/W | Value |
| Water | 89.5 | |
| BLG | 3.0 | 3.6 |
| Plant fat (oil) | 3.5 | 3.5 |
| Salt | 0.05 | 0.05 |
| Sucrose | 2.1 | 2 |
| Dipotassium phosphate | 0.8 | 0.8 |
| Monopotassium | 0.155 | 0.155 |
| phosphate | | |
| Calcium carbonate | 0.5 | 0.5 |
| Arabic gum | 0.18 | 0.18 |
| Tri-sodium citrate | 0.15 | 0.13 |
| Natural flavors | 0.2 | 0.2 |
| L-cystine | 0.05 | 0.05 |
| High acyl gellan gum | 0.02 | 0.02 |

### Example 16: Foam Characteristics

Foams from fat milk alternative compositions prepared as detailed in the Examples above were characterized by standard methods in the art for foam volume (ml, per measuring cup), foam stability (%, V₁₀ₘᵢₙ/V₀ₘᵢₙ×100), overrun (%, V₁₀ₘᵢₙ−V₀ₘᵢₙ)/V₁₀ₘᵢₙ). The results are presented in Table 11.

TABLE 11
Properties of cow milk and milk alternative (1% and
3% protein) compositions.

| | Foam | Foam | | Foam |
|---|---|---|---|---|
| | volume | volume | Overrun | stability |
| Sample | (V₀ₘᵢₙ₎) | (V₁₀ₘᵢₙ₎) | (%) | (%) |
| 1% BLG milk | 100-150 | 70-95 | 60-67 | 63-70 |
| alternative | | | | |
| 3% BLG milk | 115-126 | 83-90 | 63-70 | 71-73 |
| alternative | | | | |
| Cow milk | 65-70 | 55-58 | 43-44 | 78-90 |

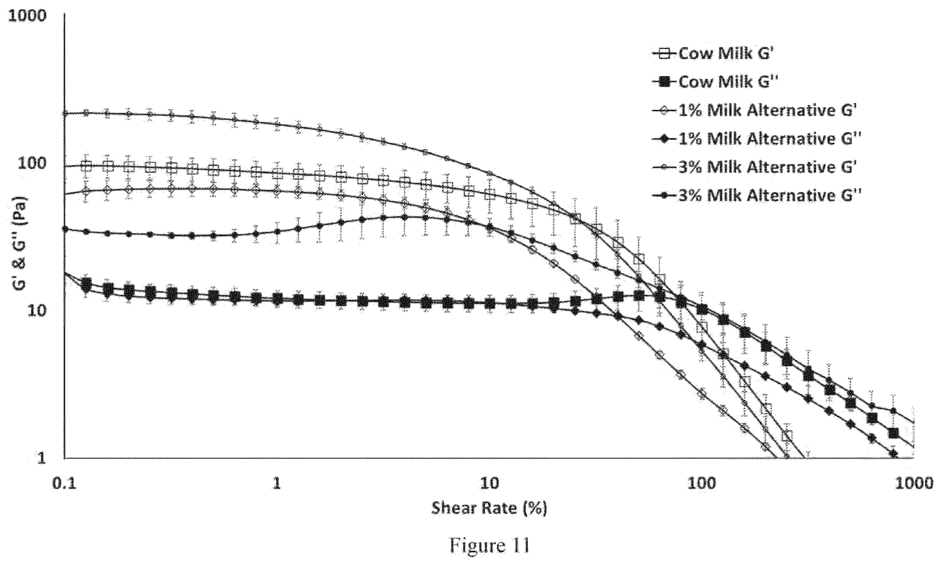

Foams were further characterized by standard methods in the art for G′ and G″ (FIG. 11). G′ denotes the storage modulus of the foam, reflecting its capacity to uphold shape and resist deformation. Conversely, G″ signifies the viscosity of the foam, with higher values indicative of heightened viscosity and a more viscous, creamy consistency. When G′ is inferior to G″, it signifies enhanced stability of the foam, showcasing resistance to applied deformation. Conversely, a descent in the plotted lines suggests the onset of sample collapse, particularly evident at elevated shear rates, thereby compromising stability.

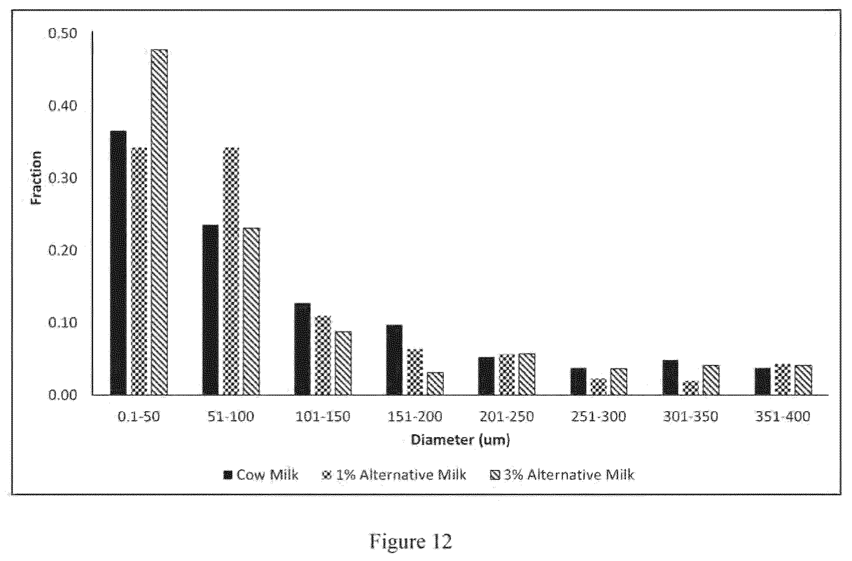

Foams were further characterized by standard methods in the art for bubble size distribution (FIG. 12).

### Example 17: Residual Cystine Levels

Stable milk alternative compositions provided by the present invention were tested to determine residual cystine levels in final consumer product containers. It has been found that the minimal detection level of cystine using HPLC (280 and/or 206 nm detector, PROTEEMA SEC 8*150 mm, 5 micron column, PSS, Catalog #pra0815053e2; mobile phase 40 mM sodium phosphate buffer, 200 mM NaCl, pH 7.0; retention time was measured at about 7.4-7.5 minutes) is about 30 ppm. Other detection methods may have different detection levels and limits.

Although the invention is described in conjunction with specific embodiments thereof, it is evident that numerous alternatives, modifications and variations that are apparent to those skilled in the art may exist. It is to be understood that the invention is not necessarily limited in its application to the details of construction and the arrangement of the components and/or methods set forth herein. Other embodiments may be practiced, and an embodiment may be carried out in various ways. Accordingly, the invention embraces all such alternatives, modifications and variations that fall within the scope of the appended claims.

1. A stable milk alternative composition, comprising:
(i) at least one milk protein;
(ii) at least one additive selected from the group consisting of: a mineral chelator, a mineral, a texturizer and an emulsifier;
(iii) at least one saccharide;
(iv) at least one fat; and
(v) water;
wherein the stable milk alternative composition is devoid of animal-derived substances, and
wherein the stable milk alternative composition has a comparable sulfur smell profile to animal milk, or
wherein the stable milk alternative composition is devoid of micellar casein.

2. The stable milk alternative composition of claim 1, wherein the at least one milk protein comprises beta lactoglobulin (BLG).

3. The stable milk alternative composition of claim 2, wherein the BLG is present at a concentration of at least 1% w/w.

4. The stable milk alternative composition of claim 2, which comprises the BLG substantially as the sole milk protein.

5. (canceled)

6. (canceled)

7. (canceled)

8. (canceled)

9. (canceled)

10. The stable milk alternative composition of claim 1, further comprising hydrogen peroxide, cystine or both.

11. The stable milk alternative composition of claim 1,
comprising:
(i) recombinant beta-lactoglobulin B (rBLG), 0.5% to 10% w/w;
(ii) a mineral chelator, 0.05% to 0.5% w/w;
(iii) a saccharide, 0.5% to 10% w/w;
(iv) optionally, a fat, 0% to 10% w/w;
(v) optionally, a texturizer, 0.001% to 10% w/w;
(vi) optionally, an emulsifier, 0.01% to 1% w/w;
(vii) optionally, a pH adjustment agent, 0.1% to 3% w/w;
(viii) optionally, a mineral, 0.05% to 5% w/w;
(ix) optionally, a flavoring agent, 0.05% to 1% w/w;
(x) optionally, a coloring agent; and
(xi) water, to 100% w/w.

12. The stable milk alternative composition of claim 1, which is selected from the group consisting of: Composition A, Composition B, Composition C, Composition D and Composition E,
wherein Composition A comprises:
(i) recombinant beta-lactoglobulin B (rBLG), 2.5% to 6% w/w;
(ii) trisodium citrate, 0.1% to 0.3% w/w;
(iii) maltose, 1.5% to 5% w/w;
(iv) vegetable fat, 2% to 4% w/w;
(v) water, 80% to 95% w/w;
(vi) optionally, inulin fiber, 1% to 4% w/w;
(vii) gellan gum, 0.002% to 0.05% w/w;
(viii) arabic gum, 0.05% to 0.3% w/w;
(ix) monosodium phosphate (MSP), 0.05% to 0.12% w/w;
(x) disodium phosphate (DSP), 0.1% to 0.3% w/w;
(xi) dipotassium phosphate (DPP), 0.5% to 0.8% w/w;
(xii) optionally, a coloring agent, preferably yellow 5 colorant, 0.005% to 0.05% w/w;
(xiii) optionally, a flavoring agent, 0.05% to 0.2% w/w;
(xiv) optionally, hydrogen peroxide, 0.10 ppm to 1 ppm;
(xv) optionally, cystine, 0.03 ppm to 0.3 ppm; and
(xvi) optionally, tricalcium phosphate, 0.15% to 0.4% w/w;
wherein the stable milk alternative Composition A is devoid of animal-derived substances and has a pH above the pI of BLG, preferably the pH is in the range of 7.2 to 7.3;
wherein Composition B comprises:
(i) recombinant beta-lactoglobulin B (rBLG), 2.5% to 6% w/w;
(ii) trisodium citrate, 0.1% to 0.3% w/w;
(iii) maltose, 2% to 5.5% w/w;
(iv) palm fat, 2% to 4% w/w;
(v) water, 80% to 95% w/w;
(vi) optionally, inulin fiber, 1% to 4% w/w;
(vii) gellan gum, 0.002% to 0.05% w/w;
(viii) arabic gum, 0.05% to 0.3% w/w;
(ix) MSP, 0.05% to 0.12% w/w;
(x) DSP, 0.1% to 0.3% w/w;
(xi) DPP, 0.5% to 0.8% w/w;
(xii) optionally, a coloring agent, preferably yellow colorant, 0.005% to 0.05% w/w;
(xiii) optionally, a flavoring agent, 0.2% to 0.5% w/w;
(xiv) optionally, hydrogen peroxide, 0.10 ppm to 1 ppm;
(xv) optionally, cystine, 0.03 ppm to 0.3 ppm; and
(xvi) optionally, tricalcium phosphate, 0.15% to 0.4% w/w;
wherein the stable milk alternative Composition B is devoid of animal-derived substances and has a pH above the pI of BLG, preferably the pH is in the range of 7.2 to 7.3;
wherein Composition C comprises:
(i) recombinant beta-lactoglobulin B (rBLG), 2.5% to 6% w/w;
(ii) trisodium citrate, 0.1% to 0.3% w/w;
(iii) sucrose, 1.5% to 5% w/w;
(iv) coconut 5 fat, 2% to 4% w/w;
(v) water, 87% to 95% w/w;
(vi) calcium carbonate, 0.25% to 0.75% w/w;
(vii) gellan gum, 0.002% to 0.05% w/w;
(viii) arabic gum, 0.05% to 0.3% w/w;
(ix) monopotassium phosphate (MPP), 0.05% to 0.3% w/w;
(x) DPP, 0.5% to 1.2% w/w;
(xi) optionally, a coloring agent, preferably yellow colorant, 0.005% to 0.05% w/w;
(xii) optionally, a flavoring agent, preferably table salt, 0.05% to 0.3% w/w;
(xiii) optionally, hydrogen peroxide, 0.10 ppm to 1 ppm; and
(xiv) optionally, cystine, 0.03 ppm to 0.3 ppm;
wherein the stable milk alternative Composition C is devoid of animal-derived substances and has a pH above the pI of BLG, preferably the pH is in the range of 7.2 to 7.4;
wherein Composition D comprises:
(i) recombinant beta-lactoglobulin B (rBLG), 0.5% to 3% w/w;
(ii) trisodium citrate, 0.03% to 0.2% w/w;
(iii) sucrose, 1.5% to 3.5% w/w;
(iv) plant fat, 2% to 4% w/w;
(v) water, 80% to 95% w/w;
(vi) optionally, inulin fiber, 1% to 4% w/w;
(vii) gellan gum, 0.002% to 0.05% w/w;
(viii) arabic gum, 0.05% to 0.3% w/w;
(ix) DPP, 0.5% to 1.2% w/w;
(x) MPP, 0.05% to 0.3% w/w;
(xi) optionally, a coloring agent, preferably yellow colorant, 0.05% to 0.5% w/w;
(xii) optionally, a flavoring agent, 0.02% to 0.5% w/w;
(xiii) optionally, hydrogen peroxide, 0.10 ppm to 1 ppm;
(xiv) optionally, cystine, 0.03 ppm to 0.3 ppm; and
(xv) optionally, calcium carbonate, 0.15% to 1% w/w;
wherein the stable milk alternative Composition D is devoid of animal-derived substances and has a pH above the pI of BLG, preferably the pH is in the range of 7.2 5 to 7.5; and
wherein Composition E comprises:
(i) recombinant beta-lactoglobulin B (rBLG), 2% to 6% w/w;
(ii) trisodium citrate, 0.1% to 0.3% w/w;
(iii) sucrose, 1.5% to 3.5% w/w;
(iv) plant fat, 2% to 4% w/w;
(v) water, 80% to 95% w/w;
(vi) optionally, inulin fiber, 1% to 4% w/w;
(vii) gellan gum, 0.002% to 0.05% w/w;
(viii) arabic gum, 0.05% to 0.3% w/w;
(ix) DPP, 0.5% to 1.2% w/w;
(x) MPP, 0.05% to 0.3% w/w;
(xi) optionally, a coloring agent, preferably yellow colorant, 0.05% to 0.5% w/w;
(xii) optionally, a flavoring agent, 0.02% to 0.5% w/w;
(xiii) optionally, hydrogen peroxide, 0.10 ppm to 1 ppm;
(xiv) optionally, cystine, 0.03 ppm to 0.3 ppm; and
(xv) optionally, calcium carbonate, 0.15% to 1% w/w;
wherein the stable milk alternative Composition E is devoid of animal-derived substances and has a pH above the pI of BLG, preferably the pH is in the range of 7.2 25 to 7.5.

13. (canceled)

14. (canceled)

15. (canceled)

16. (canceled)

17. (canceled)

18. The stable milk alternative composition of claim 1, which remains substantially uncurdled at a temperature of 60° C. for at least 30 minutes.

19. (canceled)

20. (canceled)

21. (canceled)

22. The stable milk alternative composition of claim 1, which is in the form of liquid milk.

23. The stable milk alternative composition of claim 22, which has viscosity in the range of 8 to 50 cP.

24. The stable milk alternative composition of claim 22, has color difference in the range of 0 to 6, as measured by delta E compared to cow milk.

25. The stable milk alternative composition of claim 22, which has foam density in the range of 200 to 400 gr/ml.

26. The stable milk alternative composition of claim which has foam stability in the range of 90% to 99%.

27. (canceled)

28. (canceled)

29. (canceled)

30. A method for obtaining a heat-treated edible aqueous composition, the method comprising:
(a) providing an edible aqueous composition which comprises at least one milk protein;
(b) providing hydrogen peroxide;
(c) providing cystine;
(d) contacting the edible aqueous composition with the hydrogen peroxide and the cystine to form a mixture; and
(e) maintaining the mixture at a temperature of at least 60° C. for a time period of at least 1 second;
thereby obtaining a heat-treated edible aqueous composition.

31. (canceled)

32. (canceled)

33. (canceled)

34. (canceled)

35. (canceled)

36. The method of claim 30, wherein the edible aqueous composition of step (a) comprises BLG substantially as the sole whey protein.

37. The method of claim 30, wherein the edible aqueous composition of step (a) comprises BLG substantially as the sole milk protein.

38. (canceled)

39. (canceled)

40. The method of claim 30, wherein the heat-treated edible aqueous composition formed in step (e) is substantially devoid of an eggy and/or cabbage flavor and/or smell.

41. The method of claim 30, wherein the edible aqueous composition of step (a) is a milk alternative composition, and/or the heat-treated edible aqueous composition formed in step (e) is a heat-treated milk alternative composition.

42. The method of claim 30, wherein the edible aqueous composition of step (a), and/or the heat-treated edible aqueous composition formed in step (e) is a stable milk alternative composition comprising:
(i) at least one milk protein:
(ii) at least one additive selected from the group consisting of: a mineral chelator a mineral a texturizer and an emulsifier;
(iii) at least one saccharide;
(iv) at least one fat; and
(v) water;
wherein the stable milk alternative composition is devoid of animal-derived substances, and wherein the stable milk alternative composition has a comparable sulfur smell profile to animal milk, or wherein the stable milk alternative composition is devoid of micellar casein.

43. A heat-treated edible aqueous composition, prepared by the method of claim 30.


SEQUENCE LISTING (2 sequences)

SEQ ID NO: 1 - protein, 162 aa, synthetic construct
LIVTQTMKGLDIQKVAGTWYSLAMAASDISLLDAQSAPLRVYVEELKPTPEGDLEILLQKWENGECAQKKIIAEKTKIPAVFKIDALNENKVLVLDTDYKKYLLFCMENSAEPEQSLACQCLVRTPEVDDEALEKFDKALKALPMHIRLSFNPTQLEEQCHI

SEQ ID NO: 2 - protein, 162 aa, synthetic construct
LIVTQTMKGLDIQKVAGTWYSLAMAASDISLLDAQSAPLRVYVEELKPTPEGDLEILLQKWENDECAQKKIIAEKTKIPAVFKIDALNENKVLVLDTDYKKYLLFCMENSAEPEQSLVCQCLVRTPEVDDEALEKFDKALKALPMHIRLSFNPTQLEEQCHI